(19) United States
(12) Patent Application Publication
(10) Pub. No.: US 2024/0278993 A1
(43) Pub. Date: Aug. 22, 2024

(54) Matrial Handling Method and Apparatus

(71) Applicant: OPEX Corporation, Moorestown, NJ (US)

(72) Inventors: Joseph Valinsky, Moorestown, NJ (US); Michael Rehrig, Moorestown, NJ (US); William Landi, Moorestown, NJ (US); Zachary Davis, Moorestown, NJ (US)

(21) Appl. No.: 18/582,400

(22) Filed: Feb. 20, 2024

Related U.S. Application Data
(63) Continuation of application No. PCT/US24/16389, filed on Feb. 19, 2024.
(60) Provisional application No. 63/446,575, filed on Feb. 17, 2023.
(60) Provisional application No. 63/590,647, filed on Oct. 16, 2023.

(51) Int. Cl. B65G 1/137; B65G 1/04

(52) U.S. Cl. CPC B65G 1/1376; B65G 1/0492

(57) ABSTRACT

A method and apparatus are provided for sorting items to a plurality of sort bins. After the items are sorted into the sort bins the sort bins may be automatically emptied into separate containers. Alternatively, the sort bins may be discharged from the apparatus to be processed at a remote destination. The apparatus may include a plurality of delivery vehicles for delivering items to the sort bins. The apparatus may further include a plurality of retrieval vehicles for retrieving the sort bins after all the items for a grouping are sorted to the bin. The retrieval vehicles may be configured to move the retrieved bins to one or more discharge stations where the items in the sort bins may be emptied into separate containers such as boxes for shipping the items.

### REFERENCE TO RELATED APPLICATIONS

The present application is claims priority to PCT Application No. PCT/US24/16389, filed on Feb. 19, 2024, which claims priority to U.S. Provisional Application No. 63/590,647, filed Oct. 16, 2023, which claims priority to U.S. Provisional Application No. 63/446,575, filed on Feb. 17, 2023. The entire disclosure of each of the foregoing applications is hereby incorporated herein by reference.

### FIELD OF THE INVENTION

The present invention relates generally to a material handling system and in particular to a system operable to receive and sort items into a plurality of bins or other displaceable containers. The system may include a retrieval mechanism for retrieving the bins after items have been sorted into the bins.

### BACKGROUND OF THE INVENTION

The inventors herein have observed that accumulating items of inventory to form respective groups of items, for such purposes as the fulfillment of corresponding orders to be shipped to customers or retail points of sale and/or in the processing of returns of such items, can be laborious, time consuming, inefficient, and prone to error. These and other disadvantages are most keenly felt when the items must be retrieved from (or returned to) inventory in great numbers from scattered locations within a warehouse or other large facility. By way of illustration, a single order fulfillment center may receive thousands or more orders a day, with each order requiring one, several, or many different items to be retrieved from inventory and combined in one or more containers for shipment to a customer. The most inefficient approaches still in use today require inventory items to be processed in a single step by retrieving the items manually from storage areas (e.g., by batch or wave picking) and placing them directly into the container(s) for shipment. Slightly less efficient approaches involve placing items, in a first step, into temporary item accumulation areas or cells of a “put wall” and then, in a second step, transferring the accumulated group of items into a shipping parcel or carton. After all the items for an order have been accumulated in the aforementioned manner, the packaging process is completed and the parcel, carton or other container may be shipped directly to a customer

A more sophisticated system than the prior art systems described above is disclosed in U.S. Pat. No. 11,607,713, a patent commonly owned by OPEX Corporation, assignee of the present invention and issued to McVaugh et al. on Mar. 21, 2023. McVaugh et al disclose sortation of items by vehicles movable within in an aisle disposed between rows and/or columns of sort bins. Items are delivered by the vehicles, in seriatim, in their order of arrival at an input station. In an embodiment disclosed by McVaugh et al., the delivery system is implemented as a plurality of independently movable vehicles, and an indication is provided to alert attending personnel to events such as the readiness of a sort bin to be transferred to a container that is displaceable to another destination.

Though the McVaugh et al. system represented a major advance in the art, the inventors herein have observed that a substantial amount of manual operation is still required once items have been sorted into the array of sort bins, with the potential for damage to the sorted items during the requisite handling. With continuing pressure to increase processing speeds and reduce manual operations required in a sorting system, it is desirable to reduce the manual processing needed to handle orders after the items have been sorted.

### SUMMARY OF THE INVENTION

The Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In accordance with embodiments of the present disclosure, the disadvantages and problems associated with conventional warehouse automation approaches to the sortation of inventory items into groups, and subsequent operations relating to the groups of sorted items, have been substantially reduced or eliminated by a sortation system configurable to perform a variety of tasks relevant to an inventory management, distribution center, and/or order fulfilment operation.

The present disclosure provides a number of aspects that may form part of a material handling system. The system may include one or more of a number of aspects of the invention as further described below.

In embodiments consistent with the present disclosure, an apparatus for sorting a plurality of items is provided. In one embodiment, the apparatus includes a plurality of sort bins, each sort bin defining an interior volume and having an inlet opening; a rack that is configured to retain each sort bin at a respective location spatially separated from other locations. The sort bins retained by the rack are organized into rows and/or columns and maintained in a configuration and orientation enabling the accumulation of items in each sort bin. The sort bins are arranged along one or both sides of an aisle within which is movable (1) an item sortation system, which accepts items arriving at an input station of the apparatus, transports the items within the aisle, and operates a first transfer mechanism to delivery items one at a time to one or more of the sort bins and (2) a sort bin retrieval mechanism operative to retrieve sort bins containing accumulated items of a groups and transport the sort bins to a transfer location disposed within the aisle and proximate a discharge station of the apparatus.

In embodiments, the sort bin retrieval mechanism extends a second transfer mechanism at the transfer location to initiate, at a discharge station, the discharge of accumulated items of a group out of a sort bin into a container that is displaced from the aisle. Alternatively, or in addition, the sort bin retrieval mechanism extends a second transfer mechanism to displace, away from the aisle, a sort bins together with the accumulated items of a group contained therein. In such an embodiment, the exiting sort bin is replaced by an empty sort bin.

In some embodiments, the sortation system movable within the aisle comprises a plurality of independently movable vehicles that are respectively movable along path segments of a vertical loop extending within the aisle. Each of at least a first group of the independently movable vehicles are movable along a corresponding item delivery path that encompasses an input station, where items are transferred onto a vehicle of the plurality of vehicles, and a delivery location adjacent to a sort bin retaining location of the rack. Each item delivery path may comprise contiguous horizontal and/or vertical segments of a vertical loop within the aisle.

In addition, or alternatively, each of at least a second group of the independently movable vehicles are respectively movable along segments of a vertical loop extending within the aisle. Each of at least a second group of the independently movable vehicles are movable along path segments of a corresponding sort bin retrieval path that encompasses a position within the aisle from which sort bins are extracted onto a vehicle, and position with the aisle from where sort bins are transferred from the vehicle and away from the aisle into a sort bin discharge station, which may be a zone for emptying accumulated items into a container displaced from the aisle. The sort bin retrieval path may comprise contiguous horizontal and/or vertical segments of a vertical loop within the aisle.

In embodiments, the discharge station defines one or more discharge zone(s) dimensioned and arranged to receive a sort bin of the plurality of sort bins following accumulation of items therein, wherein vehicles of at least a second group of the plurality of vehicles are movable along a horizontal and/or a vertical segment of a sort bin retrieval path extending from a retrieval location adjacent to a sort bin retaining location of the rack structure to a location adjacent to the at least one discharge zone of the discharge station.

According to one aspect of the invention, an apparatus for sorting a plurality of items is provided. The apparatus includes a plurality of sort bins and a rack defining an aisle and configured to support the plurality of sort bins at spatially separated locations along at least a first or second side of the aisle. The apparatus further includes a delivery mechanism operable within the aisle for delivering items to the sort bins and a retrieval mechanism operable within the aisle for retrieving the sort bins after items are sorted into the sort bins.

According to one aspect, a first group of sort bins of the apparatus is supported by the rack along a first side of the aisle, and a second group of sort bins is located along a second side of the aisle, the retrieval mechanism being operable to move the sort bins into the aisle from storage locations within the rack. According to another aspect, the retrieval mechanism is moveable within the aisle in a vertical and/or horizontal direction.

In some embodiments, the delivery mechanism and/or the retrieval mechanism are realized by a plurality of independently operable vehicles. All or a subset of the vehicles may perform a delivery function, and all or a subset of the vehicles may perform a retrieval function. In an embodiment, vehicles performing the delivery (delivery vehicles) function include a transfer mechanism operable in a first direction to transfer items from the delivery vehicles into one of the sort bins along the first side of the aisle and is operable in a second direction to transfer items from the delivery vehicle into one of the sort bins along the second side of the aisle. The delivery vehicles may be controlled within the aisle to move along segments of a vertical loop that encompasses an input station where items are received from outside the aisle and one or more of the sort bins,

According to one aspect of embodiments in which the delivery mechanism and/or the retrieval mechanism comprises vehicles, each vehicle comprises an energy storage device for providing power for operation of the vehicle and wherein a charging element is provided within the aisle for charging the vehicles as the vehicles move within the aisle.

According to any of the foregoing embodiments which utilize vehicles as the delivery and/or retrieval mechanism, the apparatus may include a track for guiding the vehicles to the sort bins. In some such embodiments, both the retrieval mechanism and the delivery mechanism is realized as a plurality of vehicles movable within an aisle disposed between first and second groups of sort bins, and each vehicle incorporates either or both of a first transfer mechanism operable to discharge items into the sort bins outside of the aisle and a second transfer mechanism extendable in a first direction to retain and retract a sort bin from its support location along the rack into the aisle for movement within the aisle. In such embodiments, the second transfer mechanism is further configured to extend out of the aisle into a discharge position.

According to another aspect of the invention, the apparatus comprises one or more discharge stations configured to receive one of the sort bins after items have been sorted to the sort bin. In one embodiment, the sort bins include a movable wall and the discharge stations are configured to facilitate movement of the moveable wall when one of the sort bins is transferred into the discharge station so that items can be discharged from the sort bin.

A method of sorting items into groups, comprises loading, at a loading station, a plurality of items one at a time onto a delivery mechanism movable within an aisle; operating the delivery mechanism within the aisle to deliver items to respective sort bins of a plurality of sort bins disposed along the aisle, the operating including transporting each loaded item along a vertical loop within the aisle, the vertical loop encompassing the loading location and a respective destination adjacent one of the sort bins, and operating transfer mechanisms of the delivery mechanism to respectively deposit items into the sort bins to accumulate groups of items in the sort bins; determining that a group of items assigned to a sort bin have been accumulated in a first sort bin; and retrieving the first sort bin, the retrieving including moving a retrieval mechanism within the aisle to a position proximate the first sort bin; displacing the first sort bin and the accumulated items into the aisle while retaining the first sort bin; transporting the first sort bin within the aisle to a first discharge station; discharging the accumulated items from the first sort bin at the first discharge station into a first container that is spaced apart from the aisle; and displacing the first container away from the first discharge station.

### BRIEF DESCRIPTION OF THE DRAWINGS

The foregoing summary and the following detailed description of embodiments of the present invention will be best understood when read in conjunction with the appended drawings, in which the same reference numbers will be used throughout the drawings to refer to the same or like parts:

FIG. 1 is a plan view of a material handling apparatus incorporating aspects of the present invention.

FIG. 2 is a fragmentary perspective view of the material handling apparatus illustrated in FIG. 1

FIG. 3 is a side view of the material handling apparatus illustrated in FIG. 1.

FIG. 4 is an end view of the material handling apparatus illustrated in FIG. 1.

FIG. 5 is a fragmentary side view showing a portion of a track of the material handling apparatus illustrated in FIG. 1.

FIG. 6 is a plan view of a delivery vehicle of the material handling apparatus illustrated in FIG. 1.

FIG. 7 is an end view of the delivery vehicle illustrated in FIG. 6.

FIG. 8 is a perspective view of a retrieval vehicle of the material handling system illustrated in FIG. 1.

FIG. 9 is a perspective view of the retrieval vehicle illustrated in FIG. 8 illustrating a retrieval assembly in an extended position.

FIG. 10 is a perspective view of the retrieval vehicle illustrated in FIG. 9 illustrating retrieval latches in an extended position.

FIG. 11A is a perspective view of the retrieval vehicle illustrated in FIG. 8 positioned adjacent a sorting location of the material handling apparatus illustrated in FIG. 1.

FIG. 11B is a perspective view of the retrieval vehicle illustrated in FIG. 11A illustrating a bin retainer in a retracted position.

FIG. 11C is a perspective view of the retrieval vehicle illustrated in FIG. 11A with the bin partially retrieved from the sorting location.

FIG. 11D is a perspective view of the retrieval vehicle illustrated in FIG. 11A with the bin loaded onto the retrieval vehicle.

FIG. 12A is a perspective view of the retrieval vehicle illustrated in FIG. 11A at a discharge station, with the discharge station partially broken away.

FIG. 12B is a perspective view of the retrieval vehicle illustrated in FIG. 12A at the discharge station.

FIG. 12C is a lower perspective view of the retrieval vehicle illustrated in FIG. 12A showing the bin extended over the discharge station.

FIG. 13A is an enlarge end view of a bin positioned in a sorting location of the material handling apparatus illustrated in FIG. 1.

FIG. 13B is an enlarged end view of the bin illustrated in FIG. 13A with a bin retainer shown in a retracted position.

FIG. 14 is an enlarged perspective view of an alternate embodiment of the bin illustrated in FIG. 13A.

FIG. 15 is an enlarged perspective view of a discharge station of the material handling system illustrated in FIG. 1.

FIG. 16 is an enlarged perspective view of a conveyor of the discharge station illustrated in FIG. 15.

FIG. 17 is a plan view of the conveyor illustrated in FIG. 16.

FIG. 18 is an end view of the conveyor illustrated in FIG. 17.

FIG. 19 is a side view of the discharge station illustrated in FIG. 15.

FIG. 20 is a side view of the discharge station illustrated in FIG. 19 with a carton retainer illustrated in an actuated position.

FIG. 21 is an end view of the discharge station illustrated in FIG. 19.

FIG. 22A is a perspective view of an alternate discharge station.

FIG. 22B is a perspective view of the discharge station illustrated in FIG. 22A showing the bin in position over an empty carton.

FIG. 22C is a perspective view of the discharge station illustrated in FIG. 22A showing the bin in position after discharging items into the empty carton.

FIG. 23A is a perspective view of a second alternate discharge station.

FIG. 23B is a perspective view of the discharge station illustrated in FIG. 23A showing the bin in position over an empty carton.

FIG. 23C is a perspective view of the discharge station illustrated in FIG. 23A showing the bin in position after discharging items into the empty carton.

FIG. 24A is a block diagram depicting aspects of a warehouse operation or distribution center utilizing a warehouse management system and integrating aspects of a material handling apparatus constructed according with an exemplary embodiment consistent with the present disclosure;

FIG. 24B is a block diagram depicting, in greater detail, a warehouse management system utilizing a material handling apparatus configured to integrate the functions of item sortation to sort bins and sort bin retrieval, discharge, and/or exchange according to one or more embodiments of the present disclosure;

FIG. 25A is a block diagram depicting, in greater detail, a sorting and bin retrieval/discharge/exchange (SBRE) system constructed in accordance with an exemplary embodiment of the present disclosure;

FIG. 25B is a block diagram depicting the functional components of an exemplary item induct station, which may form part of the exemplary system of FIG. 25A according to one or more embodiments consistent with the present disclosure;

FIG. 25C is a top plan view depicting components of the exemplary item input station of FIG. 25B, according to one or more embodiments consistent with the present disclosure;

FIG. 25D depicts an exemplary discharge assistant that includes a plurality of conveyors, a controller, and a path jam sensor, according to one or more embodiments consistent with the present disclosure;

FIG. 25E depicts a process for controlling the exemplary discharge assistant of FIG. 25D, according to one or more embodiments consistent with the present disclosure;

FIG. 26 is a graphical representation depicting an exchange of messages and/or instructions between logical control elements of a sorting and bin retrieval/discharge/exchange (SBRE) system according to embodiments;

FIG. 27 is a flow chart depicting an automated process for performing sortation of accumulated groups of items into sort bins, operating vehicles to retrieve sort bins containing accumulated groups, and operating vehicles within the aisle to transfer the contents of sort bins into another container and/or to exchange the sort bins containing an accumulated group with an empty container for one containing a partial group of items to be combined with other items;

FIG. 28 is a flow chart depicting an exemplary process for assigning groups or subgroups of items to sort bin locations according to one or more embodiments;

FIG. 29 is a flow chart depicting an exemplary item delivery vehicle traffic control process to coordinate movement of delivery vehicles during sortation of items according to one or more embodiments;

FIG. 30 is a flow chart depicting an exemplary sort retrieval vehicle traffic control process to coordinate movement of sort bin retrieval vehicles while sortation and sort bin retrieval operations are being performed at the same time within an aisle;

FIG. 31A is a flow chart depicting a sort bin sequencing process to combine contents of multiple sort bins in the same container according to one or embodiments consistent with the present disclosure;

FIG. 31B is a flow chart depicting a sort bin discharge and/or exchange process according to one or embodiments consistent with the present disclosure;

FIG. 32 is a flow chart depicting a modified sort bin sequencing process which utilizes determined information about one or more item or item group characteristic(s) to determine the order in which the contents of multiple sort bins are to be combined in the same container, according to one or embodiments consistent with the present disclosure; and

FIG. 33 is a detailed block diagram of a computer system, according to one or more embodiments, that can be utilized in various embodiments of the present invention to implement the computer and/or the display devices, according to one or more embodiments.

Some portions of the detailed description which follow are presented in terms of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

### DETAILED DESCRIPTION OF THE INVENTION

Systems and techniques for automating the accumulation of one or more items, at respective sort destinations, to form corresponding groups of items (e.g. for shipment to customers in fulfillment of orders or, in the case of a distribution center, to destinations such as stores or, in the reverse direction, for batch replenishment of returned items to inventory) are described. In some embodiments, items are automatically identified at a scanning station as they are conveyed along or passed between conveyor stages of an induct module. In other embodiments, items are individually scanned and transferred to a delivery mechanism. Optionally, one or more characteristics (e.g., weight, length, height or width) are determined by reference to data associated with the identification. Additionally, or alternatively, one or more sensors of the induct module may be operated to determine the one or more characteristic(s). In embodiments, each item so identified and/or characterized is transferred from a transfer conveyor of the induct module to an item delivery system such, for example, individually movable delivery vehicles that are movable along horizontal and/or vertical segments of an item delivery path.

In embodiments, elements of the delivery system are movable within an aisle that extends parallel to a horizontal or vertical array of storage locations. Each delivery vehicle is self-propelled and includes a discharge mechanism for transferring, to a sort location with which it is aligned, the item it received from the induct module and carried to that sort location. In some embodiments, the discharge mechanism is a conveyor configured to move an item along a discharge path transverse to the orientation of the aisle within which the vehicle moves.

According to one aspect, an apparatus for sorting a plurality of items to individually displaceable locations such as sort bins is provided. In an embodiment, the apparatus includes a plurality of sort bins, each sort bin defining an interior volume and having an inlet opening; a rack structure, the rack structure including a support frame configured to retain each sort bin at a respective location spatially separated from other locations whereby the sort bins are organized into rows and/or columns and maintained in a configuration enabling accumulation of items; a plurality of independently movable vehicles movable along a horizontal and/or a vertical segment of an item delivery path extending from an input station where items are transferred onto a vehicle of the plurality of vehicles to a terminal location adjacent to a sort bin retaining location of the rack structure, wherein vehicles of at least a first group of the plurality of vehicles are configured to deliver an item received at the input station to a sort bin temporarily associated with a group of items to be sorted; and a discharge station defining at least one discharge zone dimensioned and arranged to receive a sort bin of the plurality of sort bins following accumulation of items therein, wherein vehicles of at least a second group of the plurality of vehicles are movable along a horizontal and/or a vertical segment of a sort bin retrieval path extending from a retrieval location adjacent to a sort bin retaining location of the rack structure to a terminal location adjacent to the at least one discharge zone of the discharge station.

Vehicles of the second group of vehicles are constituent elements of a retrieval system, each vehicle of the second group including a first transfer mechanism configured to extract sort bins containing a group of items from sort bin retaining locations of the rack structure and to re-insert sort bins from which a group of items has been discharged into a sort bin retaining location of the rack structure, whereby re-inserted sort bins may be temporarily associated with another group of items to be sorted.

In embodiments, vehicles of the first group of vehicles are constituent elements of a sortation system, wherein each vehicle of the first group includes a second transfer mechanism configured to transfer an item received at the input station to a sort bin of the plurality of sort bins.

In some embodiments, the support frame of the rack structure includes two sections separated by an aisle through which the first and second groups of vehicles are free to move vertically and/or horizontally. In an embodiment, the sort bins are arranged in first and second groups wherein each group is arranged in rows and columns and wherein each vehicle of the first group of vehicles and of the second group of vehicles are movable along horizontal and vertical path segments within the aisle.

In an embodiment, the sort bins include a gravity operated trap door mechanism, with opening of the trap door mechanism being initiated by extending, in a first direction, a retrieved sort bin that contains sorted items. The first direction is away from the terminal location and into a first position over a discharge zone of the discharge station. Closing of the trap door mechanism is initiated by retracting a sort bin from a position over a discharge zone of the discharge station and onto a vehicle of the second group of vehicles.

In some embodiments, the discharge station further includes a chute defining an item receiving surface portion disposed directly beneath a first discharge zone of the discharge station whereby items discharged by a sort bin and landing upon the chute slide down toward a displaceable container disposed at a second discharge zone of the discharge station. Alternatively, or in addition, the discharge station further includes a discharge assisting conveyor system having a first conveyor. An item receiving surface portion of the first conveyor is disposed directly beneath a first (or third, as the case may be) discharge zone, whereby the first conveyor is configured to direct items, discharged from a sort bin, in a direction of conveyance toward and/or away from a displaceable container disposed at a second (or fourth, as the case may be) discharge zone of the discharge station.

In an embodiment, the discharge assisting conveyor system further includes a second conveyor defining an item engaging surface dimensioned and arranged to impart frictional forces to discharged items moving in the direction of conveyance upon the first conveyor, the second conveyor being dimensioned and arranged along a first lateral side of the transfer accepting surface of the first conveyor; and a third conveyor defining an item engaging surface dimensioned and arranged to impart frictional forces to discharged items moving in the direction of conveyance upon the first conveyor, the third conveyor being dimensioned and arranged along a second lateral side of the transfer accepting surface of the first conveyor. The item engaging surfaces of the second and third conveyors diverge relative to one another with a surface of each of the second and third conveyors forming an obtuse angle relative to the transfer accepting surface of the first conveyor.

The discharge assisting conveyor system further includes one or more sensors dimensioned and arranged to determine that the discharge assisting conveyor system is unable to advance an item in a direction of conveyance toward a destination container; and a controller operatively associated with the second and third conveyors and responsive to the one or more sensors to cause the second and third conveyors to impart, to a jammed item unable to advance toward a destination container, frictional forces in opposite directions upon a jammed item to facilitate resolution of a jam.

In embodiments, the controller is further responsive to the one or more sensors to cause the first, second and third conveyors to impart, to an item, frictional forces in a common direction of conveyance when items can advance toward a destination container (i.e., in the absence of an item being in a jammed condition).

In addition to or as an alternative to the incorporation of a chute and/or a discharge conveying system in accordance with the preceding embodiments, an apparatus according to an embodiment of the present invention may further include an outfeed conveyor configured to direct displaceable containers received from a discharge zone of the discharge station to another destination.

In addition to, or as an alternative to the incorporation of a chute and/or a discharge in accordance with the preceding embodiments, the discharge station of an apparatus according to an embodiment of the invention defines an input/output (I/O) transit zone dimensioned and arranged to receive a sort bin of the plurality of sort bins following accumulation of items therein, wherein vehicles of at least the second group of the plurality of vehicles are movable along a horizontal and/or a vertical segment of a sort bin retrieval path extending from a retrieval location adjacent to a sort bin retaining location of the rack structure to a terminal location adjacent to the I/O transit zone; and wherein the discharge station further includes an I/O conveyor system configured to accept retrieved sort bins delivered to the I/O transit zone by a vehicle of the second group, to transport accepted received sort bins to a remote destination, to receive sort bins arriving from a remote destination, and to transfer sort bins arriving from a remote destination to the I/O transit zone, whereby item-containing sort bins retrieved from a sort bin location of the rack structure may exit the I/O transit zone via the I/O conveyor system and empty sort bins and/or sort bins containing less than all items required for an order group may be restored to a sort bin location of the rack structure via the I/O transit zone.

In some embodiments, segments of the item delivery path along which vehicles of the plurality of vehicles move form a vertical loop within an aisle defined by the rack structure Each delivery vehicle may include an energy storage device for providing power for operation of the delivery vehicle. The system may also include a charging element within the aisle for charging the delivery vehicles as the delivery vehicles move within the aisle. In an embodiment, a track is positioned within the aisle for guiding a first group of vehicles to the sort bins. Additionally, the track may also be configured to guide the retrieval vehicles to the sort bins.

Reference will now be made in detail to exemplary embodiments of the present invention, examples of which are illustrated in the accompanying drawings. Wherever possible, the same reference numbers will be used throughout the drawings to refer to the same or like parts.

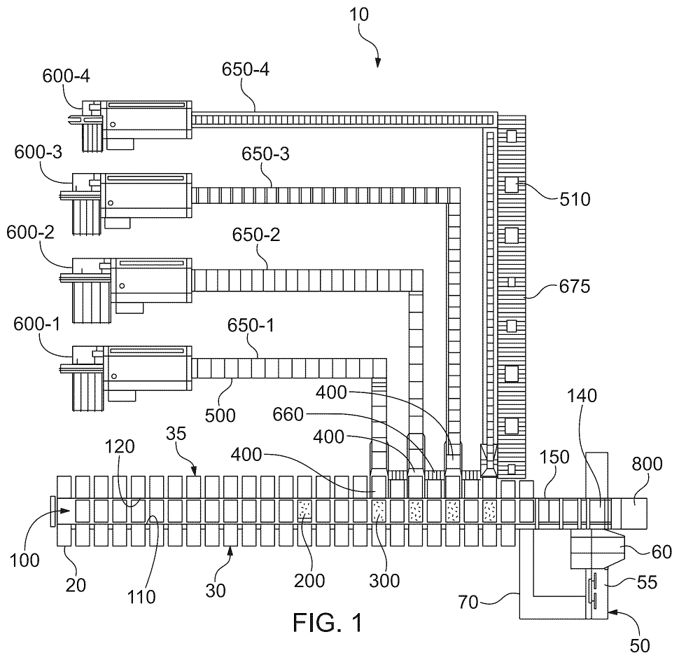

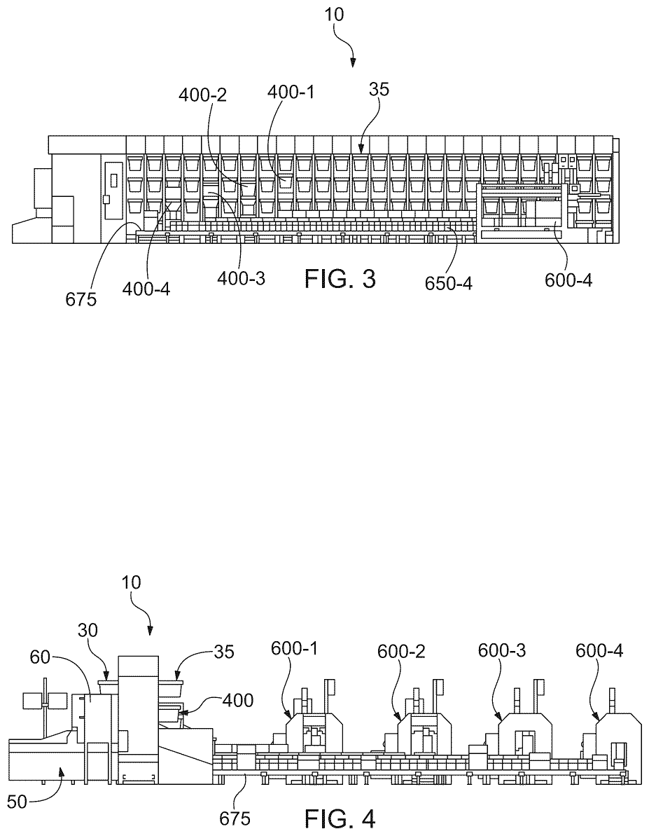

Referring now to FIGS. 1-4, a material handling system is designated generally 10. The system includes a sorting system 15 that sort items into a plurality of sort locations, such as sort bins 20. After items are sorted into a sort bin 20, the bin is retrieved and delivered to a discharge location 400. At the discharge location, the items are discharged from the bin into a container, or the entire bin is discharged from the sorting system onto an output conveyor 700 so that the bin can be conveyed to another area.

The sorting system 15 may include a plurality of bins arranged in a series of rows or columns forming a first group of bins 30. A second group of bins 35 may be spaced apart from the first group of bins so that an aisle 100 is formed between the groups of bins. A plurality of delivery vehicle 200 may travel within the aisle 100 to delivery items to the different bins 20.

A group of items may be delivered to one of the bins. Once the last item in the group is delivered to the bin, the items are retrieved and sent off for delivery. For instance, a retrieval vehicle may retrieve the bin after the group of items is delivered to the bin. The vehicles may be configured so that the vehicles can deliver items to the bins and also retrieve the bins once the group of items have been delivered to the bin. Additionally, as discussed below, the system may include a first type of vehicle referred to as a delivery vehicle 200 for delivering items to the bins and a second type of vehicle referred to as a retrieval vehicle 300 for retrieving the items once the group of items have been delivered to the sort bin.

The delivery vehicles may be configured so that a plurality of delivery vehicles 200 operate independently at the same time to deliver a plurality of items. Additionally, the delivery vehicles 200 may travel within the aisle 100 to deliver items to the sort bins 30, 35. Optionally, the delivery vehicles 200 may move from a loading station 145 to one of the delivery vehicles and then return to the loading station so that another item can be delivered to one of the bins.

As discussed above, a plurality of delivery vehicles may deliver a group of items to one of the bins. A bin may be considered full either when the bin has received a certain volume of items or when all the items of a group (such as an order) have been sorted to the bin. Once a bin is full the system may automatically retrieve the bin so that the items may be emptied from the bin. In one embodiment, the system automatically retrieves the bin using a retrieval vehicle 300 that operates within the aisle 100.

The retrieval vehicle 300 may move within the aisle 100 to a position adjacent the full bin 20. The retrieval vehicle may then transfer the full bin onto the retrieval vehicle. The retrieval vehicle then moves within the aisle while carrying the full bin to a location where the group of items in the bin can be transferred out of the aisle.

For instance, the group of items in the full bin may be discharged at a discharge station 400. Specifically, the items may be emptied out of the full bin onto a conveyor operating outside of the aisle. Alternatively, the group of items may be emptied into a box or other container that is disposed outside of the aisle and away from the front and rear racks 30,35 of bins.

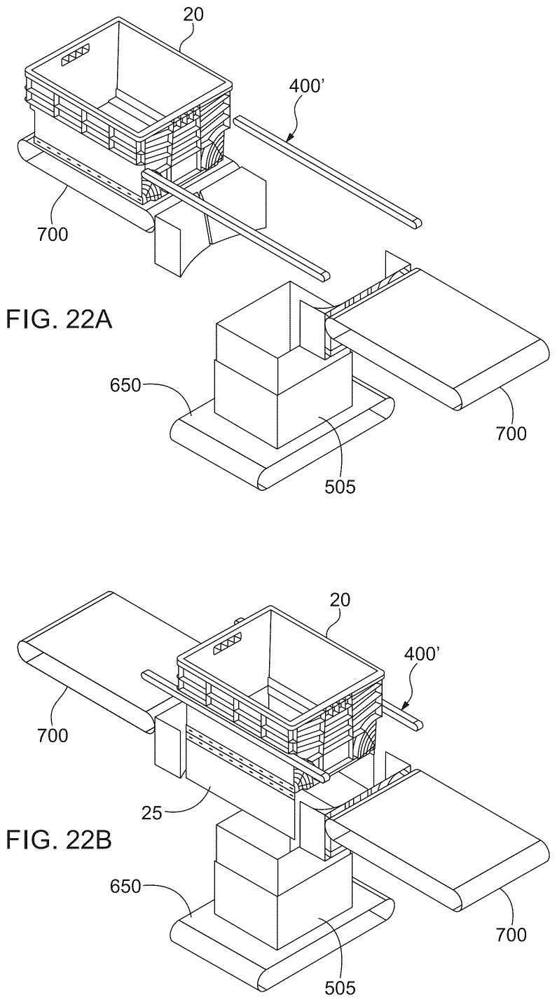

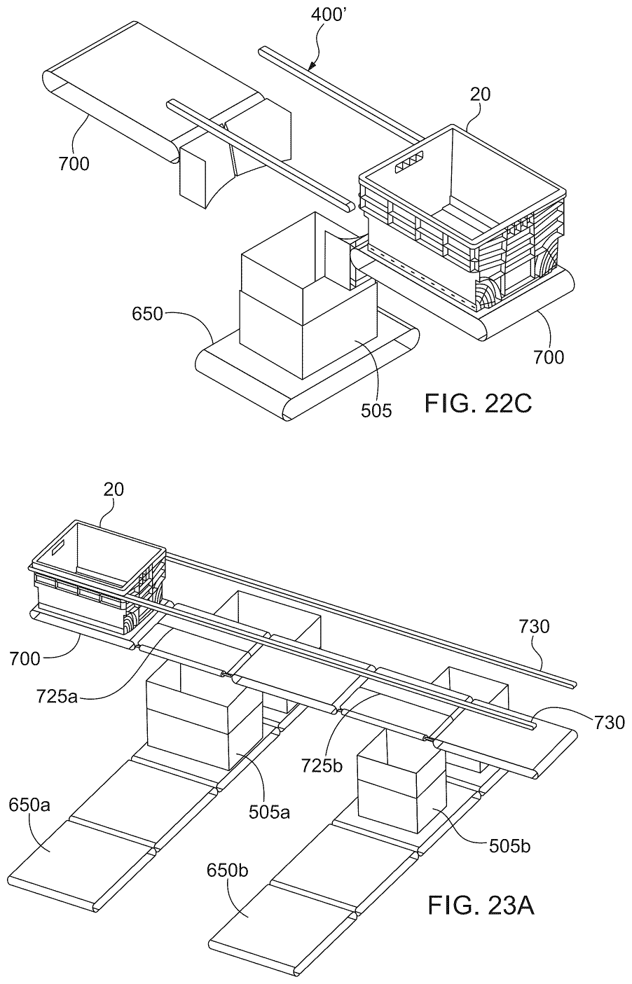

Additionally, rather than emptying the full bin at a discharge location, the full bin may be transferred to a conveyor or other item that is moveable outside of the aisle. For instance, the retrieval vehicle may move the full bin to an output location. At the output location, the retrieval vehicle may transfer the full bin out of the aisle and onto a conveyor or other vehicle that operates outside of the aisle. For instance, referring to FIG. 22A, the retrieval vehicle 300 may transfer the full bin 20 onto an output conveyor 700 that transfers the full bin away from the sorting system 15.

The system 10 may also incorporate an apparatus for supplying empty containers for receiving the contents from a full bin. For instance, the system may include an apparatus for creating containers such cardboard boxes, designated 600-1 to 600-4 in FIG. 1. The box erectors 600-1,2,3,4 are configured to fabricate a plurality of boxes. Each erector may be configured to erect a different size container or box. The empty containers are automatically conveyed to the discharge stations 400 so that the contents of a full bin can be emptied into an empty box. The box may then optionally be conveyed away from the discharge station, such as by a conveyor 660.

In the configuration illustrated in FIG. 1, each erector 600-1,2,3,4 produces a different size box and each erector supplies boxes to a different discharge station 400 of the sorting system 15. In this way, the system can determine the appropriate discharge station based on the volume of items sorted into the sort bin and the volume of the empty boxes at each discharge station. Once the appropriate discharge station is identified, the retrieval vehicle conveys the full bin to the appropriate discharge station and empties the items from the full bin into the box at the discharge station.

As described further below, rather than a series of erectors 600-1,2,3,4 supplying empty containers to a single sorting system 15, the system 10 may include a series of sorting systems similar to sorting system 15 and the erectors may feed s series of empty containers from the erectors to each of the sorting systems 15.

The system 10 may include a central controller 800 to control various aspects of the system and to provide control signals to various components of the system. The central controller may include one or more microprocessors. Additionally, the central controller 800 may be connected with a warehouse management system (WMS) that provides signals to the system 10 regarding the groupings into which the items are to be sorted. For instance, the WMS may indicate which items are to be grouped together to form an order. In this way, the WMS may provide information to the central controller about the grouping of items and the central controller 800 controls the operation of various items, such as delivery vehicles, gates, scanners etc to sort the items in accordance with the information received from the WMS.

### Sorting System

Referring to FIGS. 1-5, details of the sorting system 15 of the material handling apparatus 10 will be described in greater detail. The material handling system 10 may incorporate any of a variety of systems that sort items into a series of bins. In the embodiment illustrated in FIGS. 1-5, the sorting system utilizes an aisle-based system in which a sorting device operates within an aisle 100 that is disposed between opposing racks 30, 35 of bins 20. Any of a variety of aisle-based sorting systems can be used. In the present instance, the sorting system 15 incorporates a plurality of delivery vehicles 200 that operate independently within the aisle 100.

The sorting system 15 illustrated in FIG. 1 includes a front rack 30 of sort locations on one side of the aisle 100 and a rear rack 35 of sort locations on a second side of the aisle. The sort bins 20 in the racks 30, 35 may be arranged in a series of columns or a series of rows. It should be understood that the term rack simply refers to any structure that supports a plurality of sort bins.

As noted above, the sorting system 15 may include a plurality of vehicles 200 that operate within the aisle 100 to sort items to the sort bins 20. The delivery vehicles 200 may be configured to move horizontally and/or vertically within the aisle to deliver items to the sort locations. For example, the system may include a plurality of rows that are vertically spaced apart from one another and the delivery vehicles may move independently along horizontal guides or tracks on each row in the aisle. Additionally, the system may include a mechanism for moving the delivery vehicles vertically within the aisle. For instance, elevators or lifting mechanisms can be used to raise or lower the delivery vehicles between the rows. The elevators/lifts can be positioned at various points within the aisle. One example is an embodiment in which a first elevator or lift is positioned at one end of the aisle to lift the delivery vehicles from a lower row to an upper row and a second elevator or lift is positioned at a second end of the aisle to lower the delivery vehicles from an upper row to a lower row.

In the sorting system 15 illustrated in FIGS. 1-5, the system uses a plurality of independently operable vehicles that are operable to climb vertically within the rack without assistance of an elevator or lift.

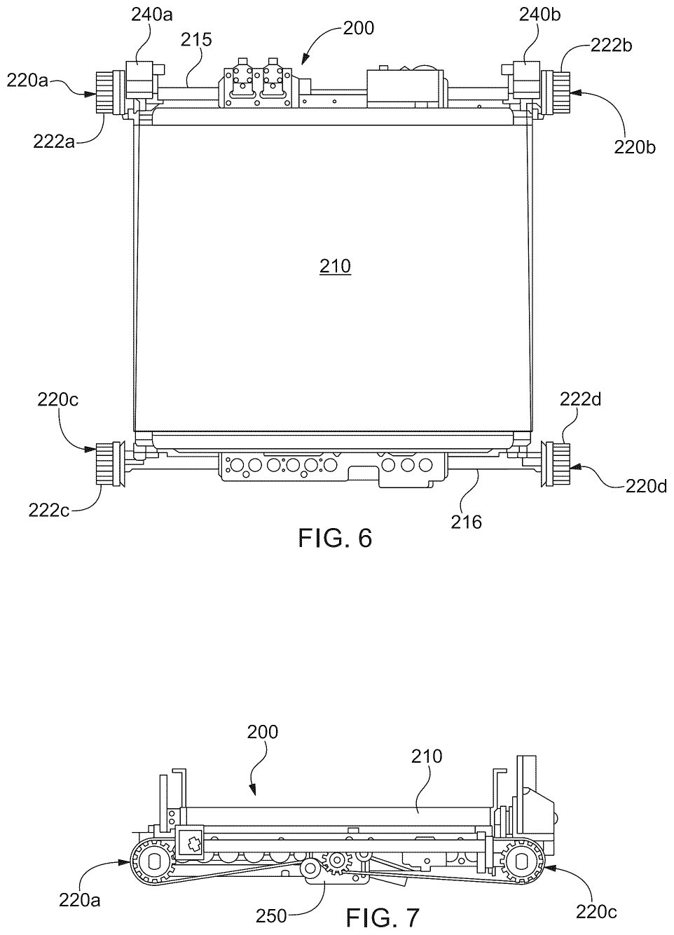

The sorting system may use a guide system such as a track 105 for guiding the delivery vehicles as they move within the aisle. It should be understood that the term track refers to any structure configured to support or guide the vehicles as the vehicles move. For instance, the guide system 105 may include a front track 110 that extends along the aisle adjacent the front rack 30 and a rear track 120 that extends along the aisle adjacent the rear rack 35. In this way, the front track 110 supports and/or guides a first side of the delivery vehicles 200 and the rear track supports and/or guides a second side of the delivery vehicles. For instance, as shown in FIGS. 6-7, the delivery vehicles 200 may include a drive system that includes two pairs of wheels: a pair of forward wheels indicated generally at 220a and 220c, and a pair of rearward wheels indicated generally at 220b and 220d. Wheels 220a and 220b are coupled to axle 215 for rotation therewith, while wheels 220c and 220d are coupled to axle 216 for rotation therewith. The forward wheels 220a and 220c ride in the front track 110, while the rearward wheels 220b and 220d ride in the rear track 120.

At a loading station 145 items are loaded onto the delivery vehicles 200. Each vehicle may carry a plurality of items. Alternatively, each delivery vehicle 200 may carry a single item as described further below. After an item is loaded onto one of the delivery vehicles, the delivery vehicle follows a path to one of the sort bins 20. The delivery vehicle transfers the item into the sort bin and follows a path to return to the loading station to receive another item.

Each delivery vehicle may follow a different path from the loading station to one of the sort locations. The track 105 may include a plurality of vertical and horizontal track segments that guide the delivery vehicles as the delivery vehicles move from the loading station to the sort bin and then back to the loading station.

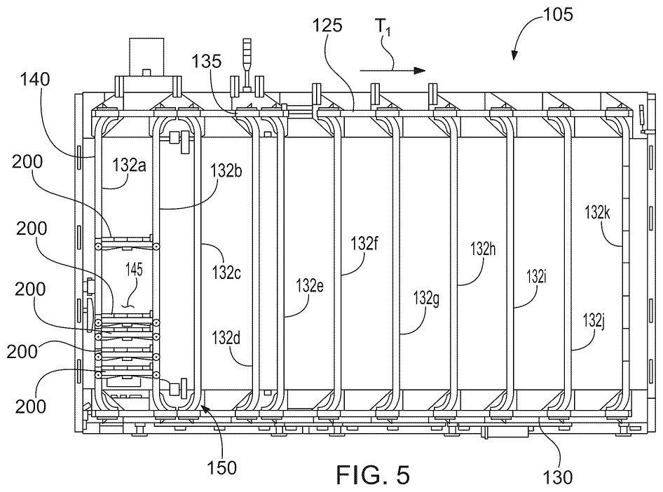

The vertical and horizontal track segments may form a path in the shape of a vertical loop in the aisle. For instance, referring to FIGS. 1 & 5, the track 105 may include a front track 125 and a rear track. In FIG. 5, the front track is illustrated, and it should be understood that the rear track is substantially similar to the front track so that the rear track mirrors the front track.

The front track may have an upper track segment 125 and a parallel lower track segment 130. A plurality of vertical tracks 132 may connect the upper track with the lower track. As shown in FIG. 5, the vertical tracks 132 may separate the track into a series of columns along which the vehicles may move up or down to one of the sort bins. Alternatively, as described previously, the track may include a plurality of horizontal tracks that separates the track into a series of rows along which the vehicles may move along to one of the sort bins 20.

In the track illustrated in FIG. 5, the track includes a plurality of vertical columns. Each column is defined by a pair of vertical tracks. The delivery vehicle may move vertically upwardly or downwardly within the column. For instance, vertical tracks 132a and 132b define a first column to guide the delivery vehicles. This first column may be a loading column 140 having a loading station 145 at which each vehicle receives an item to be delivered to one of the sort bins 20.

The track 105 may include columns that share vertical track and columns that have separate vertical tracks. For instance, as shown in FIG. 5, a second column is defined by vertical tracks 132c and 132d and delivery vehicles can move vertically upwardly or downwardly within this second column. The second column does not share any vertical tracks with the first column. In contrast, a third column is formed by vertical tracks 132e and 132f and a fourth column is formed by vertical tracks 132f and 132g. In this way, the third and fourth column share a vertical track.

A plurality of gates 135 may be positioned along the track to guide the delivery vehicles along the track. For instance, a delivery vehicle may move horizontally along the upper track 125 until it reaches the column having the sort bin 20 to which the delivery vehicle is to deliver an item. Once the delivery vehicle reaches the appropriate column, the gates fire, directing the delivery vehicle to move down the column from the upper rail. The delivery vehicle may have an actuator for selectively actuating the gates. Alternatively, each gate may have an actuator for automatically actuating the gate from a first position in which the delivery vehicle is directed in a horizontal direction to a second position in which the delivery vehicle is directed from a horizontal direction to a vertical direction. For instance, each gate may be controlled by a solenoid or other element configured to move a gate in response to signals from the controller.

The flow of delivery vehicles 200 along the track may move along any of a variety of paths. According to one embodiment, the delivery vehicles move along a path forming a vertical loop and the vehicles generally move along the vertical loop in a forward direction.

For instance, from the perspective of FIG. 5, the delivery vehicles may follow a vertical loop in a clockwise direction as shown by arrow T1. Specifically, from the loading station 145 the delivery vehicle moves upwardly in the first column until the delivery vehicle reaches the upper track 125. At the upper track the vehicle transitions from vertical movement to horizontal movement. The delivery vehicle moves along the upper track 125 in the direction of T1 until the vehicle reaches the column having the sort bin to which the delivery vehicle is to deliver an item. For instance, if the destination bin 20 is in the fourth column, the delivery vehicle moves along the upper rail until reaching vertical tracks 132f and 132g. The gates 135 are actuated so that the delivery vehicle is directed downwardly down the fourth column. The delivery vehicle continues moving downwardly until reaching the destination bin 20.

At the destination bin, the delivery vehicle discharges the item into the destination bin. The delivery vehicle then continues down the column until reaching the lower track 130. Upon reaching the lower track the delivery vehicle transitions from vertical travel to horizontal travel. The delivery vehicle then travels to the left (from the perspective of FIG. 5) to return to the loading column 140.

As described above, the delivery vehicle travels along a path that forms a vertical loop in the aisle. Specifically, the delivery vehicle travels in a clockwise direction from the loading zone to the upper rail to one of the columns and down to the lower track, which it follows back to the loading column. Each vehicle follows along a path forming a vertical loop but the path for each vehicle may differ depending on which sort bin 20 the delivery vehicle is directed.

The delivery vehicles may be controlled to continue to flow in a common direction, such as a clockwise direction as discussed above. However, it should be understood that although the vehicles may generally flow in a common direction (such as clockwise) there may be instances in which one of the vehicles may move in the opposite direction as the vehicle moves around the vertical loop. For instance, after moving downwardly along the fourth column, it may be desirable to move the vehicle upwardly within the fourth column before driving the vehicle downwardly to the lower track 130. In such an instance, the general flow of the delivery vehicle is the same: a clockwise path following a vertical loop the moves forwardly from the loading station 145 to one of the sort bins and then returns to the loading station along a separate return path.

The track 105 is generally configured to cooperate with the delivery vehicles. Specifically, the delivery vehicles 200 may include drive elements having teeth. In such an embodiment, the track may include teeth that mesh with the teeth of the vehicle drive elements. Similarly, the delivery vehicles may include drive elements that frictionally engage the track, such as drive wheels. In such an embodiment, the track need not have teeth. Accordingly, it should be understood that the delivery vehicles may include a variety of known drive mechanisms. The track 105 is configured to cooperate with the drive mechanism of the delivery vehicle to guide the delivery vehicles within the aisle.

As described above, the configuration of the track may vary depending on the configuration of the delivery vehicle. An exemplary track may be similar to the track in U.S. Pat. No. 7,861,844. The entire disclosure of U.S. Pat. No. 7,861,844 is hereby incorporated herein by reference.

### Input Station

The system may be configured so that items are directly loaded onto the delivery vehicles at the loading station. For instance, an operator may place an item directly onto the vehicle at the loading station 145. Additionally, a scanner may be provided for scanning an item before the item is loaded onto the delivery vehicle. It should be understood that the term operator may include a human operator or a mechanical operator, such as a robotic arm or similar element.

Alternatively, the system may include an input station for loading items onto the delivery vehicles. The input station may include a conveyor 55 for conveying items toward the loading station 145. The conveyor may include a first end forming a drop zone where items may be dropped or placed onto the conveyor. The second end of the conveyor may be adjacent the loading station so that the conveyor conveys the items from the drop zone to the loading station. At the loading station, the items are loaded on the delivery vehicles.

Various factors may be detected to evaluate how an item is to be processed. For instance, an item typically needs to be identified so that the system can determine the location or bin to which the item is to be delivered. This is normally done by determining the unique product code for the item. The system may include a scanning element for scanning a product identification marking on the product. By way of example, the items may be marked with one or more of a variety of markings, including, but not limited to, machine-readable optical labels, such as bar codes (e.g., QR or UPC codes), printed alphanumeric characters or a unique graphic identifier. The scanning station 60 may include a scanner or reader for reading such a marking. For instance, a bar code reader, optical reader or RFID reader may be provided to scan the item to read the identification marking.

Accordingly, the input station 50 may include a scanner 60 for scanning the items before they are placed onto the conveyor. Alternatively, the input station may include a scanner 60 that scans the items as the items move along the input conveyor.

Once the product identification marking is determined (either manually or automatically), the system retrieves information regarding the product and then controls the further processing of the item based on the information stored in the central database.

At the input station 50, items are inducted into the system by serially loading items onto the vehicles 200. In one embodiment, each item is manually scanned at the induction station to detect one or more features of the item. Those features are used to ascertain the identification of the item. Once the item is identified, various characteristics of the item may be retrieved from a central database and the item may be subsequently processed based on the known characteristics of the item. For instance, the input station 50 may include a scanning station 60 that scans for a product code, such as a bar code. Once the product code is determined, the system retrieves information regarding the product from a central database. This information is then used to control the further processing of the item.

The input conveyor 55 may be configured so that an operator can select an item from a supply of items located adjacent the input conveyor. For example, a separate supply conveyor may convey a steady stream of items to the induction station 50. The operator may continuously select an item from the supply conveyor and drop the items onto the input conveyor 55. Alternatively, a large container of items may be placed adjacent the input conveyor 55, such as a bin or other container. The operator may select items one at a time from the supply bin and place each item onto the input conveyor. Still further, the input conveyor 55 may cooperate with a supply assembly that serially feeds items onto the input conveyor. For example, a supply conveyor may convey a continuous stream of items toward the input conveyor 55. The input conveyor may include a sensor for sensing when an item is conveyed away from the input conveyor. In response, the system may control the operation of both the supply conveyor and the input conveyor 55 to drive an item forwardly from the supply conveyor onto the input conveyor. In this way, items may be fed onto the input conveyor either manually by the operator or automatically by a separate feed mechanism operable to feed items to the input conveyor.

Additionally, in the foregoing description, the system is described as having a single input station 50. However, it may be desirable to incorporate a plurality of induction stations positioned along the system 10. By using a plurality of induction stations, the feed rate of pieces may be increased. In addition, the induction stations may be configured to process different types of items.

Referring to FIGS. 1 and 5, the input station 50 includes a conveyor 55 that serially conveys items to a loading station 145. The loading station is a location along the track 105 that provides an entry point for loading an item onto a vehicle 200. At the loading station 145 the vehicle is aligned with the conveyor 55 so that items discharged from the conveyor are received onto the delivery vehicle 200 positioned at the loading station. After the item is loaded onto the delivery vehicle, the delivery vehicle moves away from the loading station 145. Another vehicle then moves into position at the loading station to receive the next item.

The system may include an optional return conveyor 70 to return items to the input conveyor 55. The return conveyor may facilitate the re-scanning of items that cannot be delivered for some reason. For instance, if the system is unable to identify the product code that is scanned for an item, the system will be unable to identify the sort bin to which the item should be delivered.

The return conveyor extends from the track 105 back toward the drop zone of the input conveyor 55. If a delivery vehicle is unable to deliver an item, the delivery vehicle may drive along the track 105 to the return conveyor and deposit the item onto the return conveyor 70 instead of delivering the item to one of the bins. The return conveyor then returns the item back to the input conveyor so that the item can be re-scanned and loaded again onto one of the delivery vehicles.

### Delivery Vehicles

As noted above, the sorting system may include a plurality of independently operable delivery vehicles 200. Each delivery vehicle is configured to deliver one or more items to one of the sort bins. The following description provides the details of an exemplary delivery vehicle. However, it should be understood that the sorting system need not be limited to one that utilizes a plurality of delivery vehicles. Additionally, the configuration of the delivery vehicles may vary depending on a variety of factors. Accordingly, it should be understood that the following discussion provides the details of an exemplary vehicle, and the sorting system is not limited to use with a delivery vehicle having the details described below.

Referring to FIGS. 6-7 a semi-autonomous vehicle 200 is illustrated. The delivery vehicle has an onboard drive system, including an onboard power supply. The delivery vehicle 200 includes a mechanism for loading and unloading items for delivery. An embodiment of a vehicle that may operate with the sorting system 15 is illustrated and described in U.S. Pat. No. 7,861,844.

The vehicle 200 may incorporate any of a variety of mechanisms for loading an item onto the vehicle and discharging the item from the vehicle into one of the bins. Additionally, the loading/unloading (or transfer) mechanism 210 may be specifically tailored for a particular application. However, in the present instance, the loading/unloading mechanism 210 is one or more conveyor belts that extend along the top surface of the vehicle. The conveyor belts are reversible. Driving the belts in a first direction displaces the item toward the rearward end of the vehicle; driving the belt in a second direction displaces the item toward the forward end of the vehicle.

One or more conveyor motor(s) as motors 240a and 240b (FIG. 6) mounted on the underside of the vehicle 200 drives the conveyor belts. Specifically, the conveyor belts are entrained around a forward roller at the forward edge of the vehicle, and a rearward roller at the rearward edge of the vehicle. The one or more conveyor motors 240a and/or 240b is/are connected with the forward roller to drive the forward roller, thereby operating the conveyor belts.

The vehicle includes four wheels that are used to transport the vehicle along the track 105. The wheels are mounted onto two parallel spaced apart axles 215 and 216, so that two of the wheels are disposed along the forward edge of the vehicle and two of the wheels are disposed along the rearward edge of the vehicle.

In an embodiment, each wheel as wheels 220a, 220b, 220c, and 220d, respectively, comprise a corresponding outer gear indicated at 222a, 222b, 222c, and 222d, respectively, that cooperate with the drive surface of the track. The outer gear is fixed relative to the axle onto which it is mounted. In this way, rotating the axle 215 or 216, as the case may be, operate to rotate the corresponding gears. Accordingly, when the vehicle is moving vertically the gears cooperate with the drive surface of the track to drive the vehicle along the track.

The vehicle includes an onboard drive motor 250 for driving the wheels. More specifically, the onboard drive motor 250 is operatively connected with the axles 215 and 216 to rotate the axles, which in turn rotates the gears 222a to 222d of the wheels.

The vehicle 200 may be powered by an external power supply, such as a contact along the rail that provides the electric power needed to drive the vehicle. However, in the present instance, the vehicle includes an onboard power source that provides the requisite power for both the drive motor and the conveyor motor. Additionally, in the present instance, the power supply is rechargeable. Although the power supply may include a power source, such as a rechargeable battery, in the present instance, the power supply is made up of one or more ultracapacitors.

As discussed further below, the vehicle further includes a processor for controlling the operation of the vehicle in response to signals received from the central processor 800. Additionally, the vehicle includes a wireless transceiver so that the vehicle can continuously communicate with the central processor as it travels along the track. Alternatively, in some applications, it may be desirable to incorporate a plurality of sensors or indicators positioned along the track. The vehicle may include a reader for sensing the sensor signals and/or the indicators, as well as a central processor for controlling the operation of the vehicle in response to the sensors or indicators.

If the system 10 includes a number of delivery vehicles 200, the positioning of the vehicles is controlled to ensure that the different vehicles do not crash into each other. In one embodiment, the central controller 800 that tracks the position of each vehicle 200 and provides control signals to each vehicle to control the progress of the vehicles along the track. The central controller 800 may also control operation of the various elements along the track, such as gates 135 that re-direct the vehicles from a horizontal direction of travel to a vertical direction of travel or vice versa.

### Retrieval Vehicle

The system 10 may include one or more vehicles for retrieving bins 20. The vehicles used to deliver the items to the bins may also be configured to retrieve the bins. Alternatively, as discussed further below the system 10 may include one or more retrieval vehicles 300 that are configured differently than the delivery vehicles 200.

The retrieval vehicles 300 are configured to be moveable vertically and horizontally. For instance, the retrieval vehicles may be configured to be moveable to align the retrieval vehicles with the bins.

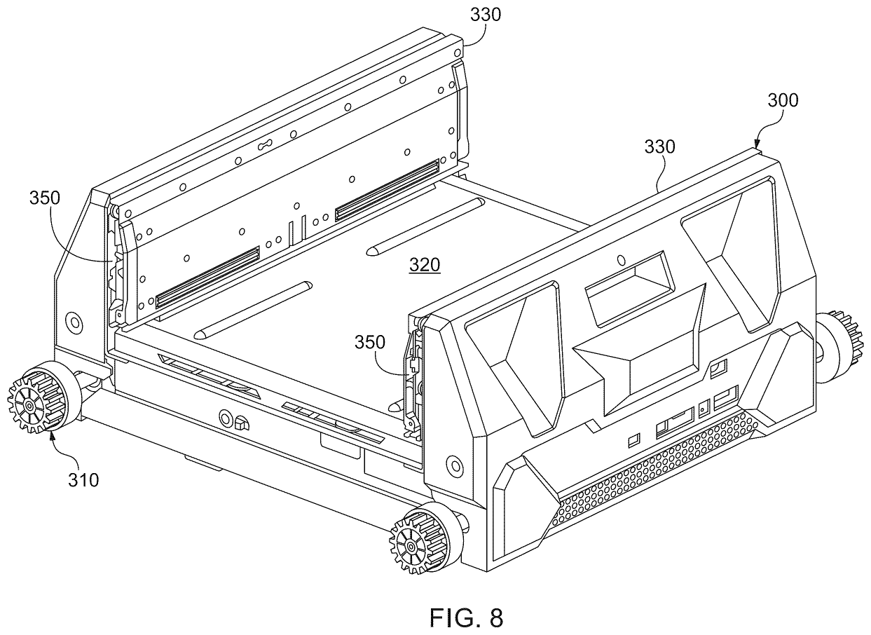

In the embodiment illustrated in FIGS. 8-10, the retrieval vehicle 300 is configured to travel within the aisle 100. Although the retrieval vehicle may move along a separate track or guide, in the present instance, the retrieval vehicle is operable within the track 105. In particular, the retrieval vehicle 300 may have a drive system 310 that is substantially similar to the drive system 220 of the delivery vehicles 200.

Referring to FIGS. 8-10 the retrieval vehicle 300 may include a plurality of drive wheels 310 for driving the vehicle within the aisle. The drive wheels 310 may include teeth that mesh with the track 105. Similarly, the drive wheels may include friction wheels if the track 105 is configured to cooperate with friction wheels.

The retrieval vehicle 300 may include two pairs of drive wheels 310 that are synchronously driven. For instance, the first pair may be mounted on a first axle and the second pair may be mounted on a second axle. Additionally, the axle may be independently driven. However, in the present instance, the axles are interconnected so that the two axles are synchronously driven.

The retrieval vehicle 300 includes a support surface 320 for supporting one or more items. For instance, the support surface may comprise a generally horizontal surface for supporting a tote 20.

The retrieval vehicle 300 may include one or more walls for retaining items on the vehicle. For instance, as shown in FIG. 8, the retrieval vehicle 300 may include a pair of side walls 330 spaced apart from one another. As shown in FIG. 8, the side walls 33 may straddle the support surface to prevent items from being discharged off the leading edge of the vehicle or the trailing edge of the vehicle.

The retrieval vehicle 300 is also configured to facilitate loading and discharging items from the vehicle. For instance, the vehicle may have a front opening between the sidewalls 330 adjacent a front edge of the vehicle and a rear opening between the sidewalls 330 adjacent a rear edge of the vehicle. The front and rear openings provide pathways for loading items onto the support surface and for discharging items off the support surface.

The system includes one or more mechanisms for transferring sort bins 20 between the racks 30, 35 and the retrieval vehicles 300. In one embodiment, the storage locations may be configured to transfer the sort bins onto the retrieval vehicle. For instance, each sort location may include a transfer mechanism such as a conveyor or other element. Alternatively, as shown in FIGS. 8-10, the retrieval vehicle may include a transfer mechanism for transferring items between the vehicle and the storage locations.

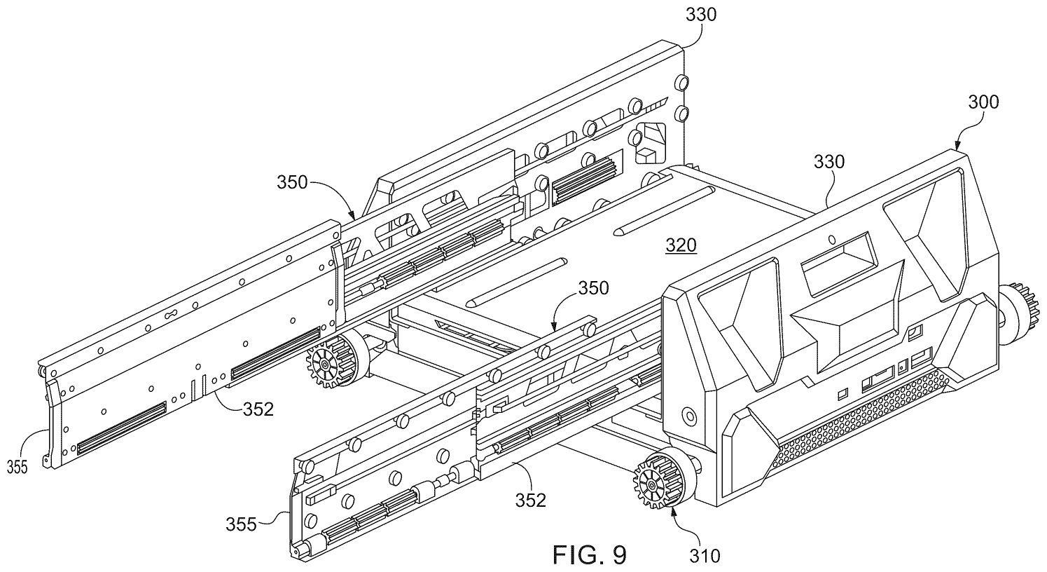

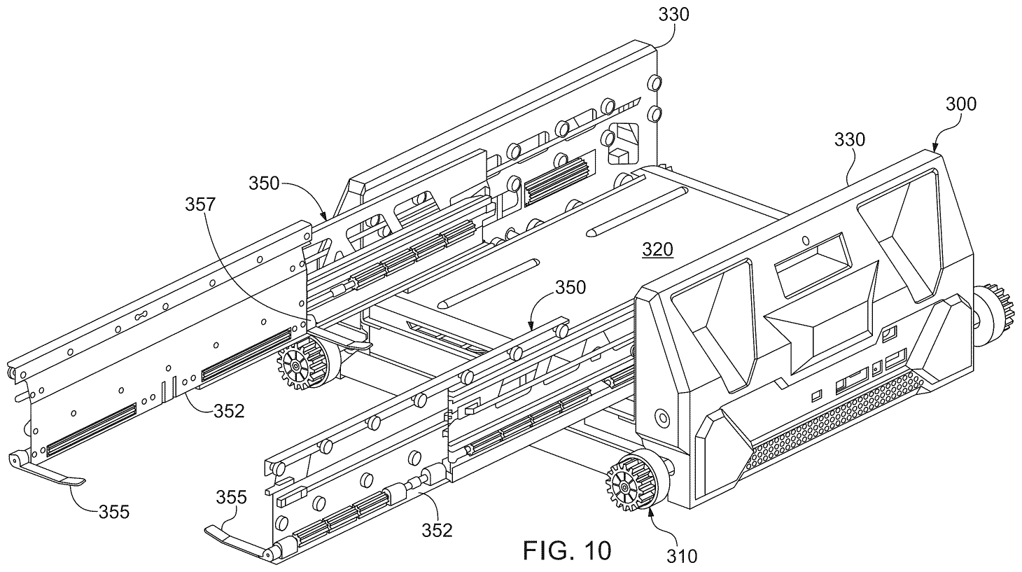

FIGS. 8-10 illustrate a transfer mechanism that extends outwardly from the retrieval vehicle 300 to engage a sort bin in one of the sort racks 30, 35. In FIG. 8, the retrieval mechanism 350 is illustrated in a retracted position. In FIG. 9, the retrieval mechanism 350 is illustrated in an extended position. In FIG. 10, a plurality of optional latching elements 355, 357 are illustrated in an extended position.

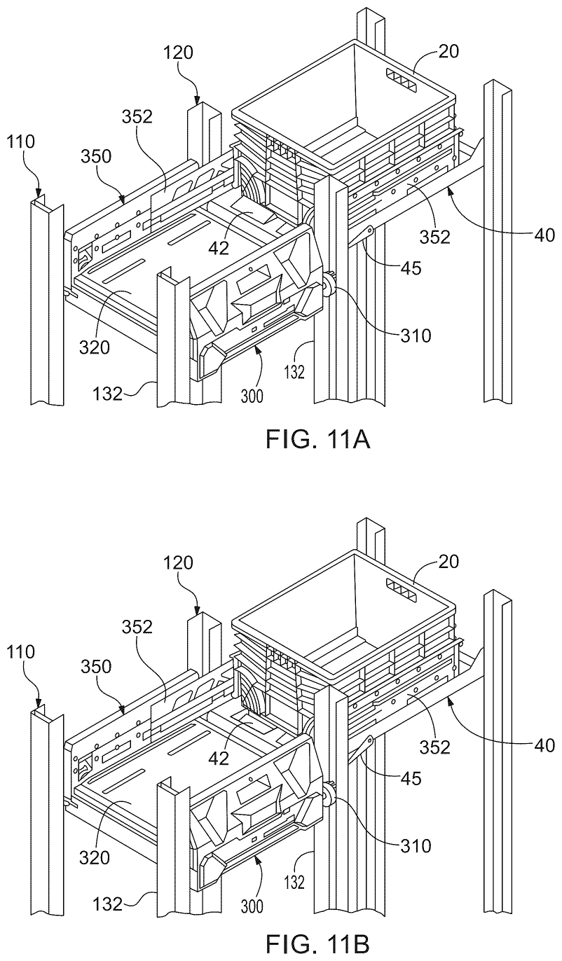

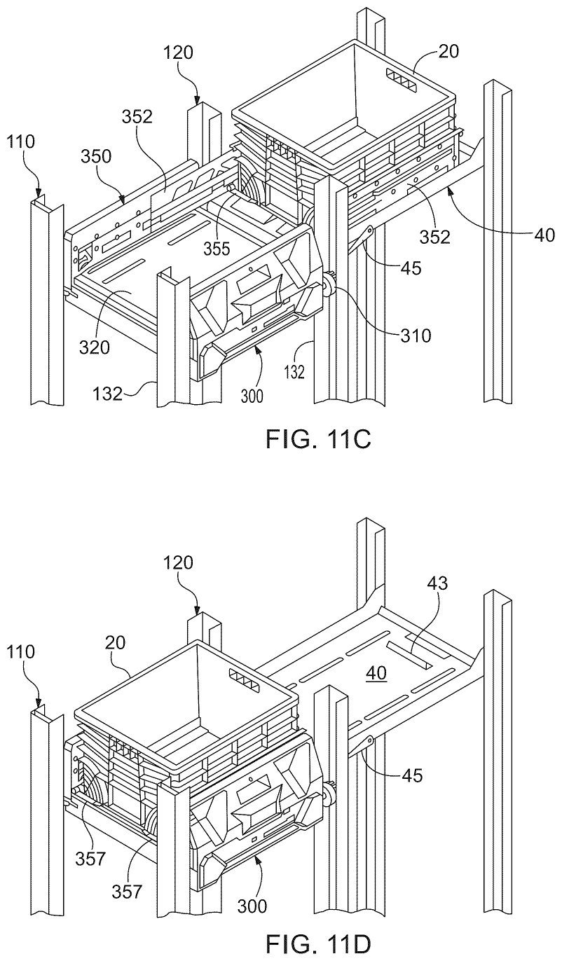

The retrieval mechanism 350 may include one or more extendable arms. For example, the retrieval mechanism may include a pair of extendable arms 352 for straddling the bins 20 as shown in FIGS. 10 and 11A-11D. Optionally, the extendable arms may be formed of a plurality of segments so that the arms telescopingly extend from the vehicle.

The extendable 352 arms may include latches or other features for positively engaging the bins 20. For instance, each arm may include a front bin latch 355 and a rear bin latch 357 spaced apart from the front bin latch. The front bin latch 355 is positioned to engage a front edge of the sort bin 20 and the rear bin latch 357 is positioned to engage a rear edge of the sort bin. Additionally, the latches 357 may be moveable between a retracted position as shown in FIG. 9 and an extended position as shown in FIG. 10. In the retracted position the latches do not engage the sort bin. In the extended position, the latches 355, 357 engage the bin so that displacing the arms 352 displaces the sort bin. Optionally, the latches pivot from the retracted position to the extended position about a pivot axis as shown in FIGS. 9-10.

An actuator on the retrieval vehicle, such as a solenoid or motor, is operable to drive the retrieval mechanism 350 between the extended and retracted positions. For instance, as shown in FIGS. 9-10 the telescoping arms are connected to one or more drive elements such as gears that cooperate to extend the arms. Similarly, the latches 355, 357 are connected with one or more drive elements to displace the latches between the extended and retracted positions. Both the extendable arms 352 and the latches 355, 357 may be connected with a common actuator, such as a motor.

The retrieval vehicle 300 may include an internal power source similar to the delivery vehicle 200 described above. For instance, the retrieval vehicle 330 may include a rechargeable power source that can be recharged as the vehicle moves within the aisle. Specifically, the vehicle may include one or more contacts that form an electrical contact with a power source located within the aisle 100 or adjacent the aisle.

The retrieval vehicle 300 may also include a controller for controlling operation of the vehicle similar to the delivery vehicle 200. For instance, the vehicle 300 may include a controller configured to receive signals from the central controller 800 to control operation of various functions of the vehicle. The control signals may include signals for controlling the drive wheels 310 to control movement of the vehicle within the aisle. The control signals may further include signals for controlling operation of the retrieval mechanism 350.

Referring to FIGS. 11A-11D, the retrieval vehicle 300 is configured to retrieve a bin 20 from one of the storage locations in one of the racks 30, 35 after one or more items have been sorted into the bin. In particular, the retrieval vehicle 300 may be configured to pull a bin 20 from one of the storage locations onto the vehicle while the vehicle is positioned in the aisle 100.

The system may be configured so that the bin 20 is releasably retained in the storage location while one or more items are sorted into the bin. When the retrieval vehicle 300 retrieves the bin, the retrieval vehicle actuates a release to release the bin from the storage location. After releasing the bin, the retrieval vehicle retrieves the bin from the storage location.

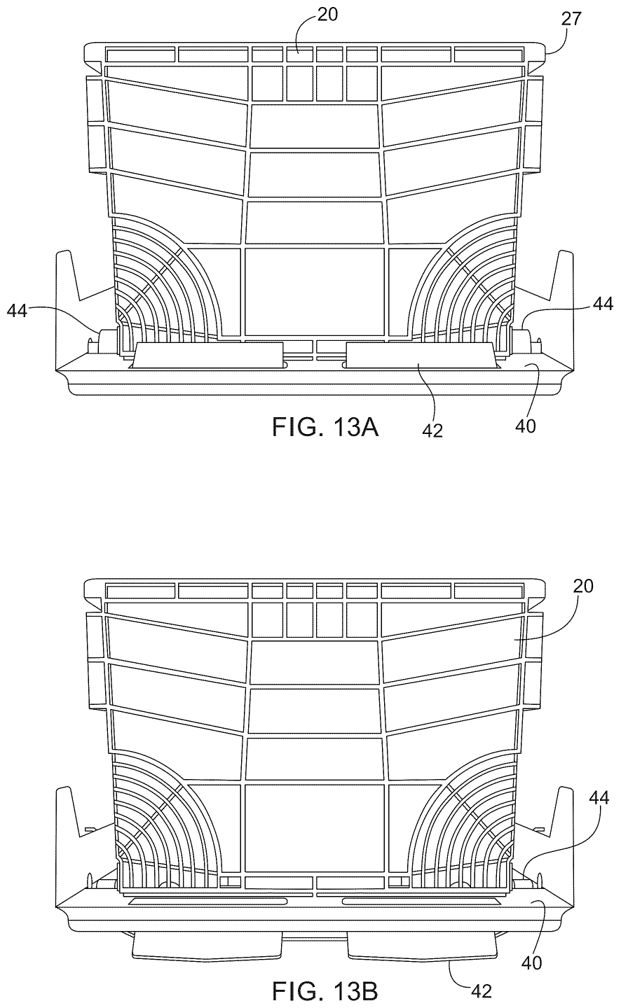

Any of a variety of retainers may be used to engage the bins to hold them in the storage locations. An exemplary retainer 42 is illustrated in FIGS. 11A-11D and FIGS. 13A-13B. The bin retainer 42 is a displaceable latch that operates as a stop operable to impede displacement of the bin from the storage location toward the aisle 100. In a first position, the retainer 42 abuts the bin impeding displacement of the bin toward the aisle 100 (See FIG. 13A). In a second position, the retainer 42 is displaced out of engagement with the bin 20 so that the bin is displaceable toward the aisle.

The system may include an element for automatically actuating the retainer from the first position to the second position in response to a control signal. For instance, the retainer 42 may be connected with a solenoid or other linear or rotary actuator that displaces the retainer in response to a control signal. Alternatively, in the present instance, the system includes an actuator 44 connected with the retainer 42 that is operable by the retrieval vehicle to release the retainer.

The actuator 44 has an actuation surface configured to cooperate with the retrieval vehicle. In the present instance, the actuator is vertically displaceable. In particular, the actuator 44 comprises a roller rotatable about a horizontal axis and the roller is vertically displaceable between an upper position and a lower position.

The actuator 44 may be directly connected with the retainer 42, however, as shown in FIGS. 11A-11D, a linkage, such as a pivotable connecting link 45 connects the actuator 44 with the retainer 42. In this way, displacement of the actuator 44 displaces the retainer 42.

The system may also include an element for automatically returning the retainer 42 from the retracted position to the actuated position. For example, the system may include a biasing element biasing the actuator and/or the connecting link 45 so that the retainer is biased from the released position shown in FIG. 13B to the retained position shown in FIG. 13A. The biasing element may comprise a spring urging actuator 44 upwardly or a spring urging the connecting link in a clockwise direction (from the perspective of FIG. 11B).

The retrieval vehicle 300 may have a separate actuating element configured to engage the actuator 44 to release the retainer 42. However, in the present instance, the retrieval mechanism 350 is configured to engage the actuator 44. For instance, the telescoping arm 352 may engage the actuator 44 to displace the actuator 44 downwardly as the arm 352 extends into the storage location.

The actuator 44 may be configured to limit the impedance on the telescoping arm 352 as the arm engages the actuator. For instance, the actuator may be angled or tapered in a wedge or similar configuration. However, in the present instance, the actuator is a roller 44 having a surface that the telescoping arm can roll along while maintaining the actuator in an actuated position as shown in FIG. 13B.

The actuator 44 may be configured so that the retainer 42 is maintained in a released position until after the entire length of the bin is displaced past the retainer. In this way, the retainer does not apply force against the bin as the bin is transferred from the storage location to the retrieval vehicle. For instance, in the present instance, the actuator 44 is positioned and configured so that the telescoping arm 352 maintains engagement with the actuator during all or substantially all of the bin transfer process. Specifically, the telescoping arm 352 may engage the actuator 44 to hold the actuator 44 down while the bin is transferred onto the vehicle. Once the arm 352 is retracted out of engagement with the actuator, the entire length of the bin (or substantially the entire length) is displaced onto retrieval vehicle. Therefore, when the actuator 44 is released, the retainer 42 does not move toward the upward position until at least substantially the entire length of the bin is transferred onto the retrieval vehicle 300. In this way, the retainer 42 does not potentially engage or impede the bin as the bin is transferred onto the retrieval vehicle.

As shown in FIG. 11D, the bins 20 may be supported by a shelf 40 that supports the bin in a storage location in the rack. The retainer 42 may project upwardly through the shelf 40 as shown in FIG. 13A. Additionally, as shown in FIG. 11D, the shelf may also include a fixed element, such as a flange or wall 43 the impedes displacement of the bin outwardly, away from the aisle. This outer stop 43 impedes or prevents the bin from unintentionally being displaced off the rack. For instance, the outer stop prevents the transfer mechanism 350 from pushing the bin out of the rack 30, 35 when the transfer mechanism displaces a bin into a storage location (e.g., onto one of the bin supports 40).

In one embodiment, as shown in FIG. 11A, the track may be arranged in a plurality of columns so that the retrieval vehicle 300 displaces the bin between a pair of vertical track segments 132 as the bin is displaced onto the vehicle. The drive system 310 of the retrieval vehicle 300 is engaged with the vertical track segments 132 as the retrieval mechanism 350 pulls the bin onto the vehicle. However, as noted previously, the track 105 may be formed of a plurality of horizontal rows instead of a plurality of vertical columns. If the track is formed into a plurality of rows, the bin may not necessarily be displaced between vertical track segments when the bin is pulled onto the vehicle.

As described above, the system is configured to sort items into bins and then retrieve the bins after a bin is full or once all of the items in a particular group (such as an order) have been sorted to the bin. In one embodiment, a vehicle, such as a retrieval vehicle 300 retrieves a bin 20. After retrieving the bin, the bin is transferred to a discharge location.

At the discharge location, the items are either discharged from the bin or the bin is transferred out of the sorting system 15. For instance, the items in a bin may be discharged from the bin 20 into a separate container outside the sorting system 15 or the bin may be discharged onto a conveyance mechanism that operates separate from the aborting system 15. Examples of such a conveyance mechanism include, but are not limited to, conveyors or vehicles such as autonomous vehicles.

The bins may be transported to a discharge location by moving the bin within the aisle from a storage location to the discharge location. For instance, the bin may be pulled into the aisle from the storage location and moved vertically and/or horizontally to align the bin with the discharge location.

In the present instance, the bins are moved within the aisle by the retrieval vehicles 300. After a vehicle retrieves a bin 20 the vehicle may move along the track 105 to a discharge location. For example, the vehicle may move vertically and/or horizontally along the track. The vehicle may move along the track with the bin at the same time one or more delivery vehicles are delivering items to bins in the racks 30,35.

The retrieval vehicles 300 may be controlled to flow in a common direction. For instance, the retrieval vehicles may flow in the same general direction as the delivery vehicles 200 as discussed above. In one embodiment, the delivery vehicles and the retrieval vehicles may generally flow in in a clockwise direction as discussed above in connection with the delivery vehicles 200.

It should be understood that although the vehicles may generally flow in a common direction (such as clockwise) there may be instances in which one of the vehicles may move in the opposite direction as the vehicle moves around the vertical loop. For instance, after moving downwardly along the fourth column, it may be desirable to move the vehicle upwardly within the fourth column before driving the vehicle downwardly to the lower track 130. In such an instance, the general flow of the retrieval or delivery vehicle is the same: a clockwise path following a vertical loop that moves forwardly from a starting location.

Although the retrieval vehicles 300 may generally follow the same direction as the delivery vehicles 200, it may be desirable to reverse the direction of travel for the retrieval vehicles. For instance, it may be desirable to move the retrieval vehicle along a first path when moving from a bin location to a discharge station. After delivering the bin to the discharge location the retrieval vehicle may follow a route that moves in a direction similar to the first path (e.g., a generally clockwise direction). Alternatively, it may be desirable to reverse the direction of travel for the retrieval vehicle as it returns to one of the bin locations. For instance, the retrieval vehicle may move in a second direction that is a path along the same path as the first path but in the reverse direction.

The discharge location may be one of a variety of transition locations for discharging items from the sorting system after a group of items have been sorted into a bin. Specifically, the group of sorted items may be dumped out of the bin 20 into which the items were sorted.

The bins 20 may include one or more openings through which the sorted items may be discharged at the discharge location. For instance, each bin may have a moveable wall that selectively covers an opening in the bin. In a first position, the moveable wall covers the opening to impede items moving through the opening; in a second position, the wall uncovers the opening thereby facilitating discharge of items from the bin.

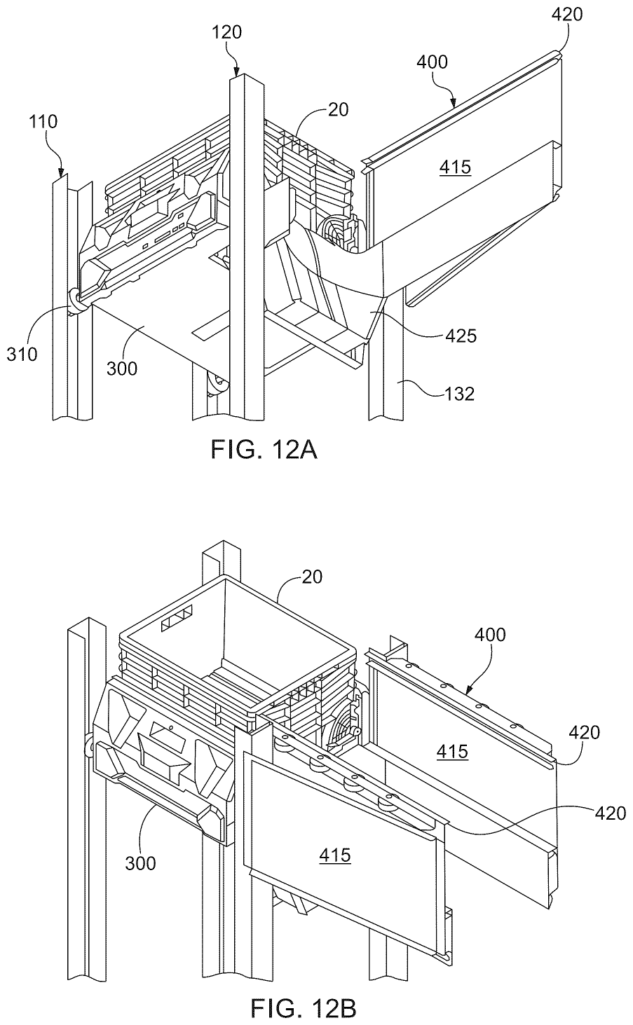

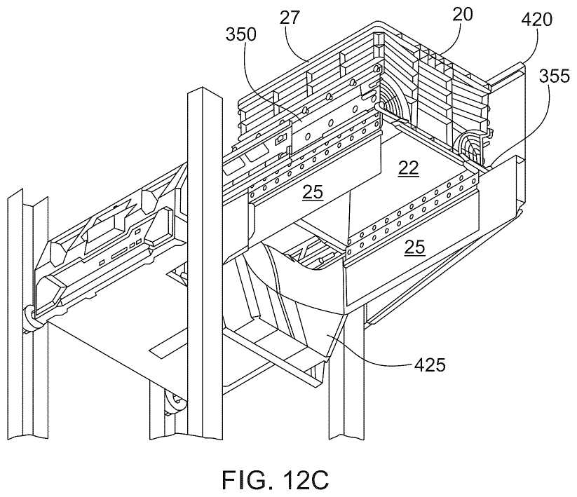

One example of a bin having a moveable wall for discharging items is illustrated in FIG. 12C. The bottom wall or floor of the bin 20 is formed of a trap door or bomb bay door that opens to allow items to fall out of the bin. The trap door may be formed of one or more segments. For instance, as shown in FIG. 12C, the trap door is formed of two segments 25. Each segment may open separately, however, in the present instance, the two segments 25 open at substantially the same time so that all of the items in the bin are discharged at substantially the same time.

It may be desirable to configure the moveable wall so that the items are discharged sequentially rather than all at once. By sequentially discharging the items, the items in a bin are discharged in a series of one or more groupings of one or more items rather than discharging the items in a single group.

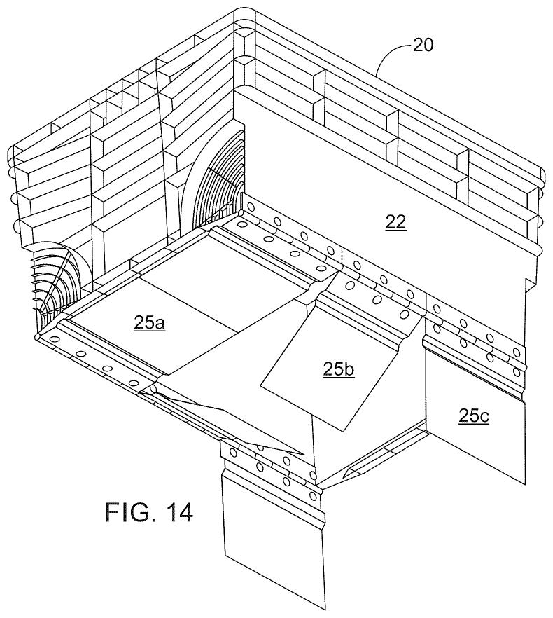

FIG. 14 illustrates a bin configured to facilitate the sequential release of items from the bin. The bin 20 may have a trap door formed of a plurality of segments formed along the length of the bin. The door segments may be opened sequentially to discharge the items in the bin sequentially. For example, the first door segments 25A may open first so that items supported on segments 25A are released or discharged from the bin. After segments 25A are opened, segments 25B may be opened so that items supported on segments 25B are released or discharged from the bin. Finally, segments 25C may be opened so that the remaining items in the bin are released or discharged from the bin. It should be understood that the number of door segments may vary depending on the application. Additionally, it should be understood that FIG. 14 is merely one example of a structure that allows items in the bin to be sequentially released.

Referring to FIGS. 12A-12C, the discharge location may include structure to support the bin 20 while the items in the bin are discharged at the discharge location. For instance, a track 420 may support the bin at the discharge station. The guide track 420 may project outwardly away from the aisle 100 to support the bin 20 as the bin is transferred off the vehicle 300.

In the present instance, the track may be a flange or u-shaped channel that engages the bin to support the bin when the bin is discharged from the retrieval vehicle 300. The track 420 may be sized to cooperate with a flange or lip 27 at the top edge of the bin (see FIG. 12C).

Optionally, the track may include one or more elements for improving the displacement of the bin 20 along the guide track 420. As shown in FIG. 12B, a plurality of rotatable elements in the guide track, such as rollers, may provide a rolling surface for the lip 27 of the bin to move along as the bin 20 is extended away from the vehicle at the discharge station.

The discharge location 400 may also include one or more elements for guiding items discharged from the bin 20. Referring to FIG. 12C, an angled wall 425 may guide items away from the aisle as items are discharged from the bin. The angled wall may also be curved to facilitate closure of the trap doors 25 when the bin is pulled back onto the retrieval vehicle 300.

The discharge location may also include walls 415 forming a chute to direct items in a desired direction as the items are discharged from the vehicle. The guide walls 415 may extend outwardly from the vertical supports or vertical tracks 132 as shown in FIGS. 12A-12B. Optionally, the guide track 420 may be fixedly connected with the sidewalls 415.

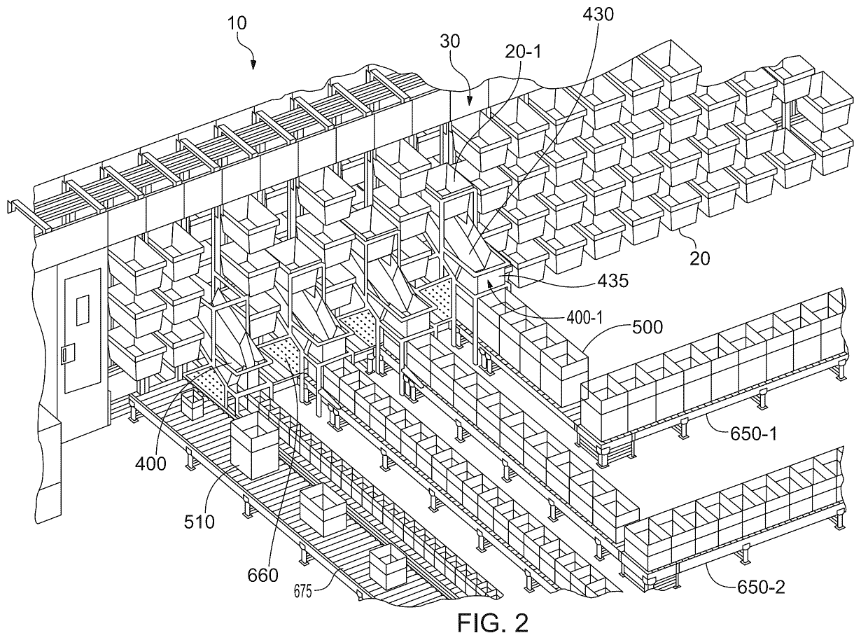

At the discharge location, 400 items in the bin may be discharged from the bin as discussed above. The items may be dumped directly into a container, such as a box or another bin. For instance, referring to FIG. 2, items from bin 20-1 are discharged onto a guide 430 that guides the items into a container. If the bin 20-1 includes a moveable wall (such as trap doors 25 shown in FIG. 12C), the bin may be supported above the guide 430 to provide clearance between the bottom of the bin and the upper surface of the guide. In this way, the trap doors 25 may open when the bin 20-1 is extended away from the aisle over the guide.

The guide 430 may be formed in a variety of configurations. One example is shown in FIG. 2 in which the guide is a ramp or slide angled downwardly and away from the aisle 100. The guide 430 may further include a housing 435 or enclosure that operates as a funnel to guide items into an open container. The housing may have side walls and an end wall opposing the angled slide 430. The bottom edge of the housing 435 may be spaced above a conveyor 650 on which the containers are conveyed so that the empty conveyor can travel under the housing 435.

As noted above, the items may be discharged directly into the containers via a guide, such as a funnel or chute. Alternatively, the items may be discharged onto a moveable element for guiding or transferring items from the bin to an empty container. Such moveable elements may include one or more conveyors or delivery vehicles that operate outside the sorting system 15.

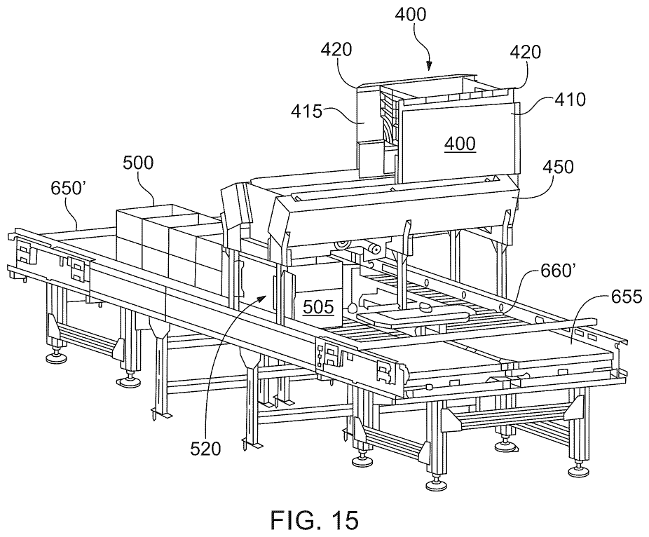

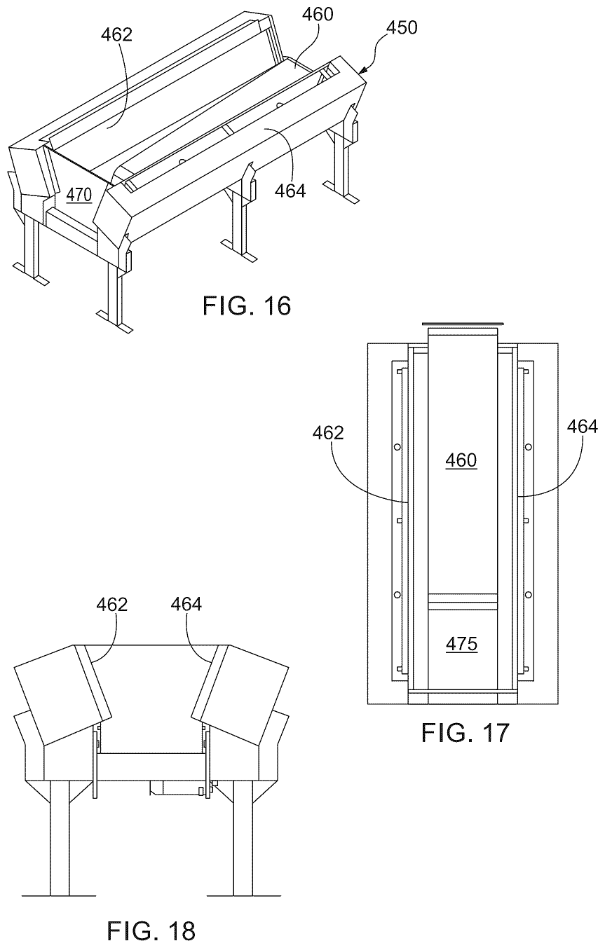

FIGS. 15-21 illustrate a discharge conveyor 450 that guides or transfers items from a bin to an empty container, such as an empty box 500. The discharge conveyor 450 includes a substantially horizontal conveyor 460 that is configured to receive items discharged from the bin retrieved by the retrieval vehicle. For example, the bin 20 may be supported over the horizontal conveyor 460 so that items discharged from the bin are deposited onto a horizontal surface of the horizontal conveyor.

The horizontal conveyor 460 has a first end adjacent the aisle and a second end positioned above a loading location 475. An empty container, such as a box may be positioned at the loading location so that items are discharged from the conveyor 460 into the container.

One or more guide elements may surround the loading location 475 to guide items from the second end of the conveyor 460 into the container at the loading location. Preferably the guide elements form an opening that is smaller than the opening of the container into which the items are being loaded. In this way the guide elements may operate like a funnel to direct items into the container at the loading location 475.

For instance, an angled guide or ramp adjacent the second end of the conveyor may guide items into the box and prevent items from falling underneath the conveyor. A stop or end wall 470 may be positioned opposing the second end of the conveyor. The end wall is configured so that items being driven off the conveyor 460 are not displaced outwardly beyond the side of the empty box at the loading location 475.

The discharge conveyor 450 may include side walls or guides that impede items from falling off the sides of the horizontal conveyor. For instance, the side walls may extend along the sides of the horizontal conveyor and extend vertically upwardly from the first end of the horizontal conveyor to the second end. The side wall may be substantially vertical. Alternatively, the side walls may be angled to form a trough. In such a configuration, the side walls direct items downwardly toward the horizontal conveyor 460.

As shown in FIGS. 15-18, the discharge conveyor 450 optionally includes side walls to keep items from falling off the sides of the horizontal conveyor 460. Additionally, the side walls may include conveyors 462, 464 to help move items along the length of the discharge conveyor. The side conveyors straddle the horizontal conveyor and extend along at least a portion of the horizontal conveyor. As shown in FIG. 16, the side conveyors 462, 464 optionally extend beyond the second end of the horizontal conveyor and into the loading location 475.

The side conveyors 462, 464 may be a series of rollers to form roller beds. However, in the present instance, the side conveyors are formed of continuous belts entrained about rollers. The rollers for the side conveyors may rotate about a vertical axis so that the conveyor belts have a contact surface that is substantially vertical. However, as shown in FIGS. 16-18, the side conveyors are formed so that the conveyors belts have a surface forming an obtuse angle with the surface of the horizontal belt.

The side conveyors 462, 464 may be operable in a first or forward direction to move items toward the loading location 475. Additionally, the side conveyors may be operable in a second or reverse direction to move items away from the loading location. During normal operation, the side conveyors operate in a forward direction. However, the side conveyors may selectively be reversed to loosen or free up items that may become lodged or jammed in the discharge conveyor 450.

Additionally, the side conveyors 462, 464 may be independently operable so that one of the side conveyors operates in a first direction while the second side conveyor operates in a second direction. The opposing operation of the side conveyors can create a twisting motion or torque on items in the discharge conveyor, which can free up or loosen items that may be lodged or jammed in the discharge conveyor.

The side walls and/or side conveyors 462, 464 may be fixedly positioned. In a fixed position, the distance between the side walls and/or side conveyors is fixed. Alternatively, the side walls and/or side conveyors may be flexibly connected relative to one another so that the distance between the side walls and/or side conveyors is variable.

A number of mechanisms can be utilized to allow the side walls and/or the side conveyors 462, 464 to move relative to one another. For instance, the rollers that support that side conveyors 462, 464 may be displaceable outwardly away from the horizontal conveyor. Biasing elements may bias the side conveyors inwardly toward the horizontal conveyor. However, if one or more items get jammed between the side walls or side conveyors, the lateral force from the jammed item(s) may overcome the biasing force to displace one or both of the side walls and/or side conveyors outwardly, which in turn may free up or loosen the jam.

The discharge conveyor assembly 450 may include one or more sensors for detecting whether one or more items are jammed or otherwise constrained from advancing from the discharge conveyor into one of the containers 500. For instance, the discharge conveyor assembly 450 may include a plurality of beam break sensors positioned along the length of the conveyor assembly to monitor the movement of the items along the conveyor. Alternatively, the conveyor assembly 450 may include one or more light curtains that detect the presence of items at locations along the length of the conveyor. In this way, the conveyor assembly includes one or more elements for detecting the presence of items at one or more points along the length of conveyor assembly 450.

Optionally, the conveyor assembly 450 may include one or more sensors for detecting the presence of an item along the length of the horizontal conveyor 460. Optionally, the conveyor assembly 450 may include one or more sensors for detecting the presence of an item along the length of the first side conveyor 462. Optionally, the conveyor assembly 450 may include one or more sensors for detecting the presence of an item along the length of the second side conveyor 464. Additionally, the conveyor assembly may include one or more sensors along each of the three conveyors 460, 462, 464 so that the system can detect the presence of items on each of the conveyors.

The sensors on the conveyor assembly may provide signals indicative of whether an item is jammed at some point in the conveyor assembly 450. The system may control the operation of the conveyors 460, 462, 464 based on the signals received from the sensors. For instance, if the sensors provide signals indicative of no jam being present, the central controller may control the conveyors so that the horizontal conveyor 460, first side conveyor 462 and second side conveyor 464 all operate in a forward direction to drive items toward the discharge location 475. Alternatively, if one or more of the sensors provide a signal indicative of a jam, the central controller may control the conveyors to vary the movement of the conveyors. For instance, as described above, the system may reverse the direction of one of the side conveyors while driving the other side conveyor in a forward direction to create a twisting movement to rotate items and potentially clear up any jammed items.

In addition to controlling operation of the conveyors in response to signals from the sensors, the central controller may control the conveyors based on the steps already taken to clear a jam. For instance, as described above, the system may declare a jam in response to signals received by one or more sensors and as a result, the central controller may reverse one of the side conveyors. After one of the side conveyors is reversed, if the sensors continue to detect a jam, the central controller may vary the operation of the conveyors 460, 462, 464. For instance, if the first side conveyor was reversed and the second side conveyor was driven forward but a jam is still detected, the central controller may reverse the direction of the two side conveyors so that the first side is driven forward and the second side conveyor is reversed. Alternatively, the side conveyors may both be reversed. Alternatively, one of the side conveyors and the horizontal conveyor may be reversed if the sensors continue to detect a jam.

Accordingly, the central controller may make multiple changes to the direction of one or more of the conveyors in response to signals received from the sensors along the length of the discharge conveyor assembly 450.

Referring to FIGS. 15 and 19-21, it may be desirable to include a retainer for retaining the containers as items are transferred in the containers at the discharge station 400. An exemplary assembly for retaining empty containers, such as boxes, is illustrated in combination with the discharge conveyor 450 described above. However, it should be understood that the container retainer may be incorporated into a structure at the discharge station that does not include the discharge conveyor, such as the chute 430 described above. Additionally, it should be noted that the system may function adequately without a container retainer in various applications.

The container retainer 520 may be configured to retain a container to be loaded at the loading location 475. The container retainer 520 may include a moveable retainer 530 that is displaceable between an engaged position and a retracted position. In a first position the retainer holds the container in a fixed position at the loading location 475. In a second position, the retainer releases the container so that the container is free to be conveyed away from the loading location.

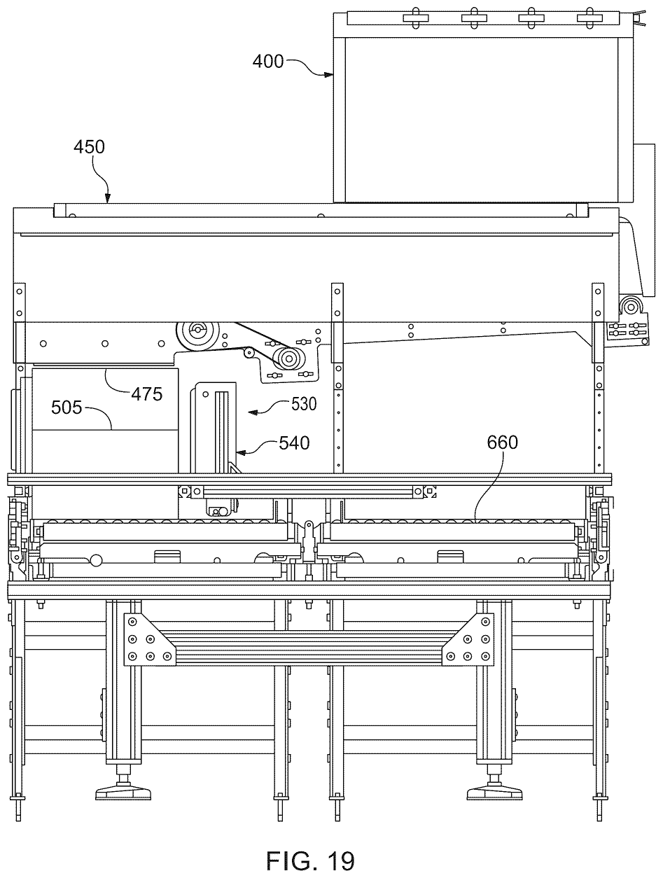

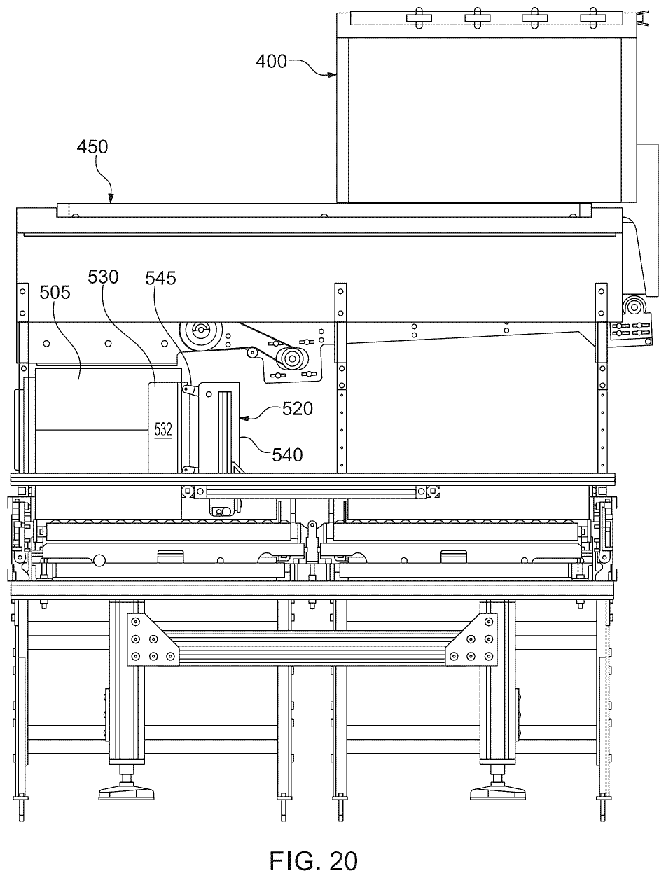

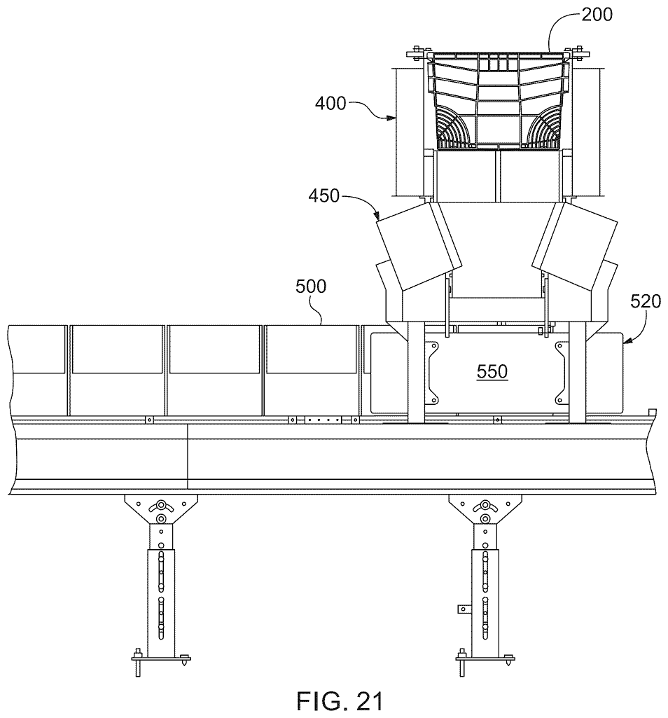

The moveable retainer 530 may be in the form of a generally planar plate that is operable to press against the side of the container. Additionally, a fixed wall or plate 550 may be disposed opposing the moveable retainer (See FIG. 19 and FIG. 21). In this way, in the first position the moveable retainer presses the container against the fixed wall 550 to clamp or hold the container in place.

The moveable retainer 530 may also include an end wall 532 that projects transverse the planar surface of the moveable retainer. The end wall may operate as a stop to stop a container in the loading location 475 as the container moves along a conveyor. In particular, the end wall 532 may project into the path of the container as the container moves into the loading location 475.

A variety of mechanisms may be utilized to displace the moveable retainer between the first position (see FIG. 19) and the second position (see FIG. 20). In the present instance, the container retainer includes an actuator 540 such as a solenoid and a linkage 545 connects the moveable retainer 530 with the solenoid.

The system 10 may include a conveyor for conveying containers away from the sorter after a sort bin has been emptied at one of the discharge stations 400. Additionally, the system may include a conveyor for conveying empty containers to the discharge stations for receiving items from the sort bins.

FIG. 2 illustrates one type of conveyor for conveying containers away from the sorter after the items from a sort bin have been transferred into the container. The conveyor may include a transfer conveyor 660 that moves container along a path that is parallel to the aisle 100 of the sorter 15. The transfer conveyor may include one or more conveyor belts or one or more rollers or similar mechanisms for moving a container along a horizontal path in a generally horizontal path. Alternatively, the transfer conveyor may include a shuttle or other mobile vehicle onto which the container may be loaded after the items from the sort bin are transferred into the container.

The transfer conveyor 660 may displace the full containers 510 from the discharge stations 400 toward an output conveyor 675 that moves full container 510 away from the sorter 15. The output conveyor may include one or more conveyor belts or one or more rollers or similar mechanisms for moving a container along a horizontal path in a generally horizontal orientation. Alternatively, the output conveyor may include a shuttle or other mobile vehicle onto which the container may be loaded.

The output conveyor 675 may be disposed at an angle to the transfer container 660 as shown in FIG. 2. In this way, the transfer conveyor moves the full containers from the discharge stations 400 along a path to the output conveyor 675. When the containers reach the end of the transfer conveyor 660, the containers are conveyed onto the output conveyor 675.

The system 10 may include one or more conveyors for providing a supply of empty containers to the discharge stations 400 for receiving items from the sort bins as discussed above. For instance, as shown in FIGS. 1-2 the system may include container input conveyors 650-1, 650-2, 650-3 and 650-4. Each of the four conveyor lines provides a supply of empty containers 500 to the discharge stations 400. In the embodiment shown in FIGS. 1-2, each input conveyor 650-1, 650-2, 650-3 and 650-4 goes to a separate discharge station 400. In this way, each input conveyor 650 independently provides a supply of empty containers to one of the discharge stations. Accordingly, each input conveyor 650 may be controlled separately.

Optionally, the input conveyors 650 may be configured to convey containers having different physical characteristics. The physical characteristics may be the dimensions of the container, such as length, width and height or the physical characteristic may be the type of container, such as tote, bin, or cardboard box. For instance, input conveyor 650-1 may convey extra-large cardboard boxes to discharge station 400-1, input conveyor 650-2 may convey large cardboard boxes to discharge station 400-2, input conveyor 650-3 may convey medium cardboard boxes to discharge station 400-3 and input conveyor 650-4 may convey small cardboard boxes to discharge station 400-4.

In some applications, it may not be desirable to automatically convey a supply of containers to the discharge stations. Alternatively, the system may have a single input conveyor that supplies empty containers to each of the discharge stations. Accordingly, it should be understood that the number of input conveyors may be varied depending on the application. Similarly, the direction and orientation of the input conveyors 650 may be varied depending on the application.

For example, an alternative input conveyor 650′ is illustrated in FIG. 15 and FIGS. 19-21. The alternate input conveyor has an input path that moves empty containers 500 parallel to the aisle of the sorter. The empty containers 500 move along the path toward a loading location of the discharge station 450. At the loading location the container is filled with items from one of the sort bins 20. In FIG. 15, the container being filled at the loading location is designated 505.

From the discharge location, the container moves toward a right-angle transfer 655 that moves the filled container transverse the input conveyor and toward the transfer conveyor 660. The transfer conveyor 660′ is configured to convey the filled containers along a path that is parallel to the aisle and opposite the direction of travel of the input conveyor. As seen from the foregoing, it should be understood that the number and layout of the container input conveyor(s) and the container transfer conveyor(s) and the container output conveyors may be varied depending on a variety of factors, including, but not limited to the size and shape of the available floor space, the number of sorting systems used, and the types of items being sorted.

In the foregoing description, the system is discussed as having a single sorter 15 that sorts items and then transfers the sorted items into containers that are conveyed away by an output conveyor 675. However, the system may include multiple sorters that are linked together by one or more common input conveyors for providing empty containers to the sorters and/or one or more common output conveyors for conveying full containers away from the sorters.

In the foregoing description, a bin is conveyed to a discharge station 400 after a group of items has been sorted to the bin and the items from the bin are discharged into another container at the discharge station. However, rather than transferring the items from one container to another at the discharge station, the entire bin may be discharged at the discharge station. For instance, the discharge station may comprise a conveyor or other moveable item onto which the bin may be placed. The retrieval vehicle may transfer the full bin onto the conveyor at the discharge station similar actuating the transfer mechanism 350 to move the full bin off of the vehicle.

Once the full bin is transferred onto the conveyor at the discharge station, the full bin may be conveyed onto a transfer conveyor and/or onto an output conveyor similar to the conveyors described above to move the full boxes 510 away from the sorter 15.

In an arrangement in which the full bins are discharged from the sorter rather than being emptied, the system may also include a mechanism for providing a supply of empty bins to restock the sorter after a full bin is discharged. For instance, a conveyor may convey empty bins toward the discharge station(s) so that after a retrieval vehicle discharges a full bin the vehicle can then retrieve an empty bin and deliver the bin to a sort location that does not have an empty bin.

Accordingly, as described above, the system may sort items into bins and then discharge the sorted items by either transferring the sorted items from a bin into another container or by transferring the entire bin out of the sorter. Additionally, the system can combine these two features by discharging the full bins out of the sorter and then transferring the items into a separate container.

Referring to FIGS. 22A-22C an alternate embodiment is illustrated in which a bin 20 to which items have been sorted is transferred onto a bin output conveyor. For example, the bin 20 may be retrieved by a retrieval vehicle as described above and conveyed to a discharge station 400′. At the discharge station the retrieval vehicle may transfer the full bin onto the bin output conveyor 700.

The bin output conveyor 700 conveys the full bin 20 along a path over a container conveyor 650 on which empty container are conveyed. As shown in FIG. 22B, a gap in the bin conveyor 700 may be disposed over the container conveyor 650 so that items can be discharged from the bin 20 into an empty bin 505 at a loading location. The bin may be supported by the discharge station over the gap by a support and/or guide similar to the track 420 described above. In this way, the bottom trap doors 25 of the bin may open so that items in the bin may fall into the container 505 below the bin.

After the items are discharged from the bin, the empty bin is conveyed along the output conveyor 700. The doors 25 of the bin are closed as the bin is conveyed away from the gap in the output conveyor 700. The empty bin may then be conveyed back toward the sorter so that the empty bin can be transferred back into the sorter by one of the retrieval vehicles.

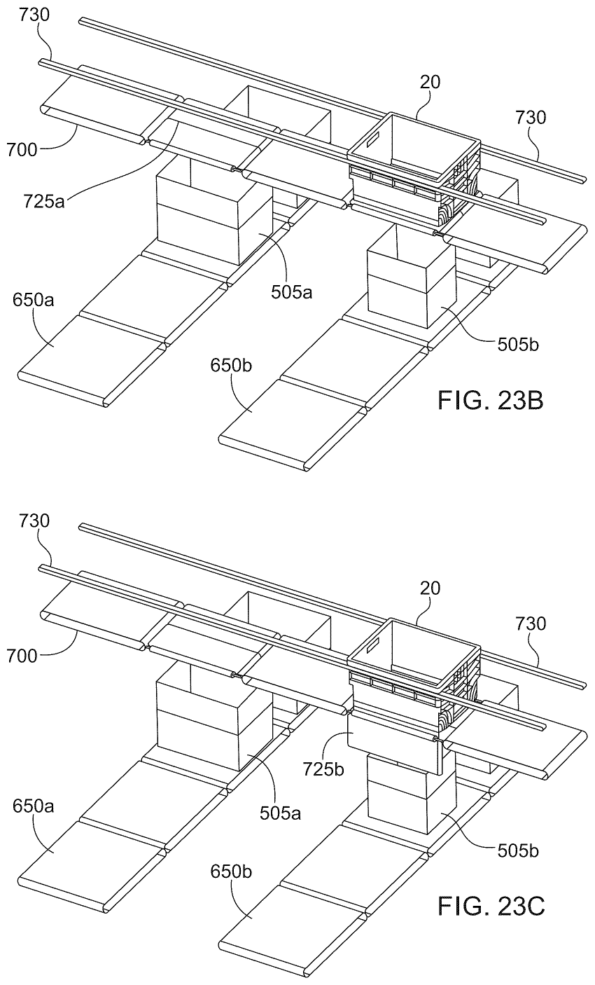

Yet another embodiment is illustrated in FIGS. 23A-23C in which the system transfers the full bins out of the sorter along a conveyor and then transfers the items from the full bin into an empty container, such as a box. In this second alternate embodiment, the output conveyor 700 for the full bins 20 selectively discharges items onto empty boxes 505A, 505B on separate container conveyors 650A, 650B.

The output conveyor 700 may include one or more moveable sections that selectively open to discharge the items from the bin. For instance, the output conveyor 700 may include a first moveable section 725A over a first container conveyor 650A and a second moveable section 725B over a second container conveyor 650B.

Each moveable section 725A, 725B is configured so that in a first position the moveable section provides a surface for supporting the bin so that the trap door of the bin remains closed. In a second position each moveable section is displaced away from the path of the output conveyor to provide a gap or opening so that the trap doors 25 of the bin may open. For instance, as shown in FIG. 23C, the moveable section 725 may be pivotable similar to trap doors. Similar to the embodiments described above, a bin support 730 may be provided over the moveable sections so that the bin is supported over the gaps in the output conveyor 700 when one of the moveable sections opens.

When one of the moveable sections moves into an open position, the bin support 730 supports the bin to keep the bin from falling through the opening in the output conveyor. While the bin is supported and the pivotable section 725B is open, the trap door of the bin opens allowing the items to fall into the container 505B on output conveyor 650B. Similarly, the first pivotable section may pivot open when the bin is positioned over the first output conveyor so that items may be discharged from the bin into the empty container 505A.

Referring to FIGS. 1-4, the system 10 may also include one or more box erectors 600. Box erectors automatically make cardboard boxes from a supply of cardboard. The box erector 600 is operable to cut a length of cardboard from the supply of cardboard and then cut and fold the cardboard segment to create an empty box 500. As shown in FIG. 1, the system may include a plurality of box erectors 600-1, 600-2, 600-3, 600-4. The box erectors may all create the same size box. Alternatively, the box erectors may create boxes of different sizes and configurations. For instance, the first erector 600-1 may create a box of a first size, the second erector 600-2 may create a box of a second size, the third erector 600-3 may create a box of a third size, the fourth erector 600-4 may create a box of a fourth size.

The system may also include a plurality of conveyors 650 for conveying the empty boxes 500 from the box erectors to the discharge stations 400. The conveyors may be configured so that boxes from any of the erectors may be conveyed to any of the discharge stations. Alternatively, as shown in FIG. 1, the conveyors from the erectors to the discharge stations may be separate so that each erector only feeds empty boxes to a single discharge station.

### Operation

The system is operable to sort a plurality of items into bins 20 and then automatically retrieve the bins after items are sorted to the bins. The system may empty the retrieved bins. Alternatively, the system is operable to discharge the bins from the system so that the bins can be processed at a location remote from the system.

The process of sorting the items into a plurality of bins may optionally include the step of loading the items onto a plurality of independently operable delivery vehicles 200 that operate within an aisle 100. To deliver an item, one of the delivery vehicles 200 may drive within the aisle along a vertical loop from a loading location to one of the bins. At the bin, the delivery vehicle may actuate a transfer mechanism to deliver the item into the bin. After delivering the item, the delivery vehicle may drive within the aisle along the vertical loop to return to the loading location to receive another item to be delivered. The process may be repeated with the delivery vehicles to sort the items into the sort bins.

As described above, the process of sorting items may optionally include the step of scanning items to identify a characteristic for each item before the item is loaded onto one of the delivery vehicles. For instance, the characteristic may be a unique identifier such as a product identification code. Alternatively, the process may include the step of manually entering information regarding the characteristic, such as keying in the product identification code. The central controller 800 may then use the characteristic to determine the bin to which the item is to be delivered.

The process of sorting an item may also include the step of conveying the item along a conveyor and scanning the item as the item is conveyed. A scanner positioned along the conveyor such as a bar code scanner or a line scan camera may scan the item as the item is conveyed along the conveyor. The conveyor may convey the item to one of the delivery vehicles at a loading location so that the item may be loaded onto the delivery vehicle 200. Alternatively, the process of sorting may include the step of scanning the item and placing the item directly onto one of the delivery vehicles. For instance, the operator may manually place the item onto the delivery vehicle or an automated item, such as a robotic arm may place the item directly onto the delivery vehicle.

The process for sorting an item may also include moving the delivery vehicle within an aisle along a vertical loop that includes one or more vertical segments and one or more horizontal segments. The bins 20 may be positioned on either side of the aisle so that the delivery vehicle may transfer the item forwardly into a bin on one side of the aisle or rearwardly into a bin on a second side of the aisle.

The step of moving the delivery vehicle vehicles may include the step of moving the delivery vehicles along a track 105 within the aisle 100. The step of moving the delivery vehicles may include driving the vehicles vertically or lifting the vehicles. The step of driving the delivery vehicles may include the step of actuating gates along the track at intersections to control the direction of travel for each vehicle.

The central controller 800 may control the delivery of items to accumulate items in the bins. Specifically, the central controller 800 may store the identification of a group of items that is to be accumulated together in one of the bins. For instance, the central controller may receive information regarding a group of items that are required for a particular order. The central controller will provide control signals to the delivery vehicles to deliver the items for the order into one of the bins. Once all of the items for an order have been accumulated into the bin, the central controller identifies the bin as being ready for retrieval.

The central controller 800 may control each delivery vehicle separately so that each vehicle follows a vertical loop within the aisle, but each vehicle may follow a separate path depending on the bin to which the vehicle is to deliver an item. For instance, a first vehicle may follow a first path to a first bin while a second vehicle follows a second path to a second bin.

The process of sorting the items may include the step of determining the route for a vehicle based on the bin to which an item is to be sorted. Specifically, the central controller 800 may determine the route for the vehicle and communicate information to the vehicle regarding the bin into which the item is to be delivered.

After determining the route for a vehicle, the central controller may provide signals for controlling the gates along the track to direct the vehicle to the appropriate column. The gates may be directly actuated by an actuator such as a solenoid so that the central controller may provide signals to the gate solenoids. Alternatively, the delivery vehicle may include an actuator for actuating the gates along the track. The central controller may provide signals to the delivery vehicle to selectively actuate the actuator to selectively actuate the gates to direct the delivery vehicle along the appropriate path.

The process for sorting items may include the step of stopping the vehicle so that the vehicle is aligned with a gap above the bin to which the item is to be delivered. For example, the top of the vehicle may be aligned with the gap between the appropriate bin 20 and the bottom edge of the bin that is immediately above the appropriate bin.

While the vehicle is stopped, a controller onboard the vehicle may send an appropriate signal to the conveyor motor to drive the conveyor belts, which drives the item forwardly to discharge the item into the bin.

The process of retrieving bins may include identifying a bin 20 among the plurality of bins. In particular, the central controller 800 may determine that all the items in a group of items have been delivered to a bin. Once the items in the group are delivered to the bin, the central controller 800 may identify the bin as a bin to be retrieved.

The process of retrieving a bin may also include the process of driving a vehicle within the aisle 100 to a bin that is to be retrieved. The vehicle may be the same vehicle as the delivery vehicle, or the retrieval vehicle may be configured differently than the delivery vehicle. The retrieval vehicle may move vertically and/or horizontally within the aisle.

Optionally, when retrieving a bin, the retrieval vehicle may move from a staging location to the storage location from which the bin is to be received. For instance, the system may include one or more retrieval vehicles 300 that are not used to deliver items. Therefore, when the retrieval vehicles are not in operation, the retrieval vehicles may be staged in a location that is outside of the delivery paths of the delivery vehicles 200.

The staging location for the retrieval vehicles 300 is preferably located within the aisle 100. For instance, referring to FIGS. 1 and 5, the system may include a staging column 150 within the aisle 100. The staging column 150 may be positioned anywhere along the length of the aisle. In the present instance, the staging column is located adjacent the loading column 140 where items are loaded onto the delivery vehicles. Storage locations or storage bins may be positioned along the staging column 150. However, in the present instance storage bins are not located along the staging column thereby minimizing the need for delivery vehicles to move through the staging column.

Rather than staging the retrieval vehicles when not in use, the retrieval vehicles may move within the aisle. For instance, the central controller 800 may track the gaps between the delivery vehicles moving within the aisle. The central controller 800 may control the movement of the retrieval vehicles so that the retrieval vehicles move within gaps between the delivery vehicles. Specifically, the controller 800 may control the path that the retrieval vehicles move to minimize the impact of the retrieval vehicles on movement of the delivery vehicles when the retrieval vehicles are not in use.

As noted above, the process of retrieving a bin 20 may include the step of moving a vehicle within the aisle to the bin. Once the vehicle is positioned adjacent the bin, the vehicle may transfer the bin onto the vehicle while the vehicle is in the aisle. In other words, the bin 20 is transferred from a storage location into the aisle 100.

The bin may be transferred onto the vehicle by a mechanism at the storage location or the vehicle may include a transfer mechanism for transferring the bin onto the vehicle. In the present instance, the vehicle includes a transfer mechanism operable to engage the bin and transfer the bin onto the vehicle. Optionally, the process of transferring the bin may include the step of extending a transfer mechanism 350 from the vehicle 300 into engagement with the bin 20 and then retracting the transfer mechanism to pull the bin onto the vehicle.

The step of extending the transfer mechanism 350 may include the step of extending one or more telescoping arms 352 toward the bin. Optionally, the transfer mechanism 350 may include retractable engagement elements, such as pivotable latching fingers 355, 357. The step of extending the telescoping arm 352 may include the step of maintaining the latching element in a retracted position while the arm is extended. After the arms 352 are extended, the engagement elements may engage the bin. For instance, after the arms are extended into the storage location at which the bin is located, the latching fingers 355, 357 may pivot into an extended position to engage the bin.

The step of retracting the transfer mechanism may include the step of withdrawing the arms by collapsing the telescoping arms 352 into a retracted position to pull the bin onto the vehicle. Additionally, the step of retracting may include the step of maintaining the latching elements 355, 357 in the extended position so that the latching element(s) maintain engagement with the bin as the arms are retracted.

Referring to FIGS. 8-10, the operation of the retrieval vehicle 300 when retrieving a bin is illustrated. In FIG. 8, the vehicle is illustrated with the transfer mechanism 350 in a retracted position. Once the vehicle is aligned with a bin to be retrieved, a motor on the vehicle is actuated to turn a drive mechanism (such as one or more gears), which in turn extends the transfer mechanism 350 into an extended position as illustrated in FIG. 9. In this position, the transfer mechanism extends into the storage location so that the telescoping arms 352 straddle the bin as shown in FIG. 11B. Once the arms are extended, continuing to drive the motor actuates the latches 355 to extend the latches into engagement with the bin. In the present instance, the latches are actuated by pivoting the latches 355, 357 into the extended position as shown in FIG. 10. The bin 20 is retained between the front latches 355 that contact the front edge of the bin and the rear latches 357 that contact the rearward edge of the bin (see FIG. 11C). In this way, the bin is positively retained so that the bin moves forwardly or rearwardly in response to the arms 350 extending or retracting.

The step of retrieving the bin 20 may optionally include the step of releasing the bin from a bin retainer. For instance, the storage location may include a retainer the engages the bin to impede displacement of the bin out of the storage location. In one example described above, the retainer 42 may engage a surface of the bin to retain the bin in the storage location. The retainer may be a stop 42 that abuts a surface of the bin to impede movement of the bin.

The step of releasing the bin retainer 42 may include the step of actuating an actuator 44 to displace the bin retainer. The step of actuating the actuator may include the step of continuing to engage the actuator so that the retainer remains in a released position during substantially the entire displacement of the bin from the storage location. The step of actuating the actuator 44 to release the bin retainer 42 may comprise the step of extending the transfer mechanism 350 into the storage location. Optionally, the step of actuating the actuator 44 may include the step of aligning the transfer mechanism with the actuator.

Optionally, the retrieval vehicle 300 may include side walls 330 with a generally horizontal surface 320 between the side walls. A front opening may extend along the front edge of the vehicle between the side walls and a rear opening may extend along the rear edge between the side walls. The step of retrieving the bin may include the step of displacing the bin onto the horizontal surface through the front opening or the rear opening.

As noted above, the process may include the step of emptying the retrieved bin. The method for emptying a retrieved bin 20 may include the step of driving the retrieval vehicle within the aisle to a location where the bin may be emptied. Specifically, the process may include the step of moving the vehicle vertically and/or horizontally along a path that extends from the storage location where the bin was retrieved to a discharge station 400 where the bin can be emptied.

The central controller may determine a path for the retrieval vehicle within the aisle based on one or more of a number of variables. For instance, the system may include a plurality of discharge stations 400. Each discharge station may be configured to receive items or orders of a certain characteristic. For example, a discharge station may be configured to receive groups of items having a total weight below a first threshold and another discharge station may be configured to receive groups of items have a total weight above the first threshold. Similarly, the different discharge stations may be configured to receive orders based on features such as the number of items in a bin, the estimated volume of the items in the bin, the maximum length of items in the bin etc.

Alternatively, each discharge station may be configured to receive bins regardless of the physical characteristics of the items in the bin. In other words, each discharge location is configured to receive any of the bins regardless of the grouping of items in the bin. In this way, the central controller may determine which discharge station a retrieved bin is to be directed to based on a variety of factors, including but not limited to: the proximity of the retrieved bin to the discharge station, the traffic (i.e. the travel of the delivery vehicles and the retrieval vehicles) between the retrieved bin location and the discharge station, and availability of the discharge station (i.e. whether a vehicle is currently at or en route to the discharge station).

The process of moving the retrieval vehicle 300 to a discharge station 400 may include the step of driving the vehicle within the aisle 100 along a track 105. The step of driving may comprise the step of driving a first driving wheel on one side of the aisle and the step of driving a second driving wheel on another side of the aisle.

The process of emptying the bin may include the step of transferring the bin off the retrieval vehicle. The bin may be transferred off the retrieval vehicle at the discharge station. Optionally, the bin may be transferred by actuating the transfer mechanism 350 to extend the bin away from the retrieval vehicle.

The steps in moving the bin off the vehicle 300 at the discharge location may be similar to the steps for transferring a bin onto the vehicle from one of the storage locations, but in reverse. For instance, FIGS. 11A-11D illustrate the steps in transferring a bin from one of the storage locations when the central controller determines that all the items in a predetermined group have been accumulated in the bin. In FIG. 11A, the retrieval vehicle is aligned with the storage location so that the support surface 320 of the vehicle is the same height as or slightly lower than the bottom surface of the bin. In FIG. 11B, the transfer mechanism is extended into the storage location. In FIG. 11C, the engagement elements 355, 357 are moved into engagement with the bin. In FIG. 11D, the transfer mechanism is retracted while the engagement elements 355, 357 engage the bin, thereby transferring the bin onto the vehicle 300. In contrast, the process of transferring the bin off the vehicle may start by aligning the vehicle with a conveyor or guide at the discharge station 400. The transfer mechanism 350 is then extended while the engagement elements engage the bin, thereby displacing the bin off the vehicle.

The bin 20 may include a movable wall and the process for discharging items from the bin may include the step of displacing the movable wall. For instance, the retrieval vehicle may include an actuator operable to displace the moveable wall to discharge the items from the bin. Alternatively, the bin may cooperate with a mechanism at the discharge station to displace the movable wall. In the present instance, the bottom wall of the bin is displaceable, and the process includes the step of supporting the bin while releasing the bottom wall of the bin so that the bottom wall is displaced into the open position allowing items fall through the bottom of the bin.

The process of discharging items from the bin may include the step of aligning the bin 20 with a guide 430 or 435 that directs items toward a container 500. After the step of aligning the bin with the guide, the bin is opened, and the guide directs the items into a container.

The process of discharging items optionally includes aligning an empty container with the guide that guides the items discharged from the bin. The process of aligning an empty container may include the step of conveying the empty container along a conveyor to a discharge location 475. The method may further include the steps of engaging the empty container 500 at the discharge location to retain the empty container at the discharge location while items are transferred from the bin into the container. The step of engaging the empty container may include the step of clamping the empty container in position or engaging the container between one or more stops to limit movement of the container.

After the items are transferred into the container 500, the full container is designated 510 in FIGS. 1, 2. The full container is conveyed away from the discharge location so that an empty container can be moved into the discharge location to receive items from the next bin. The full container may be conveyed by a horizontal conveyor such as a transfer conveyor 660 and the transfer conveyor may convey the container to an output conveyor that conveys the container with the sorted items away from the sorter 15.

Referring to FIGS. 15-21, the process of discharging the items from the bin 20 may include the step of dropping the items onto a generally horizontal conveyor. The horizontal conveyor may convey the items toward the discharge location that is aligned with a container below the conveyor.

The process of conveying the items toward the discharge location may include the process of driving side conveyors 462, 464 that straddle the horizontal conveyor and form an angle with the horizontal conveyor. The side conveyors may be driven in a forward direction to urge items down toward the horizontal conveyor and toward the discharge location 475.

The method may optionally include the step of displacing the side conveyors 462, 464 relative to one another to increase the distance between the side conveyors.

The method of discharging items may optionally include the step of sensing whether the items have jammed somewhere in the path between the bin 20 and the empty container 500. Additionally, the system may include the step of displacing the items along the path to attempt to free up the jammed items. For instance, the method may include the step of driving one of the side conveyors in a forward direction while driving the second side conveyor in a reverse direction to twist items that may be jammed in the path along the horizontal conveyor 460.

Optionally, the process of discharging items may include the step of progressively releasing the items from the bin. In this way, the items are not released or transferred all at once. Progressively releasing the items may limit or minimize the likelihood of items becoming jammed as the items are transferred into the container 500. The step of progressively releasing items from the bin may include the step of progressively opening a displaceable wall of the bin. For instance, the moveable wall may include a plurality of segments such as door segments 25A,B,C and the method may include the step of sequentially opening the door segments. Alternatively, the method may include the step of gradually opening or displacing a displaceable wall of the bin to gradually increase the opening in the bin through which items are discharged from the bin.

After the items are discharged from the bin, the process may include the step of transferring the bin back onto the retrieval vehicle. The process of transferring the bin back onto the retrieval vehicle may include the step of closing the moveable wall while the bin is transferred onto the vehicle.

After the empty bin is transferred back onto the vehicle, the vehicle may then travel vertically or horizontally within the aisle to follow a path to an empty storage location (i.e., a storage location in which there is no bin). The empty storage location may be the storage location from which the vehicle retrieved the bin. Alternatively, the empty storage location may be different from the storage location from which the vehicle retrieved the bin. Once the retrieval vehicle arrives at the empty storage location, the vehicle transfers the empty bin into the storage location by reversing the steps illustrated in FIGS. 11A-11D.

The step of transferring the empty bin into the empty storage location may include the step of actuating the retainer into a released position while the bin is transferred into storage location and then actuating the retainer into a retaining position so that the retainer engages the bin to retain the bin.

As noted above, the method may include the step of discharging the full bins from the sorting system rather than emptying the full bins. In such a method, the items may be sorted into the sort bins as described above and the sort bins may be retrieved when the sort bins are full. The retrieved bins may then be conveyed to one of the discharge stations as described above. At the discharge station, rather than transferring the bin off of the vehicle 300 to empty the bin, the bin is transferred onto a conveyor at the discharge location. For instance, the bin 20 may be transferred onto the transfer conveyor 660 so that the full bin may be transferred away from the sort system.

The method may further include the step of transferring an empty bin onto the retrieval vehicle after the vehicle has transferred the full bin onto the conveyor at the discharge location. For instance, the system may include a conveyor for supplying empty bins to the discharge location. The conveyor may be controlled so that an empty container is advanced to the discharge location after the retrieval vehicle discharges a full bin. The vehicle may then transfer the empty bin onto the vehicle similar to the manner in which the vehicle retrieves a full bin from a storage location as described above.

Once an empty bin is loaded onto the vehicle, the vehicle may move to one of the empty storage locations to transfer the empty bin into the empty storage location as described above.

Furthermore, the process of discharging full bins from the retrieval vehicle may include the process of automatically emptying the bin after the bin is conveyed away from the discharge station 400.

Referring to FIGS. 22A-22C, the process of emptying the full bin may include the step of operating a conveyor 700 to convey the full bin away from the sorter. The conveyor may convey the full bin 20 toward an opening over a conveyor 650 conveying an empty container 505 that is positioned in a discharge location to receive the items from the bin. The bin may discharge the items into the empty container while the bin is positioned over the empty container.

The method of discharging the items from the bin may include the steps of supporting the bin 20 while the bin is positioned over a gap in the conveyor 700 so that the bottom of the bin is free to open. The bottom door 25 of the bin opens thereby allowing the items in the bin to fall into the box 505 below. After the items are discharged from the bin 20, the bin is advanced along the conveyor 700 and the full container 505 is moved along the container conveyor 650.

Referring to FIGS. 23A-C, the process of emptying the bins may include the step of selectively actuating a moveable section 725A, 725B of the conveyor 700 selectively create an opening. Such a process may include the step of identifying the location for discharging the items from the bin and conveying the full bin toward the location. The process may also include the step of operating a container conveyor 650A, 650B to align an empty container with the identified location for emptying the bin. The method may further include the step of actuating the moveable conveyor segment at the identified location to create a gap in the conveyor. Additionally, the method may include the step of supporting the bin so that the bottom door of the bin can open so that items may be discharged from the bin into the container.

Optionally, the process may include the step of creating empty containers and conveying the empty container toward the discharge location. Optionally, the process may include the step of creating empty containers having different physical characteristics and selecting the discharge station to which a container is to be delivered based on the physical characteristics of the empty container.

It should be understood that the method described above may include the step of sorting items to the bins 20 while the retrieval vehicle 300 is operating to retrieve a bin from a storage location, move the retrieved bin to a discharge station 400, empty the retrieved bin and/or return an empty bin to an empty storage location.

In the foregoing discussion, the items are sorted to the sort bins prior to being discharged at one of the discharge stations. However, it should be understood that the process may also include the step of delivering an item directly to the discharge station to discharge the item into a container. In this way, certain items can bypass the sort bins and be delivered directly to the containers to be transferred away from the sorter.

In some instances, the items in a group (such as the items in an order) may be too large or too numerous to fit into a single sort bin 20. In such an instance, the central controller will control the delivery vehicles to deliver the items to two or more separate bins. The bins will be identified together as having a single order so that none of the bins will be retrieved until all of the items for the order are sorted to the sort bins that have been identified for the order. The system will then retrieve the plurality of bins and deliver each of the bins to one of the discharge stations so that all the items in each of the bins may be emptied into a single container. In this way, the method may include the step of retaining a container at the discharge location after the first bin is emptied into the container.

Alternatively, the plurality of sort bins may be sequentially conveyed to the discharge location and then sequentially emptied into a plurality of empty containers. The central controller may identify each of the separate containers so that the separate containers are identified as belonging to the same order.

The system may also process a group of items to control the sequencing of how items are sorted to two or more bins. The system may also control the order in which the bins are retrieved by the retrieval bots 300.

According to one example, the system may sort a number of items for an order into a plurality of bins. The sorting of the items may be done by a plurality of sorting vehicles 200 operating within an aisle as discussed above. The system may determine which of the bins an item for an order is to be sorted based on a first characteristic. For instance, the first characteristic may be the weight of an item and the system may sort items having a weight over a threshold to a first bin while items having a weight below the threshold may be sorted to a second bin. In this way, the system may sort items for a single order into a plurality of bins based on a characteristic of each item so that items sharing a common characteristic are sorted together into a bin.

The first characteristic may be any of a variety of characteristics of the items, including but not limited to length, width, height, weight, fragility, density, volume, or shape.

The system may also control the sequencing of the order in which the bins are retrieved by the retrieval bots. One method for controlling the order in which the bins are retrieved is to retrieve the bins in the order of the bins being filled. Specifically, after the last item for an order is sorted into a bin, the bin may be identified as being full or as being ready to be retrieved. The system may prioritize the retrieval of the bins based on the order in which each bin is identified as being full or based on the order in which each bin is identified as being ready to be retrieved.

Rather than controlling the bin retrieval sequence based on the order in which the bins are identified as full or as being ready to be retrieved, the system may control the sequencing of retrieval of the bins to maintain order cohesion. Specifically, if the items for an order are sorted into a plurality of bins, the system may delay the retrieval of any of the bins for the order until all of the items for an order are sorted. For instance, an order may include items A-F and items A, B, C are to be sorted to a first bin and items D, E, F are to be sorted to a second bin the system. Once items A, B and C are sorted to the first bin, the bin may be considered full since all of the items have been sorted to the bin. However, if one of the items D, E or F has not yet been sorted to the second bin then the system may delay the retrieval of the first bin. Specifically, the first bin may not be designated as being ready for retrieval until all of the items for all of the bins for the order have been sorted. Once the last item from the order is sorted, all of the bins having items for the order may be designated as being ready for retrieval.

Once all of the bins for an order are designated as being ready for retrieval, the system may control the retrieval of the bins to keep the items for the order together. For instance, in one application all of the items from the plurality of bins for a single order may be discharged into a single container at one of the discharge stations. In such an instance, the bins for the order are serially retrieved and conveyed to a common discharge station 400. A single container is retained at the discharge station until the items from all of the bins for the order are discharged into the container. The full container with all of the items for the order is then advanced away from the discharge station 400.

In an alternate application, rather than discharge the items from the plurality of bins for an order, the bins may be electronically tagged as being associated with a single order and the bins may be sequentially discharged from the sorting system 15 to keep the bins together. For example, the system may control the discharge of other bins for other orders so that all of the bins for a single order are discharged sequentially without other order bins being inserted onto the conveyor between bins that are for a single order. In this way, the plurality of bins for a single order are conveyed along an output conveyor (such as conveyor 700) in an uninterrupted sequence.

As noted above, the items for an order may be sorted to a plurality of bins based on a characteristic of the items so that items having a similar characteristic are sorted to the same bin. It may be desirable to retrieve the bins in a particular order based on the characteristic of the items in the bins. For example, an order having multiple items may be sorted to a plurality of bins, such as two bins. The first bin may be for items having a weight greater than a certain threshold. The second bin may be for items having a weight below the threshold. After the items for the order have been sorted to the two bins, the system may retrieve the first item first and transport the first bin to the discharge station to discharge the heavy items into a container. Subsequently, the system may retrieve the second bin and transport the second bin to the discharge station to discharge the light items into the container. In this way, the system avoids discharging heavy items in an order onto the light items, which could damage the light items. Accordingly, the system is operable to retrieve multiple bins in a sequence so that the items are discharged into a common container based on a physical characteristic of the items in the order.

As discussed above, the system is operable to sort items into bins and then discharge the items from one or more of the bins into a container. Optionally, the system may also include one or more elements for urging items into the container after the items are discharged into the container. For example, one or more of the items may project upwardly above the upper rim of the open container after the items are dumped into the container. The system may include structure configured to urge the projecting item(s) downwardly into the box. Preferably the structure urges the projecting item(s) below the upper rim of the box.

Optionally, the structure for urging items into the container may include a height limiting bar that extends across the width of the container. The bar extends at a predetermined height, such as the height of the rim of the box. The bar may be positioned adjacent the discharge station so that the box passes under the bar as the box is conveyed away from the discharge station. In this way, items in a container that project above the rim will engage the height limiting bar and tend to be forced downwardly into the container as the container passes under the bar.

Optionally, the structure for urging items into the container may include a flexible element, such as a curtain that extends across the width of the conveyor adjacent the discharge station so that containers pass under the curtain as they are conveyed away from the discharge station. The curtain hangs above the containers and extends below the upper rim of the containers. Optionally, the curtain may be formed of a plurality of panels, forming a split curtain having separate panels. In this way, if items in a container project above the rim of the container, the curtain will tend to urge items downwardly into the container as the container passes under the curtain.

Accordingly, the system may optionally include the steps of discharging items into a container and engaging items that project above a threshold so that the items are urged downwardly into the container. Optionally, the step of engaging items that project above the threshold may occur during the step of displacing the container away from the discharge station.

Another aspect of the system may include the steps of retrieving bins of items and discharging the items from the bins into containers. The step of discharging items into container may include the step of dropping the items into a container. The system may also include the step of shaking or jogging the container to settle the items in the container. For instance, the method may include the step of shaking the container back and forth. Similarly, the method may include the step of vibrating the container to settle the items. Optionally, the step of settling the items in the container may occur while the container is positioned at the discharge station.

The foregoing description describes a system having a sortation system with a single aisle. However, the system may include a plurality of aisles, with each system being configured as described above. Optionally, in multi-aisle system, a feed system may be provided to provide items to be sorted to each aisle. The feed system may be any of a variety of systems including but not limited to delivery vehicles or conveyors.

The central controller may be configured to control the feed system so that the feed system feeds a first group of items to the first sort aisle while feeding a second group of items to the second aisle. In this way, the first aisle may be utilized to process items having a first characteristic and the second aisle may be utilized to process items having a second characteristic. The characteristic used to determine the aisle to which the feed system is to feed an item may be any of a variety of characteristics, such as a physical characteristic, including, size, weight, shape etc. But the characteristic need not be a physical attribute of the item.

Accordingly, the system may include the process of feeding items to a plurality of aisles of sorting devices. Each aisle may be configured to sort the items to a plurality of sort locations to accumulate items in the sort locations. After the items for an order have been completed, the sorting devices may retrieve the sort bin or bins for the completed order using a retrieval device and convey the bin(s) to a discharge location where the bins are either emptied or unloaded and conveyed away from the sorting device. Optionally, the system may include the process of detecting a characteristic of each item and determining the aisle to which the item is to be directed. The system may further include the process of controlling the feed system to selectively feed the items based on the step of determining the aisle to which the item is to be directed.

As described above, the system may operate by accumulating items into sort bins and then retrieving the bins when they are full and discharging the full bins onto a conveyor rather than discharging the items from the bins into another container (see e.g., FIGS. 22A-C, 23A-C and the description above). In the foregoing description, the system is described as feeding an empty bin to the retrieval vehicle 300 after the retrieval vehicle unloads the full bin to the output conveyor 700. However, in certain applications, rather than loading an empty bin onto the vehicle, it may be desirable to load a bin already having items in it. Accordingly, after the retrieval vehicle discharges a bin away from the aisle, the system may feed a replacement bin toward the retrieval vehicle. The replacement bin may be an empty bin, or it may contain one or more items. The replacement bin may then be loaded onto the retrieval vehicle. The retrieval vehicle may then deliver the replacement bin to one of the sort locations so that items may be sorted into the replacement bin.

According to yet another aspect, a system is provided for sorting items using a plurality of aisles. The system may include using a plurality of the aisles to sort items for one order. For instance, as noted above, the system may include the process of sorting items to first and second sort aisles based on characteristics of the items. Additionally, as noted above, the system may be configured to feed replacement bins to the sort aisle after a sort bin is discharged from the aisle and the discharged sort bin may be replaced with a replacement bin that contains items. Accordingly, a plurality of items may be sorted to a first bin in a first storage location adjacent a first aisle. Optionally, the items may be sorted to the first bin using a plurality of sort vehicles 200 as described above. A first retrieval vehicle 300 in the first aisle may retrieve the first bin and discharge the bin from the first aisle. The discharged bin may be conveyed to a second aisle. A second retrieval vehicle 300 in a second aisle may retrieve the first bin at an input/output or discharge location. The second retrieval vehicle may then deliver the first bin to a second sort location along the second aisle. One or more items may then be sorted to the first bin while the first bin is in the second storage location. For example, one or more delivery vehicles may move within the second aisle to sort the one or more items into the first bin in the second storage location.

Optionally, the system may also include the step of retrieving the first bin using a retrieval vehicle in the second aisle after the first bin has received all of the items required from the second aisle sorting. In this way, the first bin includes items from both the first aisle and the second aisle. The retrieval vehicle may then deliver the first bin to a discharge station where the first bin is discharged from the second aisle.

As illustrated in FIGS. 1-2, the system may include one or more discharge stations 400 positioned along the aisle 100 of the sorting system 15. The system is illustrated with the discharge stations 400 on one side of the aisle 100. However, it should be understood that the discharge stations may be on either side of the aisle. Additionally, the discharge stations 400 may be positioned on both sides of the aisle.

The system may be operated to decrease the cycle time when one of the retrieval vehicles discharges a bin from the sorting system 15. For instance, if the sorting system includes discharge stations on both sides of the aisle and two of the discharge stations are aligned in the same column, the system may control the flow of replacement totes to the discharge stations to allow the retrieval vehicle to simultaneously load a replacement bin onto the retrieval vehicle at one station while discharging a full bin at the second station.

An exemplary process for simultaneously loading a replacement bin while unloading a full bin may be described with reference to FIGS. 8-10. Specifically, when the retrieval vehicle 300 is positioned in a location in the aisle having a first discharge station 400 on one side and a second discharge station on a second side, the retrieval mechanism 350 on the vehicle may be extended toward a replacement bin at the first discharge location while a full bin is positioned on the support surface 320. Specifically, the system may control the feeding of the replacement bins to convey a replacement bin to be aligned with the first discharge location. The retrieval mechanism 350 may engage the replacement bin and pull the replacement bin toward the vehicle. As the retrieval mechanism pulls the replacement bin toward the support surface 320, the retrieval mechanism pushes the full bin off the support surface and toward the second discharge station across from the first discharge location. For example, as illustrated in FIG. 10, the retrieval mechanism may include forward latches 355 and rearward latches 357. The forward latches 355 may pull the replacement bin onto the vehicle 300 while the rearward latches 357 push the full bin off of the vehicle. By simultaneously pushing off a full bin while loading a replacement bin, the system may reduce the time that the retrieval bot is positioned at the discharge station.

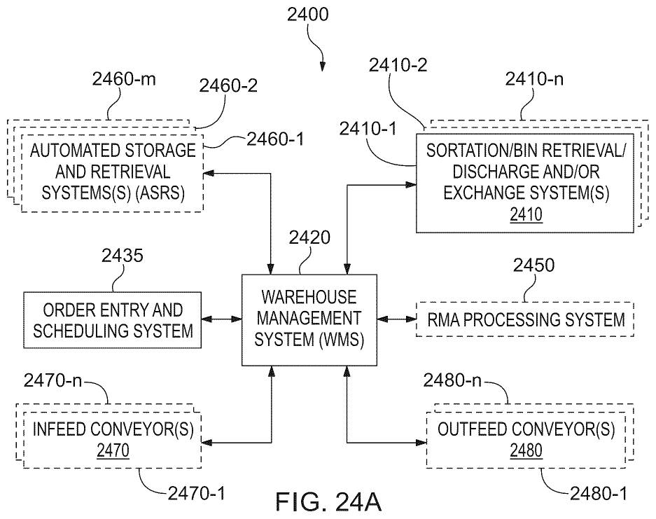

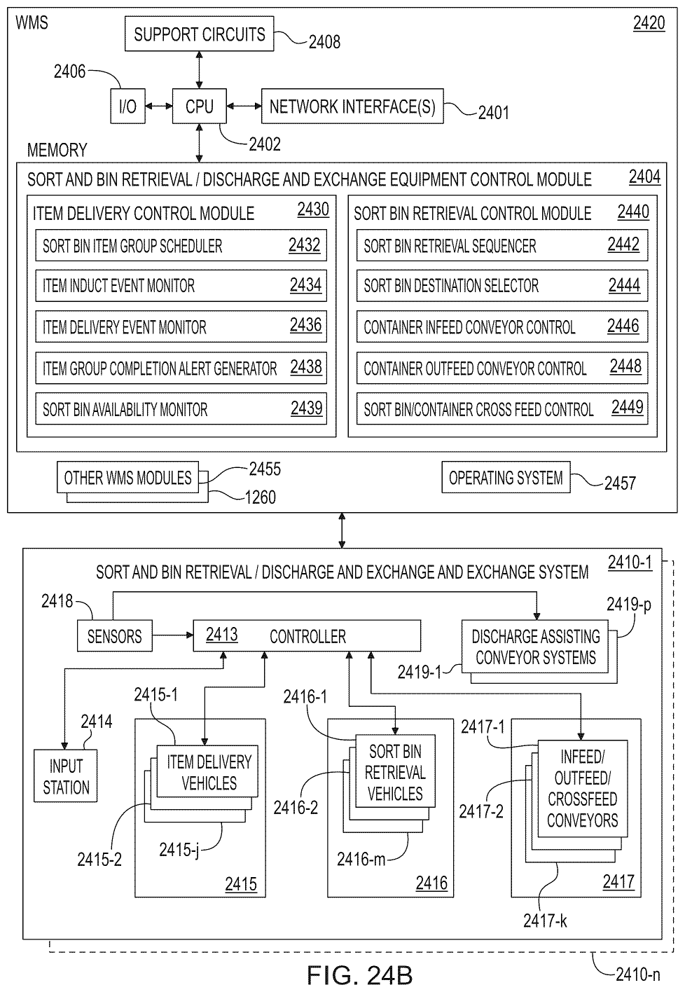

Turning now to FIG. 24A, there is shown a block diagram depicting aspects of a warehouse operation or distribution center utilizing a warehouse management system and integrating aspects of a material handling apparatus constructed according with the foregoing embodiments and other exemplary embodiments described below.

FIG. 24A is a block diagram depicting one or more sortation and bin retrieval/exchange (SBRE) systems, indicated generally at 2410-1 to 2410-n, which are operable to sort items identified to respective groups of items to designated sort bins which have been temporarily associated with the groups of items. In embodiments, the groups of items correspond to items needed to fulfil orders. In the exemplary embodiment shown in FIG. 24A, sortation and sort retrieval, discharge (emptying) and/or transfer tasks are managed under the direction of a centralized warehouse management system 2420 that forms part of an order fulfillment arrangement 2400. As shown in FIG. 24A, an exemplary order fulfillment arrangement 2400 may also include an order entry and scheduling system, indicated generally at 2435 which by way of illustration permits an administrator to set minimum inventory thresholds to trigger replenishment alerts and tracking of inventory levels as new orders are received and processed. Arrangement 2400 optionally includes a return material authorization (RMA) processing system 2450 wherein item returns deemed acceptable for return to inventory are processed and may be fed as input items into one or more SBRE's as SBRE's 2410-1 to 2410-n (depending upon order flow) or returned to storage locations of one or more automated storage and retrieval systems (ASRS) indicated generally at 2460-1 to 60-m.

FIG. 24B is a block diagram depicting, in greater detail, one or more sortation and sort bin retrieval/exchange system(s) (SBREs) as SBRE systems 2401-1 to 2410-n whose operations are coordinated by a warehouse management system (WMS) 2420, as may be performed in the operation of an order fulfillment center such as the order fulfillment center 2400 depicted in FIG. 24A. It will be seen that SBRE 2410-1 includes a controller 2413, an item input station 2414, a delivery mechanism 2415 which in an embodiment comprises independently movable vehicles and is configured to receive items as they arrive at an input station and transfer them to an arrangement of sort bins, a sort bin retrieval mechanism 2416, which in an embodiment comprises a independently movable vehicles configured to extract sort bins—once they have accumulated a group of items corresponding, for example, to an order being processed by an order fulfillment or distribution center—and, as will be described in detail shortly, to transport these extracted bins to a transfer station whereby the sort bins may either exit an SBRE as SBRE 2410-1 altogether. In the latter regard, SBRE 2410-1 further includes one or more infeed, outfeed and cross feed conveyors consistent with the previously described embodiments. As such the contents of sort bins may be discharged and transferred to another container (e.g., a carton or other package for shipment to a customer or, in the case of a distribution center, to a larger container such as a gaylord for transport to a point of sale location). As used herein, the term “exchange” is intended to refer to both the transfer of sort bins out of a system without discharging their contents and the transfer of the contents of a sort bin to a different container. Infeed

In the latter case, sort bins which have been emptied are returned to an available location whereupon a new group of items (e.g., applicable to a different customer or distribution destination) may be accumulated therein. The container which receives discharged items from a first sort bin at a first discharge zone may remain at that discharge zone in order to receive other items needed to fulfil the requirements of an order. Alternatively, the partially filled sort bin may be transferred—by one of the infeed/outfeed conveyors by the controller of SBRE 2410-1—to another SBRE as SBRE 2410-n and receive additional items at a discharge zone of that SBRE. Alternatively, or in addition, a partially filled sort bin may receive still other items at some other location external to the SBREs where, for example, items exceeding the handling limitations of the delivery system 2415 may be united with the rest of the items applicable to an order.

In the former case, another of the infeed/outfeed conveyors may be employed at a different type of discharge zone to receive a sort bin without discharging its contents, and that sort bin may be transported to destination remote from an SBRE as SBREs 2410-1 to 2410-n.

In the embodiment depicted in FIG. 24B, the delivery mechanism or system 2415 is implemented by a first group of self-propelled delivery vehicles indicated generally at reference numerals 2415-1 to 2415-j, and the retrieval mechanism or system 2416 is implemented by a second group of self-propelled sort bin retrieval vehicles indicated generally at reference numerals 2416-1 to 2416-m. In embodiments, the first group of vehicles 2415-1 to 2415j and the second group of vehicles 2416-1 to 2416-m are track guided along horizontal and/or vertical segments of an item retrieval path which connects an input station of an SBRE such as item input station 2414 with a discharge station or zone of that SBRE. In an embodiment, delivery vehicles 2415-1 to 2415-j and retrieval vehicles 2416-1 to 2416-m are directed by controller 2413 as needed to define a respective, appropriate item retrieval path for routing of each corresponding delivery vehicle as each vehicle traverses the path which extends from the point at which an item is received from the induct module to the point at which the item is discharged at a sort bin. In embodiments, gate mechanisms are provided at horizontal to vertical track intersections are actuated mechanically by the delivery vehicles as delivery vehicle 140-1, and the delivery vehicles are directed along both horizontal and vertical segments which define a vertical loop.

In some embodiments, the both groups of vehicles 2415 and 2416 have multiple types of transfer mechanisms so that they are capable of performing both item delivery and sort bin retrieval functions at the same time. In other embodiments, a small number of vehicles configured only to provide sort retrieval vehicle functions are employed and may move between aisles depending on the level of sortation activity being performed by item delivery vehicles within the respective aisle of each SBRE. The number of vehicles tasked with sort retrieval functions may be far smaller than those performing the sort tasks, e.g. on the order of 15% to 35%.

At the discharge station(s) of an SBRE, a discharge assistant may be optionally included such, for example, as a downwardly inclined chute or a discharge conveyor as depicted in FIGS. 15-21. In the illustrative example of FIG. 24B, discharge assisting conveyor systems 2419-1 to 2419-p incorporates the aforementioned horizontal, first side and second side conveyors as well as sensors 2418 as inputs for reversible control of conveyor drive motors (not shown) for operating the horizontal, and first and second side conveyors of the discharge conveyor.

In the embodiment depicted in FIG. 24B, WMS 2420 serves as a controller which directs the operation of one or more SBRE systems as system 2410-1. To this end, WMS 2420 includes a central processing unit (CPU) 2402, input/output interfaces 2406, support circuits 2408, memory 2404, and one or more network interfaces 2401. CPU 2402 is configured to fetch and execute instructions, stored in memory 2404, to implement Sort and Bin Retrieval/Discharge and Exchange Equipment (SBRE) Control Module which comprises an Item Delivery Control Module 2430, and a Sort Bin Retrieval Control Module 2440. The SBRE control module comprises an item delivery control module 2430 which includes sort bin item group scheduler 2432, item induct event monitor 2434, item group completion alert generator 2438, and sort bin availability monitor. These modules perform the functions which enable the item delivery control module 2430 to specify the sort bins to which each item that is the subject of at least one order and/or active RMA replenishment process is to be delivered. Memory 2404 also includes other WMS modules 2455 and an operating system 2457.

Sort bin retrieval control module 2440 includes sort bin retrieval sequencer, sort bin destination selector 2444, container infeed conveyor control 2446 (for replacing a container which has received items from a sort bin and has left the system via an outfeed conveyor), conveyor outfeed conveyor control 2448 (for directing containers and/or sort bins away from the discharge station and aisle) and sort bin/container cross feed control 2449 for directing containers or sort bins to other discharge stations so that these may receive items from other sort bins before being directed away from the aisle by an outfeed conveyor.

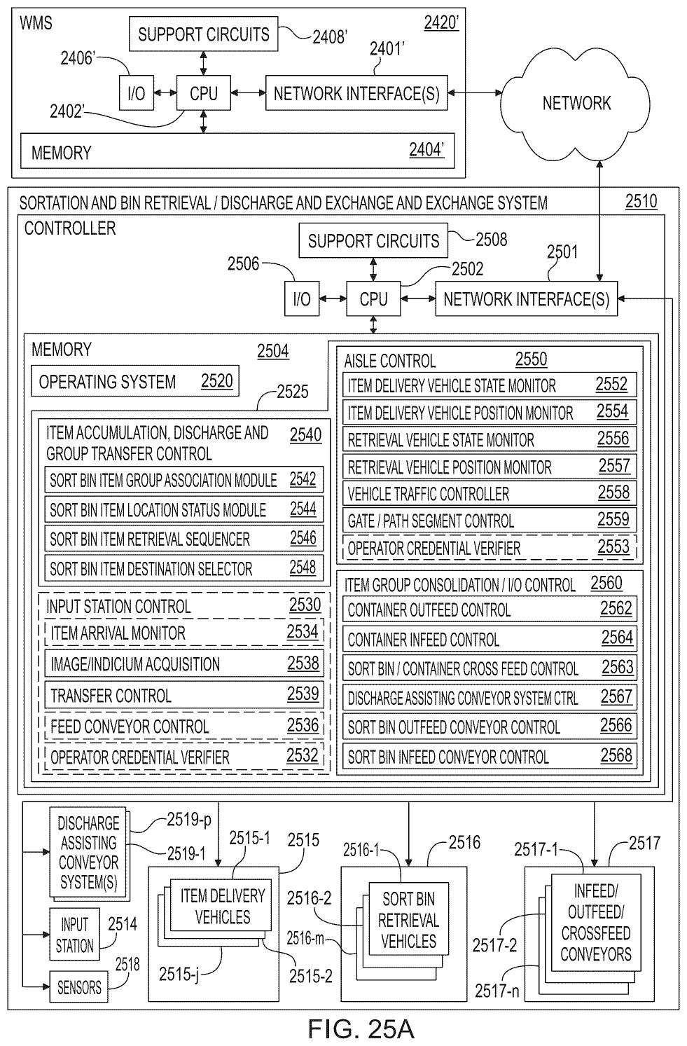

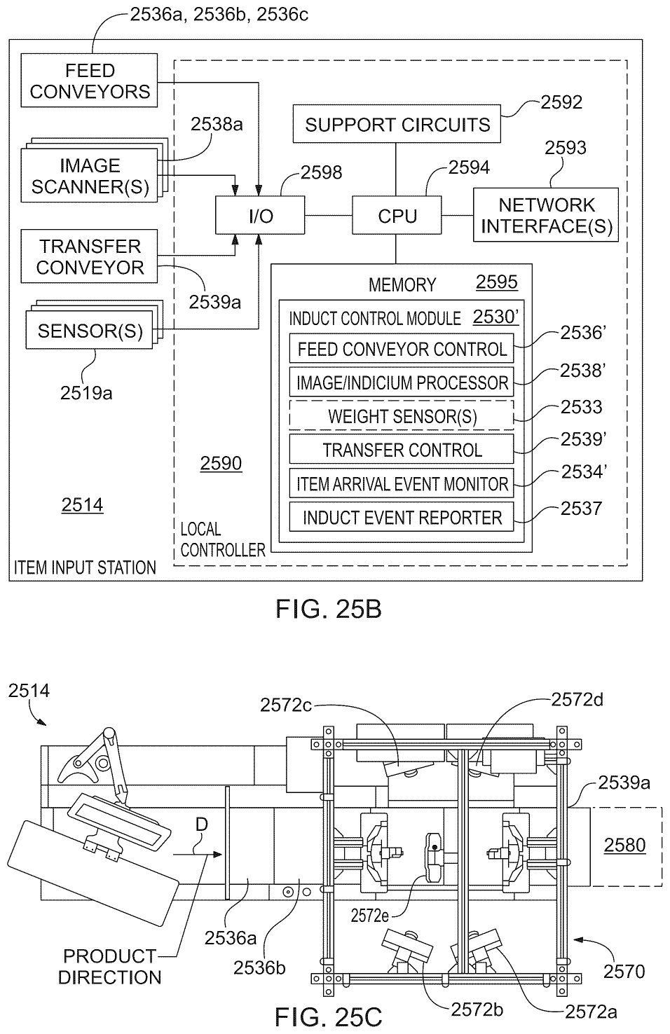

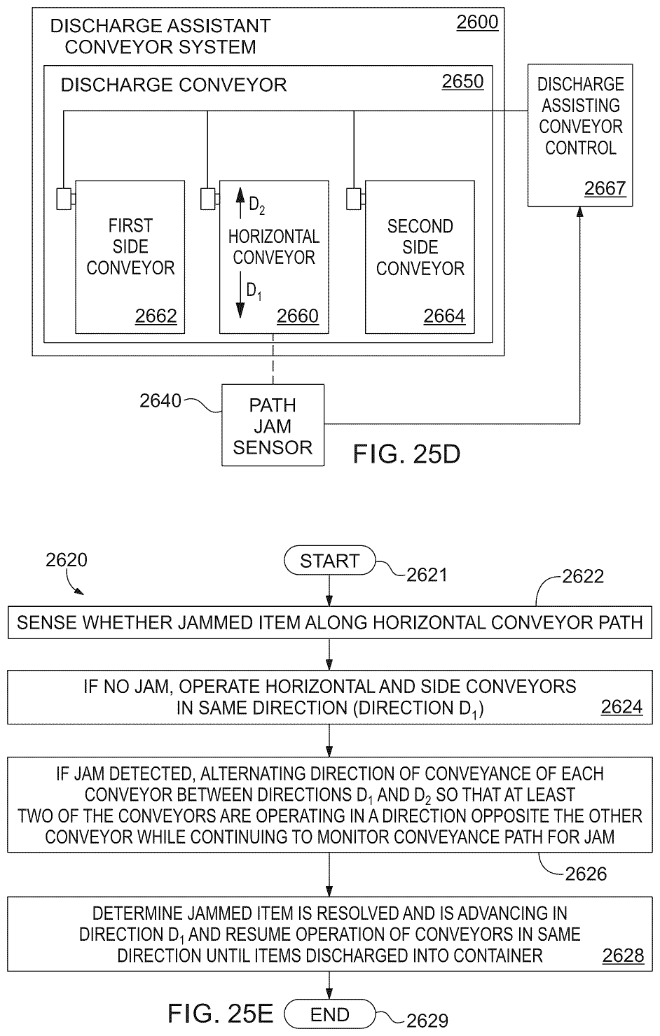

The system of FIG. 25A performs similar sortation and sort bin retrieval, discharge and exchange tasks to those performed by the system of FIG. 24B, but employs an intermediary (equipment control system or ECS 2550) which performs some of the control functions performed by the WMS of FIG. 24B. ECS 2550 includes an item accumulation, discharge and group transfer control module 2540, which includes sort bin item group association module 2542, sort bin location status monitor, sort bin retrieval sequencer, and sort bin destination selector. Item Delivery Vehicle State Monitor 2550 includes an item delivery vehicle state monitor, an item delivery vehicle position monitor, a retrieval vehicle state monitor, a vehicle traffic control which manages the relative positions of the delivery and retrieval vehicles so that collisions are avoided, an optional gate/path segment control.

In embodiments, traffic control provides messages to the vehicles authorizing them to proceed along a segment of the respective path leading to the destination assigned to the vehicle. When that segment has been completed, a vehicle will stop unless it has received the next message to proceed. Other modules include input station control.

The ECS 2550 further includes an input station control module 2530, which includes modules 2534, 2536, 2538, 2538. And 2532, and item group consolidation and I/O control 2560, which includes sub modules 2562, 2564, 2566, 2568, 2563 and 2567. Module 2532, indicated as optional, is used to authenticate an operator (in the event input of items is performed by a person) for purposes of product integrity and traceability as, for example, in highly regulated industries such as the medical field.

Other components common to both the apparatus of FIG. 24B and FIG. 25A use like or similar numerals and are not described herein.

FIG. 25B is a block diagram depicting the functional components of an exemplary item input station 2514, which may form part of the exemplary system of FIG. 25A according to one or more embodiments consistent with the present disclosure. At the input station 2514, items are inducted into the system by serially loading items onto the item delivery system (e.g., vehicles). Since characteristics of the items may be used to control the operation of the vehicles, the system may need to know the characteristics. In one instance, the characteristics may be stored in a central database so that the characteristics are known and the system tracks the progress of the items so that the identification of the item is known as the item reaches the input station. In this way, since the identification of the item is known the system 2514 can retrieve data regarding the characteristics of the item, which are stored in the database. Alternatively, the items are scanned and/or weighed at the input 2514 to identify one or more characteristic of each item.

In one embodiment, each item is manually scanned at the induction station to detect one or more features of the item. Those features are used to ascertain the identification of the item. Once the item is identified, various characteristics of the item may be retrieved from a central database and the item may be subsequently processed based on the known characteristics of the item. For instance, the induction station 602 may include a scanning station that scans for a product code, such as a bar code. Once the product code is determined, the system retrieves information regarding the product from a central database. This information is then used to control the further processing of the item as discussed further below.

In a second embodiment, the items are scanned at the induction station 602 to detect various physical characteristics of the items. For instance, the induction station 602 may measure characteristics such as the length, height and/or width of an item. Similarly, the weight or shape of the item may be detected. These characteristics may be manually or automatically detected at the induction station. For instance, a series of sensors may be used to detect the length of an item and a scale can be used to automatically weigh an item. Alternatively, an operator may analyze each item and enter information regarding each item via an input mechanism, such as a mouse, keyboard or touch screen. For instance, the system may include a touch screen that includes one or more questions or options. One example would be the packaging: is the item in a plastic bag, a blister pack or loose? Is the item flat, cylindrical or round? The system may include default characteristics so that the operator only needs to identify the characteristics for an element if the element has characteristics that vary from the default values. For instance, the default characteristic for items may be flat or rectangular. If an item is rounded (e.g. spherical or cylindrical) the operator inputs information indicating that the item is rounded and the item is subsequently processed accordingly. Based on the detected information the item is processed accordingly.

As noted above, a variety of configurations may be used for the input station, including manual or automatic configurations or a combination of manual and automated features. In a manual system, the operator enters information for each item and the system delivers the item accordingly. In an automatic system, the input system includes elements that scan each item and detect information regarding each item. The system then delivers the item according to the scanned information.

In an exemplary manual configuration, the input system includes a work station having a conveyor, an input device, such as a keyboard, and a monitor. The operator reads information on the item, such as an ID tag, inputs information from the tag into the system using the keyboard or other input device and then drops in onto a conveyor. The conveyor then conveys the piece to the input station. For instance, the operator may visually read information marked on the item or the operator may use an electronic scanner, such as a bar code reader, to read a bar code or other marking on the item. Sensors positioned along the conveyor may track the piece as the conveyor transports the item toward the loading station.

Alternatively, as shown in FIG. 25C, which is a top plan view depicting components of the exemplary item input station of FIG. 25B, there is shown an input station 2514 may include a scanning station 2570 for automatically detecting characteristics of the items. Specifically, the input station 2514 may include feed one or more conveyor(s) as conveyor 2536A for receiving items and conveying the items to a scanning station operable to detect one or more physical characteristics of an item. From the scanning station, a transfer conveyor 2536B of FIG. 4B conveys the item to the loading station 2539A where the item is either loaded onto a receiving surface of the item delivery mechanism or passed through to a reject bin.

The input feed conveyor may be any of a variety of conveying devices designed to convey items. In particular, the input conveyor may be designed to receive items dropped onto the conveyor. For instance, the input feed conveyor may be a horizontal conveyor belt or a horizontal roller bed formed of a plurality of generally horizontal rollers that are driven, thereby advancing items along the conveyor away from the roller.

FIG. 25D depicts an exemplary discharge assistant conveyor system 2600 corresponding to the arrangement shown in FIGS. 15-18. Discharge assistant conveyor system 2600 includes a discharge conveyor 2650 consisting of a first side conveyor 2662, a second side conveyor 2664, and a horizontal conveyor 2660, each of which are coupled to a discharge assisting conveyor control system 2667. Also coupled to the discharge assisting control 2667 is a path jam sensor 2640. Path sensor 2640 detects if an item is not able to traverse the conveyance path of conveyor 2650.

FIG. 25E depicts an illustrative process 2620 for controlling the discharge conveyor 2650 of discharge assistant conveyor system 2600 or discharge conveyor 450, of FIGS. 15-18. As noted above, sensor(s) as path jam sensor 2640 detect if an item is not able to traverse the conveyance path of the conveyor. Process steps 2621 2622 2624 2625, 2626, 2626, and 2629 of process 2620 are followed in sequence to resolve situations where a jam prevents conveyance of an item. In particular, the process 2620 is started at step 2621 and proceeds to step 2662. At step 2662, a path jam sensor senses whether there is a jammed item along the horizontal conveyor path. Until no jam is sensed, all conveyors as conveyors 2660, 2662, and 2664 of discharge assistant conveyor system 2600 are operated in the same direction of conveyance, D1 (FIG. 25D). Once a jam is sensed, the process proceeds to step 2626.

At step 2626, the side conveyors and horizontal conveyors are operated in alternating directions (D1 and D2), so that at least two of the conveyors are operating a direction opposite the remaining conveyor while continuing to monitor the conveyance path for a jam. At step 2628, the process proceeds to 2628, at which point a determination is made that a jammed item has able to advance in direction D1 and operation of all conveyors in direction D1 resumes until items are discharged into a container. The process then terminates at 2629.

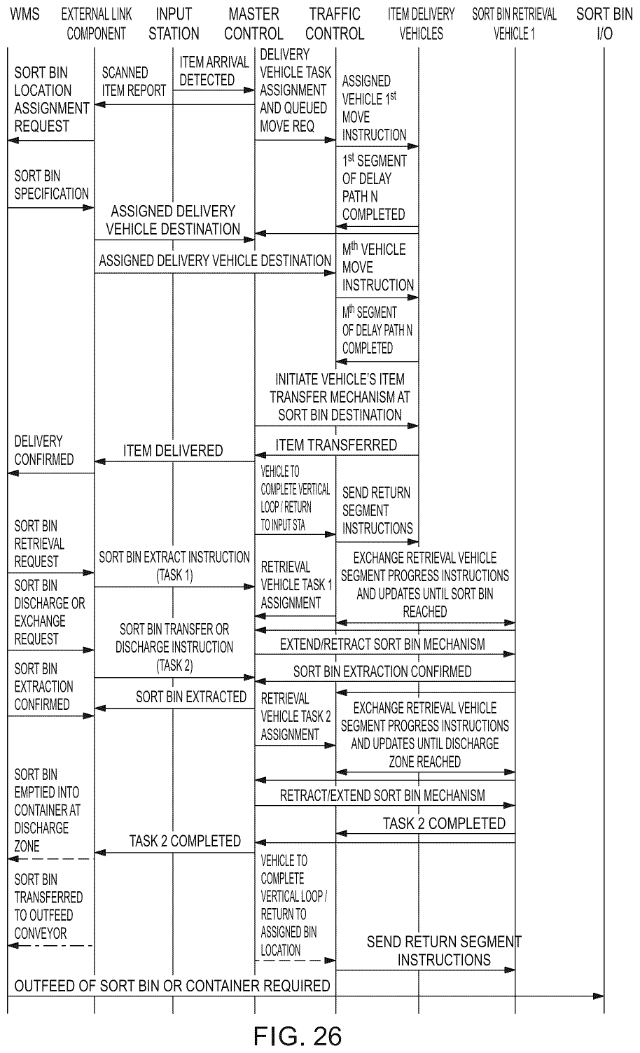

FIG. 26 is a graphical representation depicting an exchange of messages and/or instructions between logical control elements of a sorting and bin retrieval/discharge/exchange (SBRE) system according to embodiments;

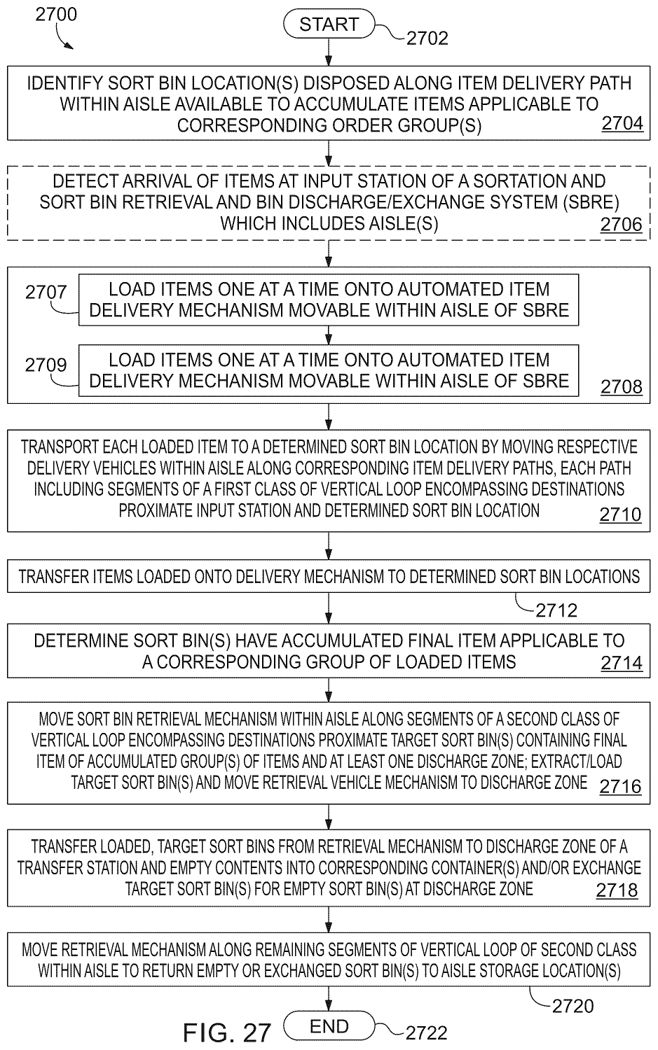

FIG. 27 is a flow chart depicting an automated process 2700 for performing sortation of accumulated groups of items into sort bins, operating vehicles to retrieve sort bins containing accumulated groups, and operating vehicles within the aisle to transfer the contents of sort bins into another container and/or to exchange the sort bins containing an accumulated group with an empty container for one containing a partial group of items to be combined with other items.

The process 2700 is entered at 2702 and proceeds to 2704, where the process identifies one or more sort bin location(s) disposed along the item delivery path within an aisle available to accumulate items applicable to corresponding order group(s). Process 2700 then proceeds to 2706 to detect arrival of items at the input station of a sortation and sort bin retrieval and bin discharge/exchange system (SBRE) which includes one more aisle(s). From 2706, process 2700 proceeds to 2708.

At 2707 and 2709 of process step 2708, items are loaded one at a time onto an automated delivery mechanism movable within an aisle of the SBRE. Process 2700 then proceeds to 2710 which transports each item loaded to a determined sort bin location by moving respective delivery vehicles within an aisle along corresponding item delivery paths, wherein each path includes segments of a first class loop encompassing destinations proximate the input station and the determined sort bin location. The process 2700 proceeds from 2710 to 2712, which transfers items loaded onto the delivery mechanism to determined sort bin locations.

From 2712, process 2700 proceeds to 2714, where process 2700 determines that one or more sort bins have accumulated a final item applicable to a corresponding group of loaded items. From 2714, process 2700 proceeds to 2716, where process 2716 moves the sort bin retrieval mechanism within the aisle along segments of a second class of vertical loop that encompasses destinations proximate target sort bin(s) containing the final item of one or more accumulated groups of items and at least one discharge zone, extracts and loads the target sort bin(s), and moves the retrieval vehicle mechanism to a discharge zone.

From 2716, process 2700 proceeds to 2718 where process 2700 transfers loaded, target sort bins from the retrieval mechanism to the discharge zone of a transfer station and empties contents of the target sort bins into one or more corresponding container(s) and/or exchanges the target sort bin(s) for empty sort bin(s) at the discharge zone. From 2718, process 2700 proceeds to 2720, where process 2700 moves the retrieval mechanism along remaining segments of a vertical loop of the second class within the aisle to return empty or exchanged sort bin(s) to one or more aisle storage location(s). Process 2700 terminates at 2722.

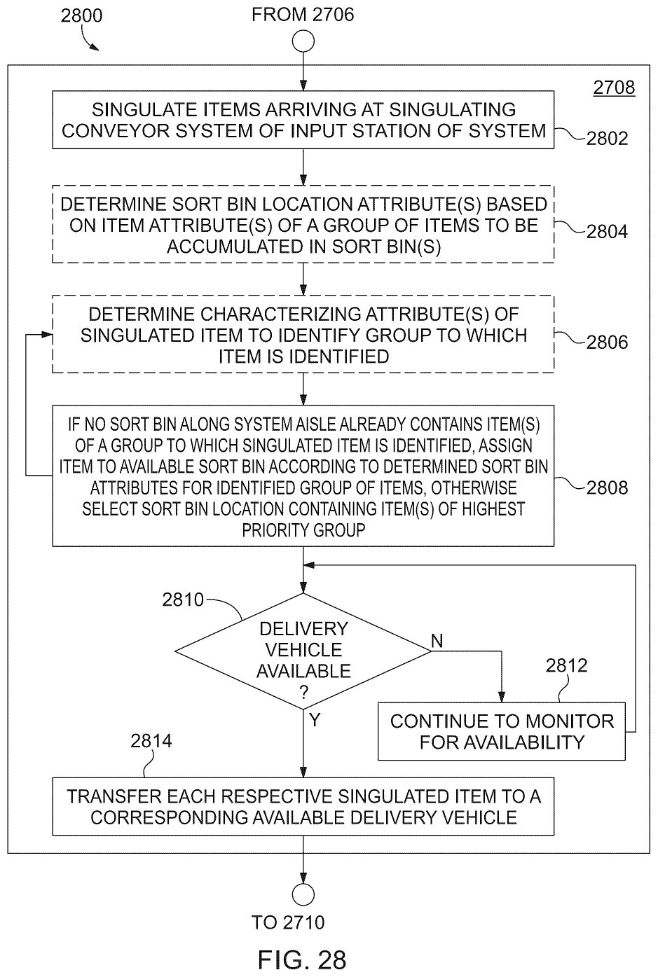

FIG. 28 is a flow chart depicting an exemplary process 2800 for assigning groups or subgroups of items to sort bin locations according to one or more embodiments, as sub process 2708 of process 2700 (FIG. 27). 2802 of process 2800 is entered from 2706 of process 2700. At 2802, process 2800 singulates items arriving at the singulating conveyor system of an input station. Optionally, process 2800 proceeds to 2804, where process 2800 determines sort bin location attribute(s) based on item attributes of a group of items to be accumulated in one or more sort bin(s) and further optionally to 2806, where one or more characterizing attribute(s) of a singulated item are determined to identify the group to which an item is identified.

From any of 2802, 2804, and 2806, process 2800 proceeds to 2808, where, if no sort bin along a system aisle already contains one or more item(s) of a group to which a singulated item is identified, process 2800 assigns the item to an available sort bin according to determined sort bin attributes for the identified group of items. If a sort bin along the system aisle does already contain one or more item(s) of a group to which a singulated item is identified, then process 2800 selects a sort bin location containing item(s) based on a group having the highest priority

From 2808, process 2800 proceeds to 2810, wherein process 2800 determines if a delivery vehicle is available. If not, process 2800 proceeds to 2812 and continues to monitor for availability until a delivery vehicle is available. When a delivery vehicle is available, process 2810 advances from 2810 to 2814. At 2814, process 2800 transfers each singulated item to a corresponding available delivery vehicle, at which point process 2800 is complete and process 2700 resumes at 2710 (FIG. 27).

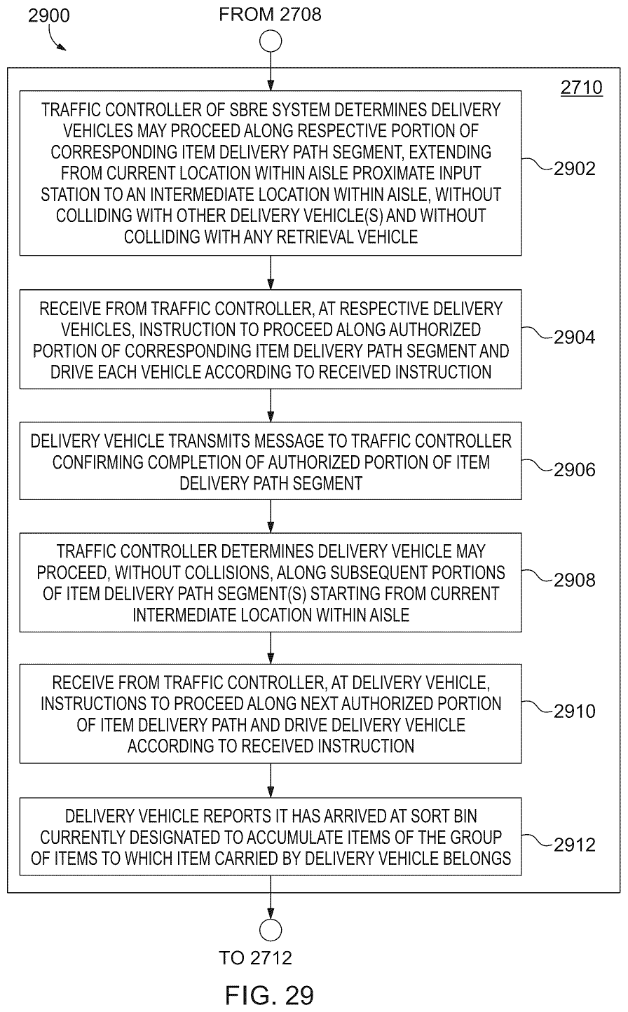

FIG. 29 is a flow chart depicting an exemplary item delivery vehicle traffic control process 2900 to coordinate movement of delivery vehicles during sortation of items according to one or more embodiments, as sub-process 2710 of process 2700 (FIG. 27). 2902 of process 2900 is entered from 2708 of process 2700. At 2902, process 2900 determines by the SBRE system traffic controller determines that each delivery vehicle may proceed along a respective portion of a corresponding item delivery path segment within the aisle which extends from the current location within the aisle proximate the input station to an intermediate location within the aisle, without colliding with other delivery vehicle(s) and without colliding with any retrieval vehicle. From 2902, process 2900 proceeds to 2904.

At 2904, process 2900 receives from the traffic controller, at respective delivery vehicles, an instruction to proceed along an authorized portion of a corresponding item delivery path segment and to drive each vehicle according to a received instruction. From 2904, process 2900 proceeds to 2906.

At 2906 of process 2900, the delivery vehicle transmits a message to the traffic controller confirming completion of the authorized portion of the item delivery path segment. From 2906, process 2900 proceeds to 2908. At 2908 of process 2900, the traffic controller determines that the delivery vehicle may proceed, without collisions, along subsequent portions of item delivery path segment(s) starting from a current intermediate location within the aisle. From 2908, process 2900 proceeds to 2910, where process 2900 receives from the traffic controller, at a delivery vehicle, instructions to proceed along the next authorized portion of the item delivery path and to drive the delivery vehicle according to the received instructions. From 2910, process 2900 proceeds to process 2912.

At 2912 of process 2900, the delivery vehicle reports that it has arrived at the sort bin currently designated to accumulate items of the group of items to which the item carried by the delivery vehicle belongs, at which point process 2900 is complete and process 2700 resumes at 2712 (FIG. 27).

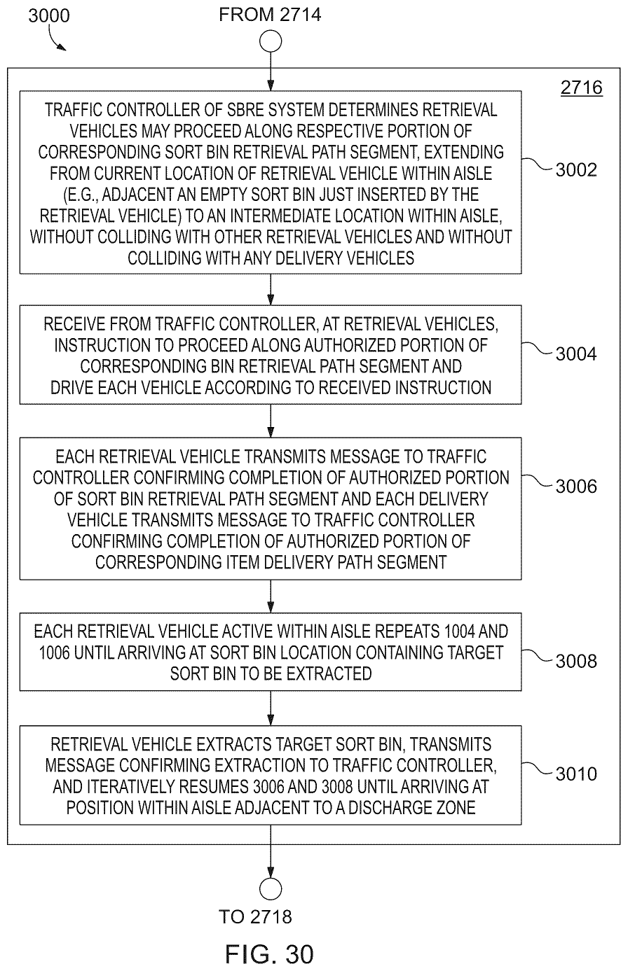

FIG. 30 is a flow chart depicting an exemplary sort retrieval vehicle traffic control process 3000, as sub process 2716 of process 2700, to coordinate movement of sort bin retrieval vehicles while sortation and sort bin retrieval operations are being performed at the same time within an aisle. As a sub-process of process 2700, process 3000 proceeds from 2716 (FIG. 27) and at initial step 3002 process 3000 determines that retrieval of vehicles may proceed along respective portions of a corresponding sort bin retrieval path segment extending from a retrieval vehicle current location within the aisle (e.g., adjacent an empty sort bin just inserted by the retrieval vehicle) to an intermediate location within the aisle, without colliding with any delivery vehicles.

From 3002, process 3000 proceeds to 3004 where process 3000 receives from the traffic controller at retrieval vehicles, instruction to proceed along an authorized portion of a corresponding bin retrieval path segment and to drive each vehicle according to the received instruction.

From 3004, process 3000 proceeds to 3006, where each retrieval vehicle transmits a message to the traffic controller confirming completion of an authorized portion of a sort bin retrieval path segment and where each delivery vehicle transmits a message to the traffic controller confirming completion of an authorized portion of a corresponding item delivery path segment.

From 3006, process 3000 proceeds to 3008, where process 3000 repeats 3004 and 3006 until arriving at a sort bin location containing a target sort bin to be extracted.

From 3008, process 3000 proceeds to 3010, where process 3000 transmits a message confirming extraction of target sort bin by a retrieval vehicle and iteratively resumes 3006 and 3008 until arriving at a position within the aisle adjacent to a discharge zone. From 3010, process 2700 is resumed at 2718 (FIG. 27).

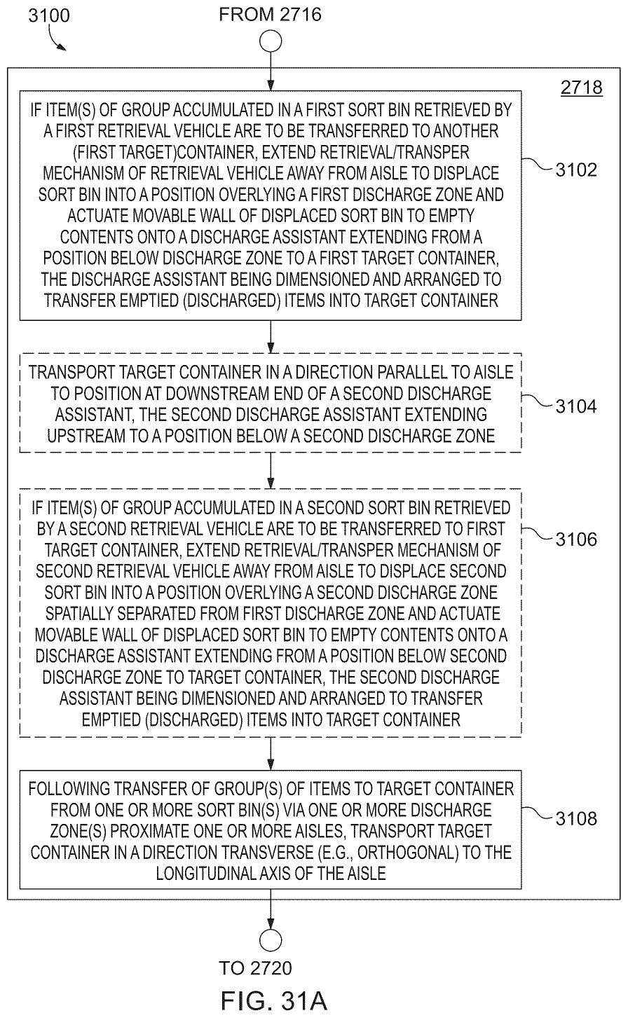

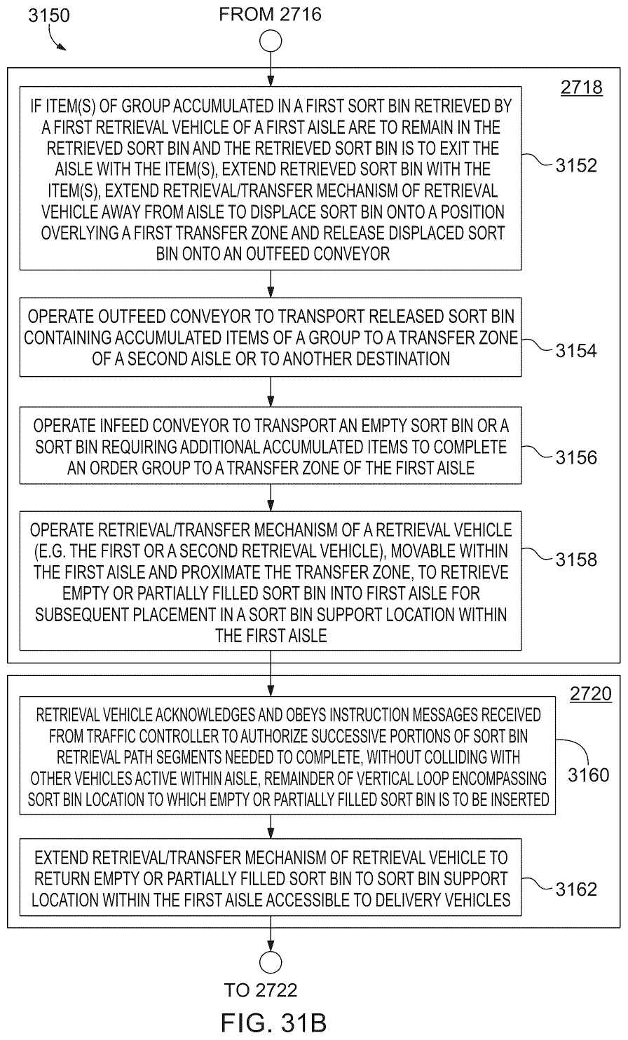

FIG. 31A is a flow chart depicting a sort bin sequencing process 3100, as sub process 2718 of process 2700 (FIG. 27), to combine contents of multiple sort bins in the same container according to one or embodiments consistent with the present disclosure. Process 3100 enters step 3102 from 2716 of process 2700. At 3102, if one or more items of a group accumulated in a first sort bin retrieved by a first retrieval vehicle are to be transferred to another (first target) container, process 3100 extends the retrieval/transfer mechanism of the retrieval vehicle away from the aisle to displace the sort bin into a position overlying a first discharge zone and actuates a movable wall of a displaced sort bin to empty the bin contents onto a discharge assistant. The discharge assistant extends from a position below the discharge zone onto a first target container and is dimensioned and arranged to transfer emptied (discharged) items into the target container.

From 3102, process 3100 proceeds to 3104, where process 3100 transports the target container in a direction parallel to the aisle to a position at the downstream end of a second discharge assistant, the second discharge assistant extending upstream to a position below a second discharge zone.

From 3104, process 3100 proceeds to 3106 where, if one or more items of a group accumulated in a second sort bin retrieved by a second retrieval vehicle are to be transferred to the first target container, process 3100 extends the retrieval/transfer mechanism of the second retrieval vehicle away from the aisle to displace the second sort bin into a position overlying a second discharge zone spatially separated from the first discharge zone and actuates a movable wall of the displaced sort bin to empty the contents onto a discharge assistant extending from a position below the second discharge zone to a target container. The second discharge assistant onto which contents are emptied is dimensioned and arranged to transfer emptied (discharged) items into the target container.

From 3106, process 3100 proceeds to 3108 where, following transfer of one or more group(s) of items to a target container from one or more sort bin(s) via one or more discharge zone(s) proximate one or more aisles, process 3100 transports the target container in a direction transfers (e.g., orthogonal) to the longitudinal axis of the aisle. From 3108, process 2700 is resumed at 2720 (FIG. 27).

FIG. 31B is a flow chart depicting a sort bin discharge and/or exchange process 3150, as sub-processes 2718 and 2720 of process 2700 (FIG. 27), according to one or embodiments consistent with the present disclosure. 3152 of process 3150 is entered from 2716 of process 2700. At 3152, if one or more items of a group accumulated in a first sort bin retrieved by a first retrieval vehicle of a first aisle are to remain in the retrieved sort bin and the retrieved sort bin is to exit the aisle with the item(s), process 3150 extends the retrieved sort bin with the items, extends retrieval/transfer mechanism of the retrieval vehicle away from the aisle to displace the sort bin onto a position overlying a first transfer zone, and releases the displaced sort bin onto an outfeed conveyor. Process 3152 proceeds to 3154.

At 3154, process 3150 operates the outfeed conveyor to transport the released sort bin containing accumulated items of a group to a transfer zone of a second aisle or to another destination. From 3154, process 3150 proceeds to 3156. At 3156, process 3150 operates an infeed conveyor to transport an empty sort bin or a sort bin requiring additional accumulated items to complete an order group to a transfer zone of the first aisle. From 3156, process 3150 proceeds to 3158.

At 3158, process 3150 operates the retrieval/transfer mechanism of a retrieval vehicle (e.g, the first or a second retrieval vehicle), movable within the first aisle and proximate the transfer zone, to retrieve an empty or partially filled sort bin into the first aisle for subsequent placement in a sort bin support location within the first aisle. Process 3150 exits sub process 2718 at 3158 and enters sub process 2710 at 3160. At 3160, process 3150 acknowledges and obeys instruction messages received from the traffic controller to authorize successive portions of sort bin retrieval path segments needed to complete, without colliding with other vehicles active within the aisle, the remainder of a vertical loop encompassing the sort bin location to which an empty or partially filled sort bin is to be inserted. From 3160, process 3150 proceeds to 3162. At 3162, process 3150 extends the retrieval/extract mechanism of the retrieval vehicle to return the empty or partially filled sort bin to sort bin a support location within the first aisle accessible to delivery vehicles.

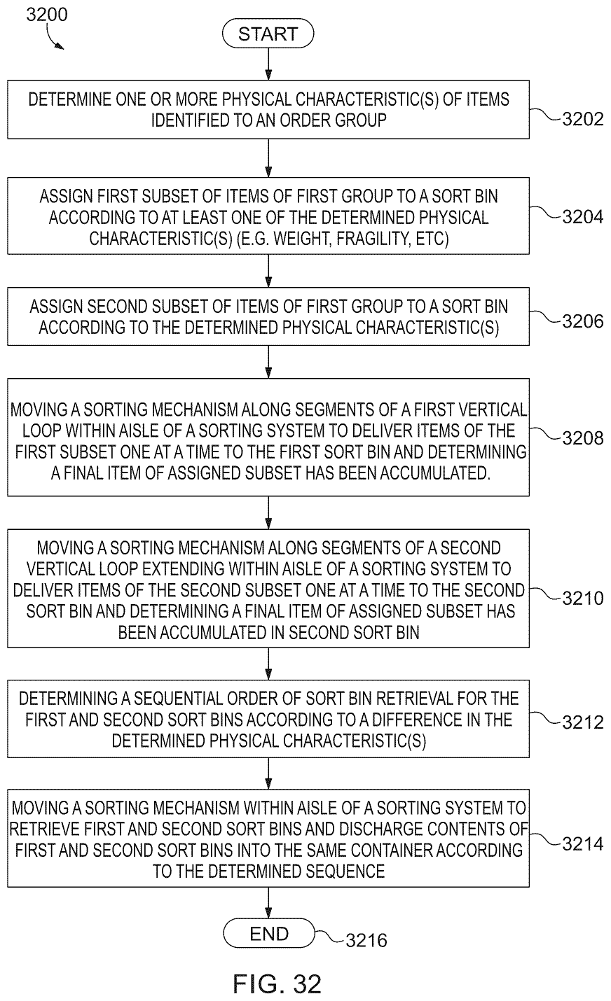

FIG. 32 is a flow chart depicting a modified sort bin sequencing process 3200 which utilizes determined information about one or more item or item group characteristic(s) to determine the order in which the contents of multiple sort bins are to be combined in the same container, according to one or embodiments consistent with the present disclosure. Process 3200 is entered upon starting at 3202, where process 3200 determines one or more physical characteristics(s) of items identified to an order group. From 3202, process 3200 proceeds to 3204, where process 3200 assigns a first subset of items of a first group of items to a sort bin according to at least one of the determined physical characteristic(s). The process 3200 proceeds from 3204 to 3206.

At 3206, process 3200 assigns a second subset of items of a first group to a sort bin according to the determined physical characteristics and process 3200 then proceeds to 3208. At 3208, process 3200 moves a sorting mechanism along segments of a first vertical loop within an aisle of a sorting system to deliver items of the first subset one at a time to the first sort bin and determines that a final item of the assigned subset has been accumulated. Process 3200 then proceeds to 3210.

At 3210, process 3200 moves a sorting mechanism along segments of a second vertical loop extending within the aisle of a sorting system to deliver items of the second subset one at a time to the second sort bin and determines that a final item has been accumulated in the second sort bin. From 3210, process 3200 proceeds to 3212 and determines a sequential order of sort bin retrieval for the first and second sort bins according to a difference in the determined physical characteristic(s). Process 3200 proceeds from 3212 to 3214.

At 3214, process 3200 moves a sorting mechanism within the aisle of a sorting system to retrieve first and second sort bins and discharge the contents of the first and second sort bins in the same container according to the determined sequence. From 3214, process 3200 terminates at 3216.

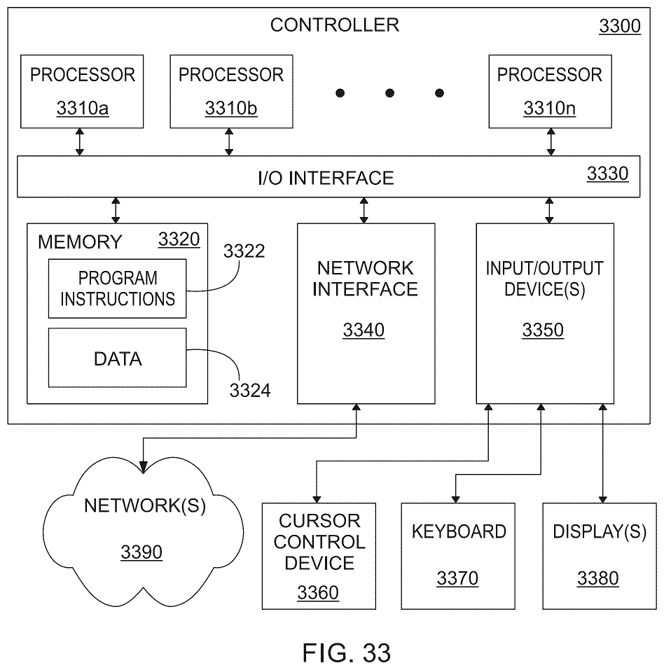

Various embodiments of method and apparatus for organizing, enhancing and presenting message content which incorporate one or more media files, as described herein, may be executed on one or more computer systems, which may interact with various other devices. One such computer system is computer system 3300 illustrated by FIG. 33, which may in various embodiments implement elements or functionality illustrated. In various embodiments, computer system 3300 may be configured to implement methods described above. The computer system 3300 may be used to implement any other system, device, element, functionality or method of the above-described embodiments. In the illustrated embodiments, computer system 3300 may be configured to implement method 2700 (FIG. 27), method 2800 (FIG. 28), method 2900 (FIG. 29), method 3000 (FIG. 30), and/or any of the other methods described and/or depicted herein, as processor-executable executable program instructions 3322 (e.g., program instructions executable by processor(s) 3310) in various embodiments.

In the illustrated embodiment, computer system 1200 includes one or more processors 3310a-3310n coupled to a system memory 3320 via an input/output (I/O) interface 3330. Computer system 3300 further includes a network interface 3340 coupled to I/O interface 3330, and one or more input/output devices 3350, such as cursor control device 3360, keyboard 3370, and display(s) 3380. In various embodiments, any of the components may be utilized by the system to receive user input described above. In various embodiments, a user interface may be generated and displayed on display 3380. In some cases, it is contemplated that embodiments may be implemented using a single instance of computer system 3300, while in other embodiments multiple such systems, or multiple nodes making up computer system 3300, may be configured to host different portions or instances of various embodiments. For example, in one embodiment some elements may be implemented via one or more nodes of computer system 3300 that are distinct from those nodes implementing other elements. In another example, multiple nodes may implement computer system 3300 in a distributed manner.

In different embodiments, computer system 3300 may be any of various types of devices, including, but not limited to, a personal computer system, desktop computer, laptop, notebook, or netbook computer, mainframe computer system, handheld computer, workstation, network computer, application server, storage device, a peripheral device such as a switch, modem, router, or in general any type of computing or electronic device.

In various embodiments, computer system 3300 may be a uniprocessor system including one processor 3310, or a multiprocessor system including several processors 3310 (e.g., two, four, eight, or another suitable number). Processors 3310 may be any suitable processor capable of executing instructions. For example, in various embodiments processors 3310 may be general-purpose or embedded processors implementing any of a variety of instruction set architectures (ISAs). In multiprocessor systems, each of processors 3310 may commonly, but not necessarily, implement the same ISA.

System memory 3320 may be configured to store program instructions 3322 and/or data 3324 accessible by processor 3310. In various embodiments, system memory 3320 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 3320. In other embodiments, program instructions and/or data may be received, sent or stored upon different types of computer-accessible media or on similar media separate from system memory 3320 or computer system 1200.

In one embodiment, I/O interface 3330 may be configured to coordinate I/O traffic between processor 3310, system memory 3320, and any peripheral devices in the device, including network interface 3340 or other peripheral interfaces, such as input/output devices 3350. In some embodiments, I/O interface 3330 may perform any necessary protocol, timing or other data transformations to convert data signals from one component (e.g., system memory 3320) into a format suitable for use by another component (e.g., processor 3310). In some embodiments, I/O interface 3330 may include support for devices attached through various types of peripheral buses, such as a variant of the Peripheral Component Interconnect (PCI) bus standard or the Universal Serial Bus (USB) standard, for example. In some embodiments, the function of I/O interface 3330 may be split into two or more separate components, such as a north bridge and a south bridge, for example. Also, in some embodiments some or all of the functionality of I/O interface 3330, such as an interface to system memory, may be incorporated directly into processor 3310.

Network interface 3340 may be configured to allow data to be exchanged between computer system 3300 and other devices attached to a network (e.g., network 3390), such as one or more display devices (not shown), or one or more external systems or between nodes of computer system 3300. In various embodiments, network 33390 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 3340 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 3350 may, in some embodiments, include one or more communication terminals, keyboards, keypads, touchpads, scanning devices, voice or optical recognition devices, or any other devices suitable for entering or accessing data by one or more computer systems 3300. Multiple input/output devices 3350 may be present in computer system 900 or may be distributed on various nodes of computer system 1200. In some embodiments, similar input/output devices may be separate from computer system 1200 and may interact with one or more nodes of computer system 1200 through a wired or wireless connection, such as over network interface 3340.

It will be recognized by those skilled in the art that changes or modifications may be made to the above-described embodiments without departing from the broad inventive concepts of the invention. For instance, in the foregoing discussion the system is described as a series of vehicles guided by a track. However, it should be understood that the system need not include a track. For example, the vehicles may travel along the ground in addition to traveling along a track.

In addition to a system in which the vehicles move along the ground without a track, the system may incorporate a guidance assembly that includes one or more rails or other physical guides that contact a mechanism on the vehicle to direct the vehicle along a path. For instance, the vehicles may each include one or more contact elements such as wheels, rollers, guide tabs, pins or other elements that may engage the guidance assembly. The guidance assembly may be a linear element such as a straight rail or it may be a curved element. The guidance assembly may curve within a horizontal plane so that the rail stays within a plane, or the guide may curve vertically so that the rail is within a single plane. The guidance assembly may include a plurality of guides or rails vertically spaced from one another so that the vehicles may move horizontally at a plurality of vertical levels. The guide may also include an elevator for moving the vehicles between the vertically spaced rails.

As can be seen from the above, the system may be incorporated into a variety of systems that use physical guide mechanisms or guide the vehicles along open areas by directing the path to guide the vehicles to storage locations or transfer locations.

The systems and methods described herein may be implemented in software, hardware, or a combination thereof, in different embodiments. In addition, the order of methods may be changed, and various elements may be added, reordered, combined, omitted, or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

It should therefore be understood that this invention is not limited to the particular embodiments described herein but is intended to include all changes and modifications that are within the scope and spirit of the invention as set forth in the claims.

1. An item sorting apparatus including an input station for acquiring information used to identify destinations applicable to items to be sorted, a plurality of sort bins, and a rack defining an aisle and configured to support the plurality of sort bins at spatially separated locations along at least a first or second side of the aisle, characterized by:
a plurality of discharge stations proximate the aisle;
a delivery mechanism operable within the aisle for delivering items to the sort bins to thereby accumulate groups of items applicable to an order;
a retrieval mechanism operable within the aisle and configured to move with the aisle, to retrieve respective sort bins containing sorted items, to transport the respective sort bins within the aisle to one or more locations adjacent the discharge station, and to discharge items from at least one of the transported sort bins into a container displaced from the aisle; and
an outfeed conveyor for moving the container away from the aisle.

2. The apparatus of claim 1, wherein a first group of sort bins is supported by the rack along a first side of the aisle, wherein a second group of sort bins is located along a second side of the aisle, and wherein the retrieval mechanism is operable to move the sort bins into the aisle.

3. The apparatus of claim 1 wherein the retrieval mechanism is moveable within the aisle in a vertical and/or horizontal direction.

4. The apparatus of claim 1 wherein the delivery mechanism comprises a plurality of independently operable delivery vehicles.

5. The apparatus of claim 4 wherein the delivery vehicles comprise a transfer mechanism operable in a first direction to transfer items from the delivery vehicles into one of the sort bins along the first side of the aisle and operable in a second direction to transfer items from the delivery vehicle into one of the sort bins along the second side of the aisle.

6. The apparatus of claim 4 wherein the delivery vehicles are operable to follow a vertical loop within the aisle.

7. The apparatus of claim 6 wherein each delivery vehicle comprises an energy storage device for providing power for operation of the delivery vehicle and wherein a charging element is provided within the aisle for charging the delivery vehicles as the delivery vehicles move within the aisle

8. The apparatus of claim 7 comprising a track for guiding the delivery vehicles to the sort bins.

9. The apparatus of claim 4 wherein the retrieval mechanism comprises a plurality of retrieval vehicles.

10. The apparatus of claim 9 wherein the retrieval vehicles comprise a transfer mechanism configured to engage the sort bins.

11. The apparatus of claim 9 wherein each retrieval vehicle comprises an energy storage device for providing power for operation of the retrieval vehicle.

12. The apparatus of claim 1, wherein the discharge stations include a discharge conveyor system that includes a first, second and third conveyor configured to iteratively reverse directions at different times to resolve an item jam.

13. The apparatus of claim 1 wherein the sort bins include a moveable wall.

14. The apparatus of claim 13 wherein the discharge stations are configured to facilitate movement of the moveable wall when one of the sort bins is transferred into the discharge station so that items can be discharged from the sort bin.

15. A method of sorting items into groups, comprising:
loading, at a loading station, a plurality of items one at a time onto a delivery mechanism movable within an aisle;
operating the delivery mechanism within the aisle to deliver items to respective sort bins of a plurality of sort bins disposed along the aisle, the operating including
transporting each loaded item along a vertical loop within the aisle, the vertical loop encompassing the loading location and a respective destination adjacent one of the sort bins, and
operating transfer mechanisms of the delivery mechanism to respectively deposit items into the sort bins to accumulate groups of items in the sort bins;
determining that a group of items assigned to a sort bin have been accumulated in a first sort bin; and
retrieving the first sort bin, the retrieving including moving a retrieval mechanism within the aisle to a position proximate the first sort bin;
displacing the first sort bin and the accumulated items into the aisle while retaining the first sort bin;
transporting the first sort bin within the aisle to a first discharge station;
discharging the accumulated items from the first sort bin at the first discharge station into a first container that is spaced apart from the aisle;
displacing the first container in a direction parallel to the aisle;
at a second discharge station, receiving accumulated items from a second sort bin retrieved by the sort mechanism into the first container; and
transporting the first container away from the second discharge station.
